(19) United States
(12) Patent Application Publication
(10) Pub. No.: US 2008/0183689 A1
(43) Pub. Date: Jul. 31, 2008

(54) Search method and apparatus for plural databases

(75) Inventors: Atsushi Kubota, Kawasaki (JP); Haruyasu Ueda, Kawasaki (JP); Yasuhiko Kanemasa, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/075,373

(22) Filed: Mar. 11, 2008

Related U.S. Application Data
(63) Continuation-in-part of application No. 11/903,029, filed on Sep. 20, 2007, now abandoned.

(30) Foreign Application Priority Data
Dec. 21, 2006 (JP) 2006-343872
Dec. 4, 2007 (JP) 2007-313134

(51) Int. Cl. G06F 17/30

(52) U.S. Cl. 707/4; 707/E17.014

(57) ABSTRACT

In a search method, integration metadata is newly introduced in which structure data defining an output structure of a query result, a correspondence relation between elements in the structure data and elements in databases, an association of elements between the databases and a bi-directional conversion function applied to said association of said elements between said databases or a specific element of said databases are defined. And, this search method includes: accepting a query of integrated data reference for a plurality of databases; extracting a value of an element in database, which corresponds to the top-level element in a structure identified from the integration metadata in a integration metadata storage by upwardly tracing the structure based on the query; extracting a value of each element in each database by downwardly tracing the structure based on a value of an element in the database, which corresponding to the top-level element in the structure; and outputting the extracted value of each element in each database according to data stored in the integration metadata storage.

### CROSS-REFERENCE TO RELATED APPLICATION

This is a continuation-in-part application of application Ser. No. 11/903,029, filed Sep. 20, 2007.

### TECHNICAL FIELD OF THE INVENTION

This invention relates to a technique for retrieving in a form that data distributedly held in plural databases is integrated.

### BACKGROUND OF THE INVENTION

In a conventional art, when associated data is distributedly held extending in plural existing databases, which are placed in different environments, a method has been adopted in which a new data warehousing is constructed in order to refer to them as one set of integrated data, and all of the data are migrated to the data warehousing. However, because data should be copied from the original databases to the data warehousing in this method, time lag occurs. Therefore, it is impossible to refer to the data in the original database in real time. In addition, because the cost and time are required for the construction of the data warehousing, it is not easy to re-form the data warehousing. Therefore, the data warehousing has a problem that it is impossible to rapidly deal with a case where a request for the database integration is changed because the business changes in a short cycle.

On the other hand, as another method, there is a method in which the data is stored in the original databases, and when a request for the integrated data is received from a user, necessary data is acquired by outputting a query to each database in real time, and then the acquired data is composed to return it to the user (hereinafter, this method is called as a query-type database integration). In this method, a response time is not short because data is acquired through the network, but the practicability of this method increases because of the recent improvement of the network speed. In this method, the data extending in the plural databases can be used except for the performance problem as if the data is stored in one database. This method can resolve the real-time problem of the data in the data warehousing, and there is no need to change the databases themselves. Therefore, it becomes possible to immediately deal with the change of the request for the database integration because of the business change.

For example, as shown in FIG. 1, an example is considered in which an order database (DB) including an order slip table and an item table is provided in a host A, an item DB including a treated item table is provided in a host B, a stock DB 1 including a stock table 1 is provided in a host C, and a stock DB 2 including a stock table 2 is provided in a host D. Incidentally, in FIG. 1, it is assumed that all of the databases are relational databases. In addition, in the example of FIG. 1, a data item “order_id” (also called a column) is registered in the order slip table and the item table, a data item “item_code” in the item table is registered in the stock table 2 of the stock DB 2, and furthermore, a data item “code” associated with the data item “item_code” in the item table is registered in the treated item table of the item DB and the stock table 1 of the stock DB 1.

Although there are various methods of referring to the associated data registered extending in the plural databases by the query-type database integration technique, one of the methods is disclosed in U.S. 2005/0160076-A1, for example. In this publication, a technique is disclosed in which a data view in a tagged document format, which is integrated extending in plural databases, is provided, and a query freely using a query language is enabled. In this publication, as a generation rule when integrating the plural databases, “DB integration metadata” is prepared.

FIG. 2 schematically shows the DB integration metadata corresponding to FIG. 1. In the example of FIG. 2, as a child node of a node “order”, a node corresponding to each data item of the order slip table in the order DB is placed. Furthermore, an intermediate node “items” among the child nodes of the node “order” is also placed. Then, as a child node of the node “items”, a node “item” is placed, and as a child node of the node “item”, a node corresponding to each data item of the item table in the order DB is placed. Furthermore, as a child node of the node “item”, a parent node of a node corresponding to each data item of the treated item table in the item DB and a parent node of a node corresponding to each data item of the stock tables 1 and 2 in the stock DBs 1 and 2 are placed. Incidentally, the stock tables 1 and 2 share the nodes. In addition, associations between the aforementioned databases are provided in the DB integration metadata. The DB integration metadata shown in FIG. 2 is described by, for instance, XML, as shown in FIGS. 3 to 6.

In the DB integration metadata, three kinds of contents including “definition of the view structure in the tagged document format” (See FIG. 3), “correspondence relation between each element of the view structure and a database item” (See FIGS. 4 and 5), and “associations between the database items” (See FIG. 6) are described. In order to show the view as if the tagged document defined in this generation rule actually exists, when this system accepts a query for that view, this system interprets the query content, issues a sub query for each database so as to conform with the view generation rule, and then synthesizes query results from the databases to reply a query response as if the tagged document actually exists and the query for the tagged document is carried out. Specifically, as shown in FIG. 7, by causing a user to consider the existence of the virtual view 3 by using the DB integration metadata, a query 1 for the virtual view 3 is input to the system. The query 1 is described in, for example, XQuery (See http://www.w3.org/XML/Query). In the example of FIG. 7, a case of referring to “orders for two or more FMV-6000CL” is shown. Then, the system generates and outputs a query result 5 according to the DB integration metadata.

Conventionally, when an application using the data distributed in the plural databases is created, a lot of time is required to describe codes for obtaining data from each database. However, according to the technique described in this publication, the time to create the entire application is shortened because the data acquisition from each database becomes very simple and can be carried out quickly.

However, in the technique disclosed in the publication, because “the association between the database items” needs the complete identity of the values, it is impossible to associate the items and provide the data view in the tagged document format when value ranges or formats of the items to be associated are not identical. For example, as shown in FIG. 8, when a value of the data item “item_code” of the item table in the order DB is stored in a format using only 6-digit numeral (e.g. “034564”), and a value of the data item “code” of the treated item table in the item DB is stored in a format using three characters “fmv” at the head of the 6-digit numeral (e.g, “fmv034564”), the association between them cannot be set.

In addition, in the technique disclosed in the aforementioned publication, the data structure can be virtualized, but the value range of the data cannot be virtualized. That is, the value itself of the data in the database is shown as the value of the data on the virtual view. With this, it is impossible to provide a view matching with a value range or format of the data, which is assumed by the application developer, and it is necessary to change the value range or format to that of the view, at the application side. Therefore, the development of the application becomes complicated.

### SUMMARY OF THE INVENTION

Therefore, an object of this invention is to provide a technique enabling to set association between data items in a different value range or different format when carrying out the query-type database integration.

In addition, another object of this invention is to provide a technique enabling the virtualization of the value range of the data in the database when carrying out the query-type database integration.

Furthermore, still another object of this invention is to provide a technique enabling to flexibly carry out the association between the data items in the database or data reference when carrying out the query-type database integration.

In a search method according to the first aspect of this invention, integration metadata is newly introduced in which structure data defining an output structure of a query result (e.g. in an embodiment, virtual XML schema information), a correspondence relation between elements in the structure data and elements in databases, an association of elements between the databases and a bi-directional conversion function applied to the association of the elements between the databases or a specific element of the databases are defined. By such a bi-directional conversion function, it becomes possible to associate the data items in different value ranges or different formats. Furthermore, it is possible to virtualize the value range in the database.

Incidentally, the bi-directional conversion function is a function having symmetricalness of the conversion. That is, when a value firstly converted in a certain direction by using the bi-directional conversion function is next converted in the reverse direction of the bi-directional conversion function, the original value is obtained.

Then, the search method according to the first aspect of this invention includes: accepting a query of integrated data reference for a plurality of databases; extracting a value of an element in database, which corresponds to the top-level element in a structure identified from integration metadata in a integration metadata storage by upwardly tracing the structure based on the query; extracting a value of each element in each database by downwardly tracing the structure based on a value of an element in the database, which corresponding to the top-level element in the structure; and outputting the extracted value of each element in each database according to data stored in the integration metadata storage.

In addition, the aforementioned first extracting includes: outputting individual queries based on at least one of a condition of the query and a processing result immediately before to the pertinent databases on a upward trace route, and obtaining search processing results of the individual queries; and upwardly applying a pertinent bi-directional conversion function on the upward trace route to at least one of the condition of the query and the processing result immediately before, and obtaining a conversion processing result. In addition, the aforementioned second extracting includes: outputting individual queries based on upper-level processing results to pertinent databases on a downward trace route, and obtaining the search processing result; and applying a pertinent bi-directional conversion function on the downward trace route to upper-level processing results, and obtaining a conversion processing result.

Thus, by appropriately carrying out the individual queries for the databases and the application of the bi-directional conversion function in appropriate directions in the upward trace processing and downward trace processing of the structure identified from the integration metadata, the user can obtain the query result without considering the plural databases.

In addition, in the aforementioned integration metadata, the bi-directional conversion function may be defined as an element in the same rank as that of the element of the database. Then, the association of the elements between the databases may include an association between an element of a first database and a downward element of the bi-directional conversion function, and an association between an element of a second database and an upward element of the bi-directional conversion function. Similarly to the elements of the databases, the bi-directional conversion function corresponds to a node in the structure (e.g. tree structure) identified from the integration metadata, and associates the elements of the databases in the both directions.

Furthermore, in the aforementioned integration metadata, the bi-directional conversion function may be defined as an element in the same rank as that of the elements of the database. Then, in a case of the bi-directional conversion function, which converts a value of a specific element in the database, the association of the elements between the databases may include an association between the specific element of the database and the element of the bi-directional conversion function. Virtualization of the value range of the data in the database can be realized by adopting such a configuration.

In addition, in the aforementioned integration metadata, an element in the structure data, which corresponds to the bi-directional conversion function, may include an attribute concerning whether or not utilization in the query of the data reference is granted. It becomes possible to define necessary structure in the structure data without destroying the virtual view for the user.

Furthermore, in the aforementioned integration metadata, the bi-directional conversion function may be defined as an element in the same rank as that of the element of the database. Then, the association of the elements between databases may include an association between m elements of a first database and m downward elements of the bi-directional conversion function and an association between n elements of a second database and n upward elements of the bi-directional conversion function. Thus, it is possible to flexibly determine a conversion method of the bi-directional conversion function.

In addition, in the aforementioned integration metadata, the bi-directional conversion function may be defined as an element in the same rank as that of the elements of the database. Then, in a case of the bi-directional conversion function, which is applied to a specific element of the database, the association of the elements between the databases may include an association between m specific elements of the database and m elements of the bi-directional conversion function. When virtualizing the value range of the data in the database, the flexible virtualization becomes possible.

In addition, when a function limiting a value of the element of the associated database is defined as the aforementioned bi-directional conversion function, the individual query to the associated database may include a condition concerning the value limited by the bi-directional conversion function. For example, when the bi-directional conversion function is defined in which the conversion at the upward trace processing is not carried out unless the specific data item in the lower-level database has a specific value, the upward trace cannot be carried out through the element corresponding to the bi-directional conversion function unless the specific data item has the specific value. That is, the data is limited. The useless trace is carried out when the characteristic of the bi-directional conversion function is not considered. Therefore, by changing the individual query to be the aforementioned individual query, it is possible to reduce the data volume replied from the database, the load of the data transfer, and the processing load of the replied data.

Although the first aspect of this invention effectively functions in a case where the bi-directional conversion function can be defined, the bi-directional conversion function cannot be always defined. For example, in a case where data stored in two databases is associated each other by using an item code, when a first item code is represented by a mixed format including both of capital letters and small letters (e.g. “SymfoWARE”), and a second item code is represented by a format including only capital letters (e.g. “SYMFOWARE”), a conversion from the former to the latter can be uniquely defined. However, the reverse conversion cannot be defined, and the association between them cannot be made. However, there is a case where such association is effective. Therefore, in a second aspect of this invention, both of the bi-directional conversion function and a one-directional conversion function are made to be handled.

However, when the one-directional conversion function exists, the upward trace and the downward trace for the structure identified from the integration metadata cannot be simply carried out. Therefore, it is necessary to carry out a following processing. Incidentally, the integration metadata defines structure data defining an output structure of a query result, a correspondence relation between elements in the structure data and elements in the databases, an association of the elements between the databases, and a bi-directional conversion function or one-directional conversion function applied to the association of the elements between the databases or a specific element of the databases.

The second aspect of this invention includes: accepting a query of integrated data reference for a plurality of databases; identifying an upward trace condition that is a condition obtained by excluding a downward trace condition that is a condition relating to a first element corresponding to a one-directional conversion function in the structure identified from the integration metadata stored in the integration metadata storage device storing the integration metadata and second elements lower than the first element from conditions of the query or that is a condition to extract all values for an immediately upper element of the first element corresponding to the one-directional conversion function in the structure in a case where the conditions of the query are only the downward trace conditions; extracting a value of an element in the database, which corresponds to a top-level element in the structure identified from the integration metadata by upwardly tracing the structure identified from the integration metadata based on the upward trace condition; extracting a value of each element in each database by downwardly tracing the structure based on the value of the element in the database, which corresponds to the top-level element in the structure, and the downward trace condition; and outputting the extracted value of each element in each database according to the integration metadata stored in the integration metadata storage device.

Then, the extracting by upwardly tracing includes: outputting an individual query based on at least one of the upward trace condition and a processing result immediately before to a pertinent database on an upward trace route to obtain a search processing result; and upwardly applying the pertinent bi-directional conversion function on the upward trace route to the upward trace condition or the processing result immediately before to obtain a conversion processing result. Furthermore, the extracting by downwardly tracing includes: outputting an individual query based on at least one of an upper processing result and the downward trace condition to a pertinent database on an downward trace route to obtain a search processing result; and downwardly applying the pertinent bi-directional conversion function or the pertinent one-directional conversion function on the downward trace route to obtain a conversion processing result.

Because the upward trace cannot be carried out from an element lower than the one-directional conversion function when the one-directional conversion function is defined in the structure, the upward trace condition and the downward trace condition are separately applied.

Incidentally, the definition method of the one-directional conversion function in the integration metadata is almost the same as that of the bi-directional conversion function.

Incidentally, it is possible to create a program for causing a computer to execute these methods according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram showing an example of plural databases;

FIG. 2 is a schematic diagram showing conventional DB integration metadata;

FIG. 3 is a diagram showing a first portion of the conventional DB integration metadata;

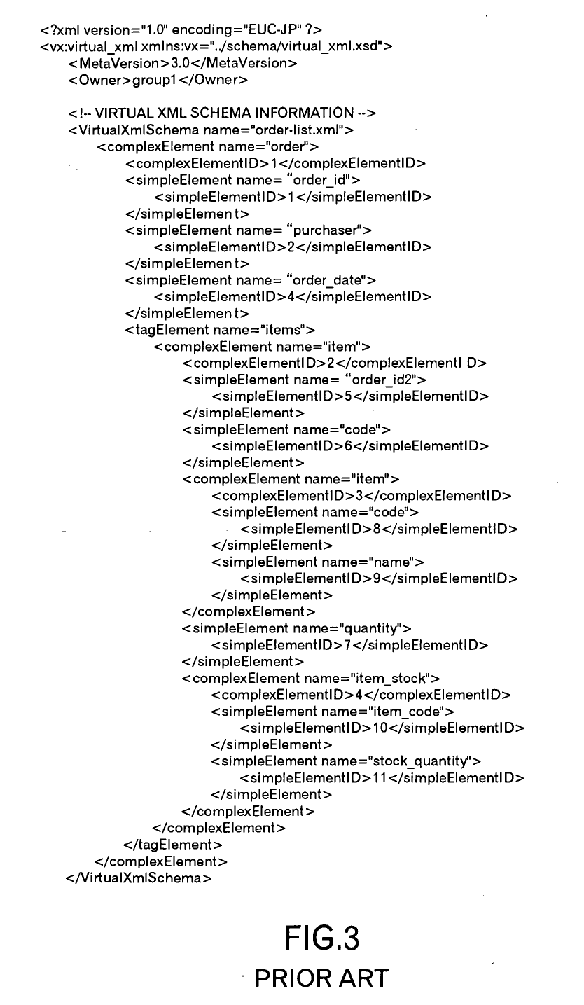

FIG. 4 is a diagram showing a second portion of the conventional DB integration metadata;

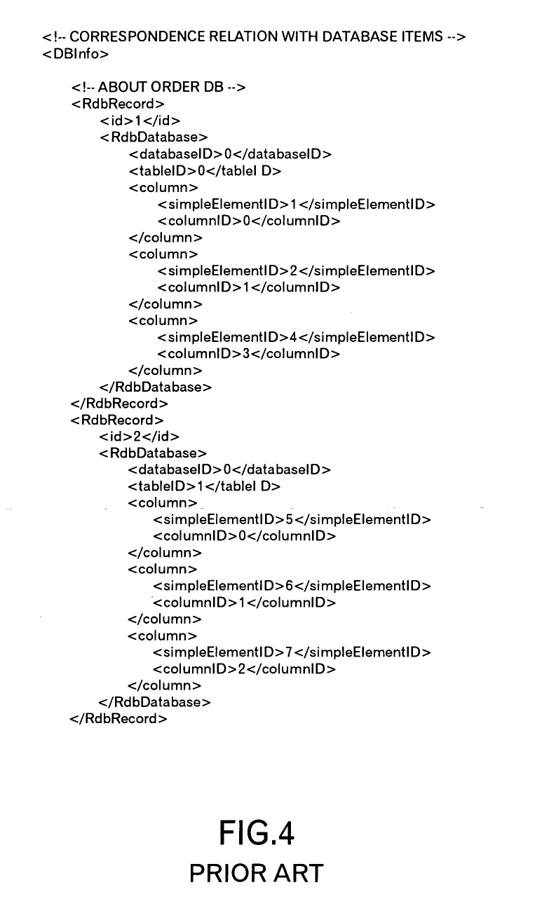

FIG. 5 is a diagram showing a third portion of the conventional DB integration metadata;

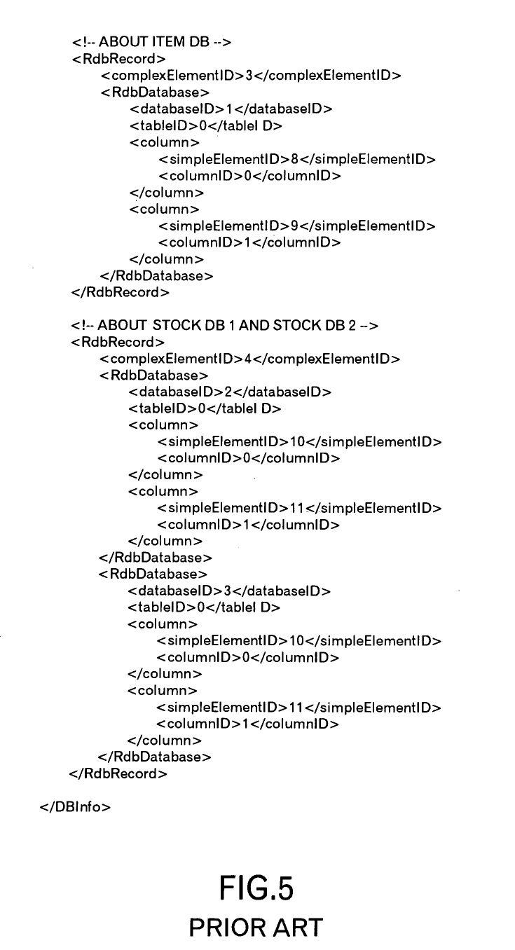

FIG. 6 is a diagram showing a fourth portion of the conventional DB integration metadata;

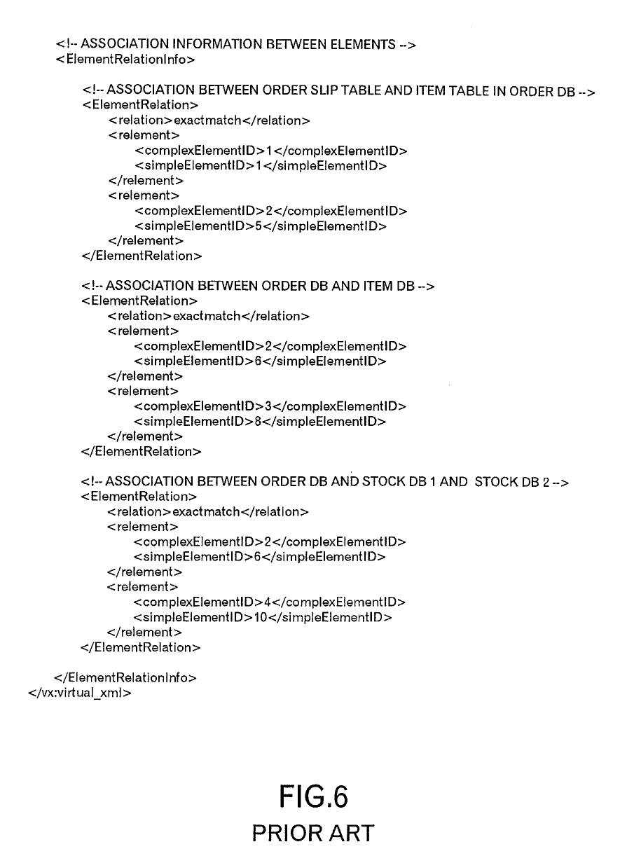

FIG. 7 is a diagram to explain a virtual data view;

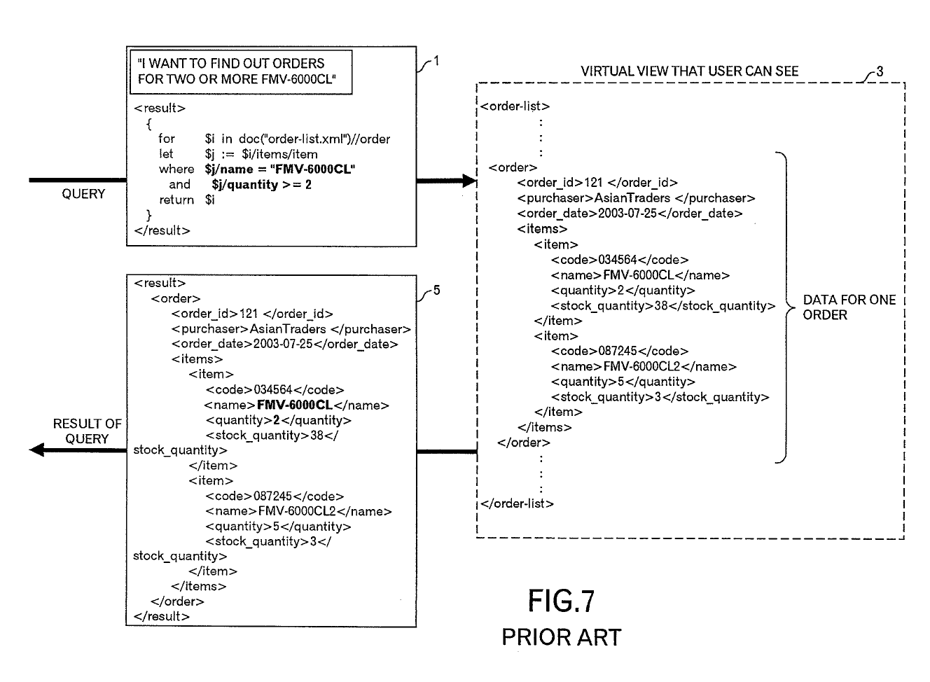

FIG. 8 is a diagram showing a problem in a conventional art;

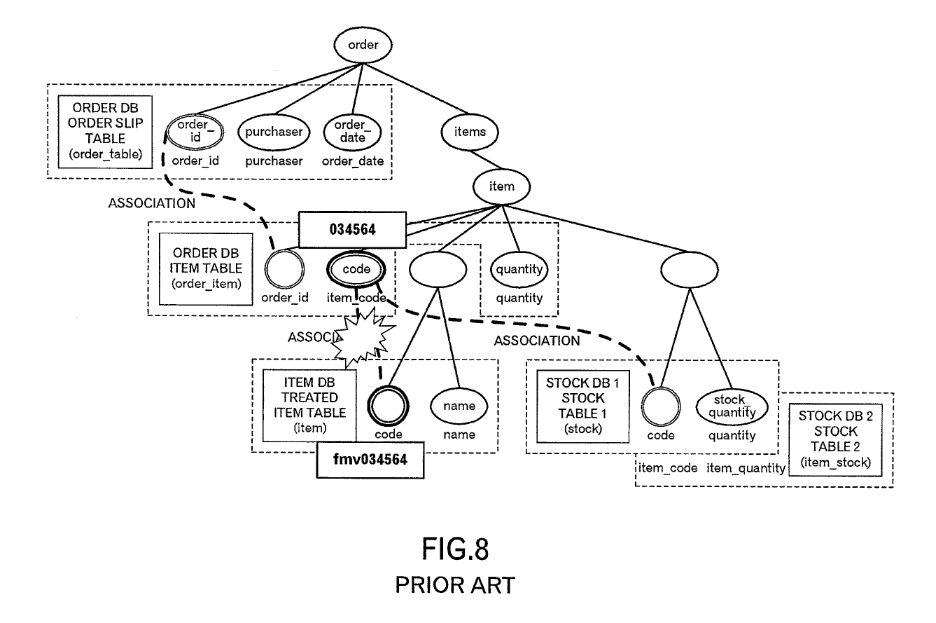

FIG. 9 is a system outline diagram in a first embodiment of this invention;

FIG. 10 is a diagram showing a host B in the first embodiment of this invention;

FIG. 11 is a schematic diagram showing the DB integration metadata in the first embodiment of this invention;

FIG. 12 is a diagram showing a first portion of the DB integration metadata in the first embodiment of this invention;

FIG. 13 is a diagram showing a second portion of the DB integration metadata in the first embodiment of this invention;

FIG. 14 is a diagram showing a third portion of the DB integration metadata in the first embodiment of this invention;

FIG. 15 is a diagram showing a fourth portion of the DB integration metadata in the first embodiment of this invention;

FIG. 16 is a diagram to explain a visible attribute of an element;

FIG. 17 is a schematic diagram showing the DB integration metadata when a value range or format of data in the database is virtualized;

FIG. 18 is a diagram showing an example of a bi-directional filter to carry out data coupling or decomposing;

FIG. 19 is a diagram showing a first portion of a processing flow in the first embodiment of this invention;

FIG. 20 is a diagram showing a specific example in a first stage to explain the processing flow in the first embodiment of this invention;

FIG. 21 is a diagram showing a specific example in a second stage to explain the processing flow in the first embodiment of this invention;

FIG. 22 is a diagram showing a specific example in a third stage to explain the processing flow in the first embodiment of this invention;

FIG. 23 is a diagram showing a second portion of the processing flow in the first embodiment of this invention;

FIG. 24 is a diagram showing a specific example in a fourth stage to explain the processing flow in the first embodiment of this invention;

FIG. 25 is a diagram showing a'specific example in a fifth stage to explain the processing flow in the first embodiment of this invention;

FIG. 26 is a diagram showing a specific example in a sixth stage to explain the processing flow in the first embodiment of this invention;

FIG. 27 is a diagram showing a specific example in a seventh stage to explain the processing flow in the first embodiment of this invention;

FIG. 28 is a diagram showing a specific example in an eighth stage to explain the processing flow in the first embodiment of this invention;

FIG. 29 is a diagram showing a specific example in a ninth stage to explain the processing flow in the first embodiment of this invention;

FIG. 30 is a diagram showing a specific example in a tenth stage to explain the processing flow in the first embodiment of this invention;

FIG. 31 is a diagram showing a third portion of the processing flow in the first embodiment of this invention;

FIG. 32 is a schematic diagram of a query result;

FIG. 33 is a diagram showing an example of a bi-directional filter to limit or select the data value;

FIG. 34 is a diagram showing a first portion of a processing flow when the bi-directional filter to limit or select the data value is described;

FIG. 35 is a diagram showing a processing flow of a first search processing;

FIG. 36 is a diagram showing a second portion of the processing when the bi-directional filter to limit or select the data value is described;

FIG. 37 is a diagram showing a processing flow of a second search processing;

FIG. 38 is a diagram showing a second example of the DB integration metadata;

FIG. 39 is a diagram showing a second example of the DB integration metadata;

FIG. 40 is a diagram showing a second example of the DB integration metadata;

FIG. 41 is a diagram showing a second example of the DB integration metadata;

FIG. 42 is a diagram showing a database in which XML-DB coexists;

FIG. 43 is a diagram to explain a one-directional filter;

FIG. 44 is a diagram showing an example of the one-directional filter;

FIG. 45 is a diagram showing an example of the one-directional filter, which carries out an m-to-n conversion;

FIG. 46 is a diagram showing a specific example (first stage) to explain a processing flow in a second embodiment of this invention;

FIG. 47 is a diagram showing a first portion of the processing flow in the second embodiment of this invention;

FIG. 48 is a diagram showing a processing flow of an upward conditional expression group generation processing;

FIG. 49 is a diagram showing a specific example (second stage) to explain the processing flow in the second embodiment of this invention;

FIG. 50 is a diagram showing a second portion of the processing flow in the second embodiment of this invention;

FIG. 51 is a diagram showing a specific example (third stage) to explain the processing flow in the second embodiment of this invention;

FIG. 52 is a diagram showing a specific example (fourth stage) to explain the processing flow in the second embodiment of this invention;

FIG. 53 is a diagram showing a specific example (fifth stage) to explain the processing flow in the second embodiment of this invention;

FIG. 54 is a diagram showing a specific example (sixth stage) to explain the processing flow in the second embodiment of this invention;

FIG. 55 is a diagram showing a specific example (seventh stage) to explain the processing flow in the second embodiment of this invention;

FIG. 56 is a diagram showing a specific example (eighth stage) to explain the processing flow in the second embodiment of this invention;

FIG. 57 is a diagram showing a third portion of the processing flow in the second embodiment of this invention;

FIG. 58 is a diagram showing a specific example (first stage) to explain the processing flow in the second embodiment of this invention;

FIG. 59 is a diagram showing a specific example (second stage) to explain the processing flow in the second embodiment of this invention;

FIG. 60 is a diagram showing a specific example (third stage) to explain the processing flow in the second embodiment of this invention;

FIG. 61 is a diagram showing a specific example (fourth stage) to explain the processing flow in the second embodiment of this invention;

FIG. 62 is a diagram showing a specific example (fifth stage) to explain the processing flow in the second embodiment of this invention;

FIG. 63 is a diagram showing a specific example (sixth stage) to explain the processing flow in the second embodiment of this invention;

FIG. 64 is a diagram showing a specific example (seventh stage) to explain the processing flow in the second embodiment of this invention; and

FIG. 65 is a functional block diagram of a computer.

### DETAILED DESCRIPTION OF THE PREFERRED EMBODIMENTS

### Embodiment 1

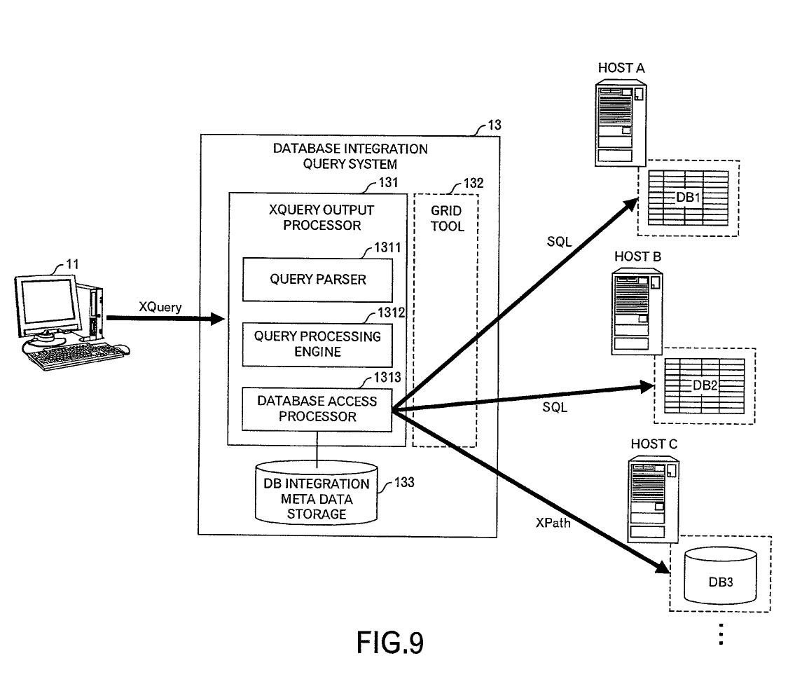

FIG. 9 shows a system outline according to a first embodiment of this invention. A user terminal 11 is connected with a database integration query system 13 through a network (not shown) or the like. Incidentally, the user terminal 11 may not be connected, but another computer utilizing the database integration query system 13 may be connected. In addition, the database integration query system 13 is connected with hosts A to C managing databases to be integrated through other networks (not shown). In the example of FIG. 9, the host A manages a DB 1 of RDB, the host B manages a DB 2 of the RDB, and the host C manages a DB 3 of XML-DB. Incidentally, the databases to be integrated may be limited only to the RDB, and the databases to be integrated may further include the XML-DB.

The database integration query system 13 includes an XQuery output processor 131, a grid tool 132, and a DB integration metadata storage 133. The XQuery output processor 131 includes a query parser 1311, a query processing engine 1312, and a database access processor 1313.

The DB integration metadata stored in the DB integration metadata storage 133 is a rule for the view generation. Prior to the query execution, this is created in advance, and stored in the DB integration metadata storage 133. Plural types of the DB integration metadata may be prepared according to the integration method of the database and the view structure to be shown. In addition, the extensible Markup Language (XML) is adopted for the description of the DB integration metadata in this embodiment. However, other languages such as SGML may be adopted.

The query parser 1311 of the XQuery output processor 131 accepts a query by the XQuery that is a query language being standardized in W3C, for example, and carries out a syntax analysis, and converts the query into an internal format (e.g. syntax tree) when there is no problem in the syntax check. Although the XQuery is used here, XPath (see http://www.w3.org/TR/xpath) may be adopted. In order to access to the integrated virtual data view, the user outputs, from the user terminal 11, a query for the virtual XML data, which uses the XQuery, to the database integration query system 13.

The query processing engine 1312 actually processes the query by the XQuery, for which the query parser 1311 carried out the syntax analysis, judges what query should be output to each database in what order to obtain data corresponding to the query, and outputs individual queries (also called as a sub query) to respective databases. In addition, in order to finally reply data obtained from each database in response to the query to the user terminal 11, the query processing engine 1312 also carries out an assembling processing to the XML data.

When receiving a query request from the query processing engine 1312, the database access processor 1313 carries out accesses to the databases through the grid tool 132. A conventional technique can be used for the queries for the plural and different types of databases as it is, and for instance, Globus Toolkit 4+OGSA-DAI WSRF 2.1, which is a grid middleware of the open source, can be used. As a result, the database access processor 1313 outputs the queries according to SQL, for the RDB, and the queries according to, for example, XPath, for the XML-DB.

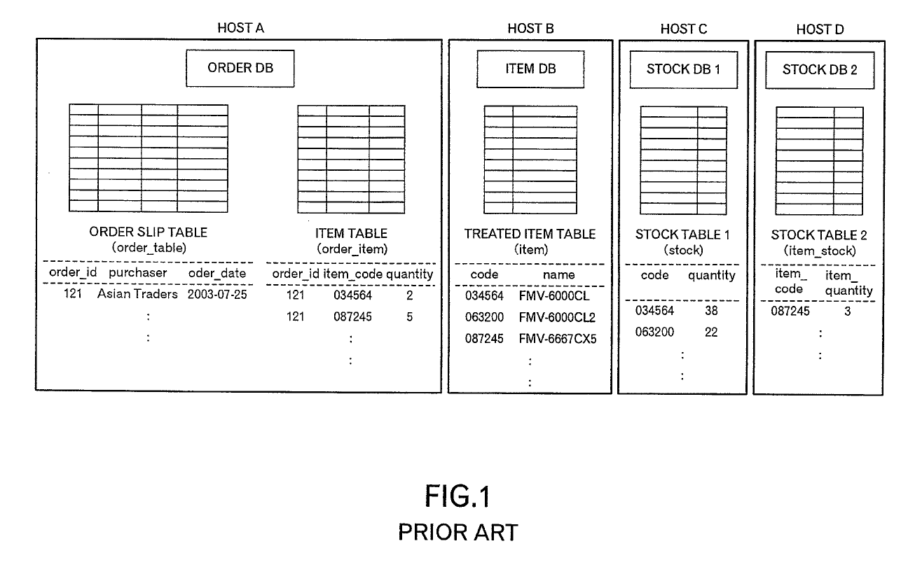

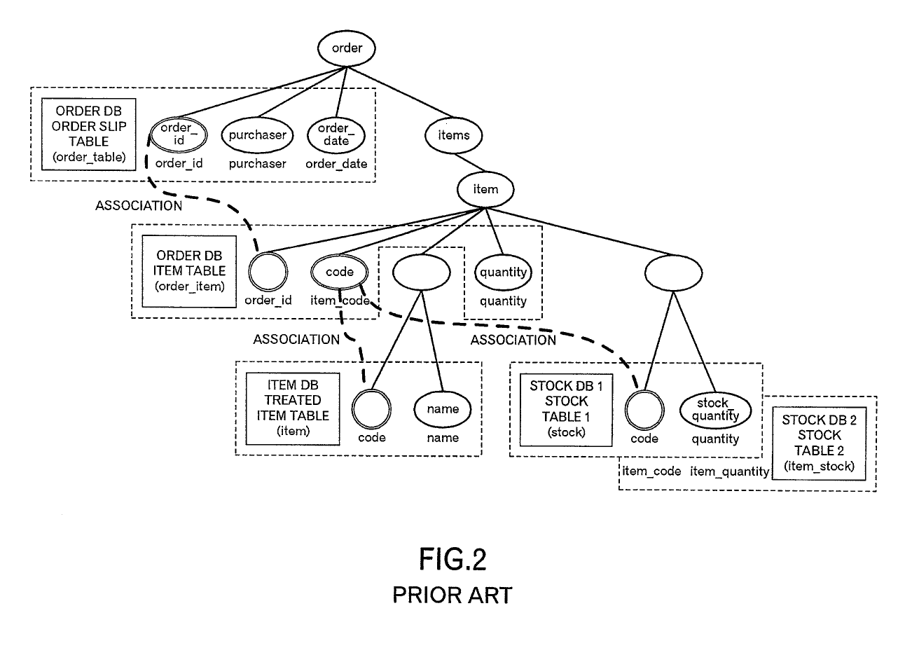

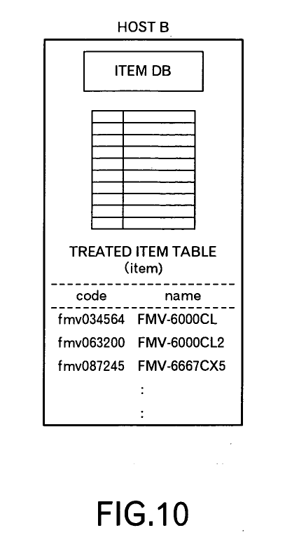

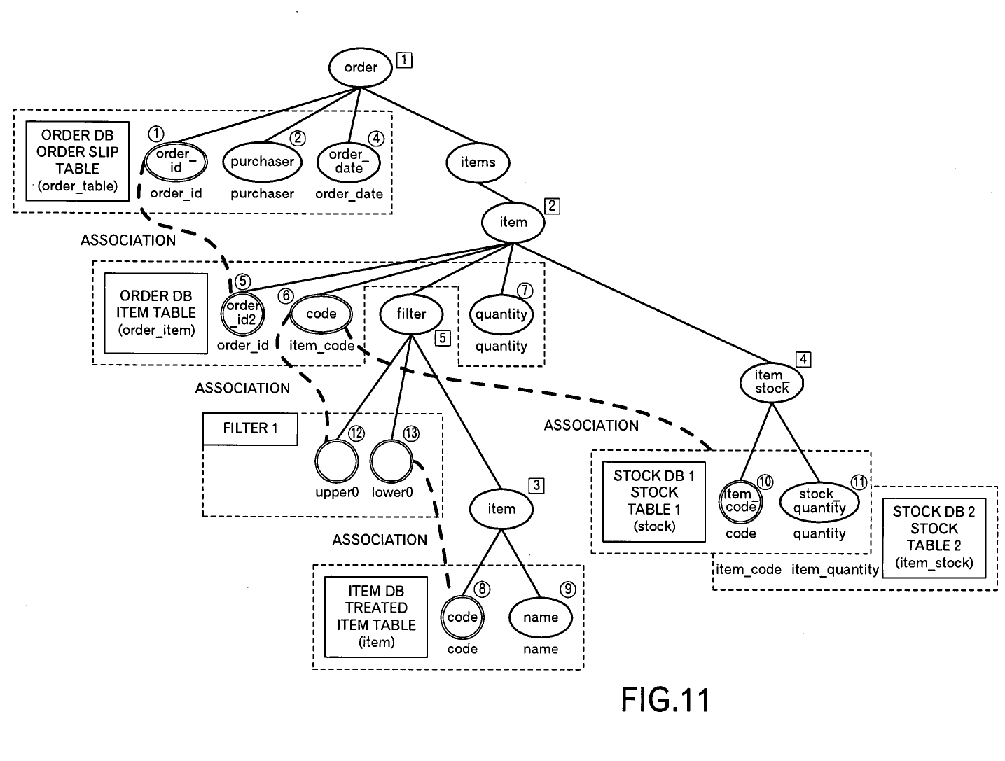

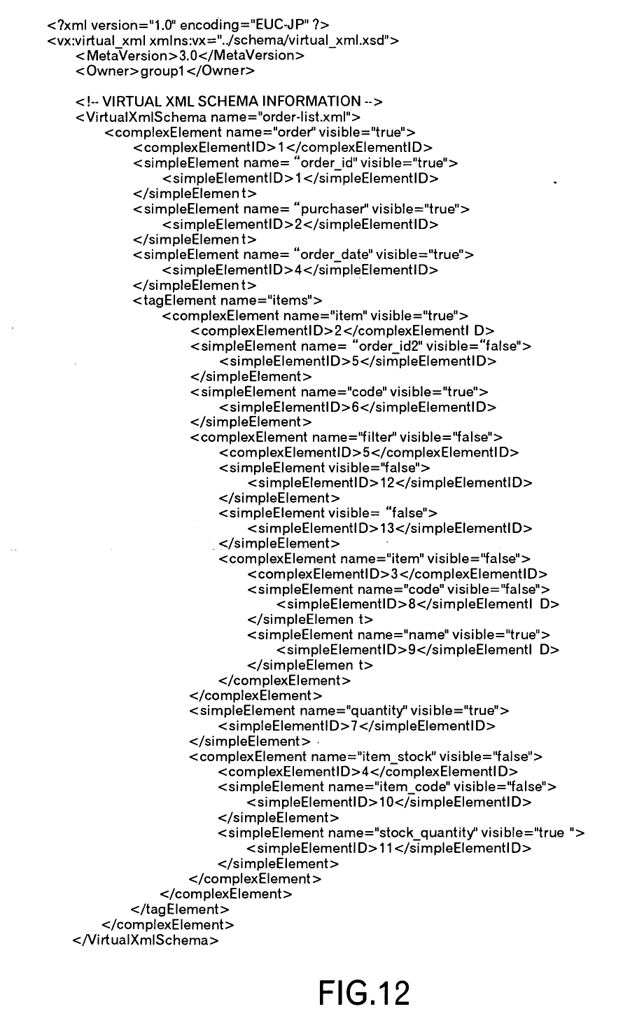

In addition, the integration metadata created when the treated item table of the item DB in FIG. 1 is replaced with the treated item table of the item DB in FIG. 10 can be schematically shown in FIG. 11. Although the basic structure is the same as that in FIG. 2, a Filter 1 is added as the bi-directional conversion function. Namely, a node whose name is “filter”, a child node whose label is “upper0”, and a child node whose label is “lower0” are added. Then, the node whose label is “upper0” is associated with a node whose name is “code”, in the item table of the order DB, and the node whose label is “lower0” is associated with the node whose name is “code”, in the treated item table of the item DB. Data shown in FIG. 11 is described as XML data as shown in FIGS. 12 to 15, specifically.

This DB integration metadata includes three data portions.

### (1) Virtual XML Schema Information (FIG. 12)

This is information concerning how to show the associated data extending in the plural databases, for the user, as XML data having a certain structure.

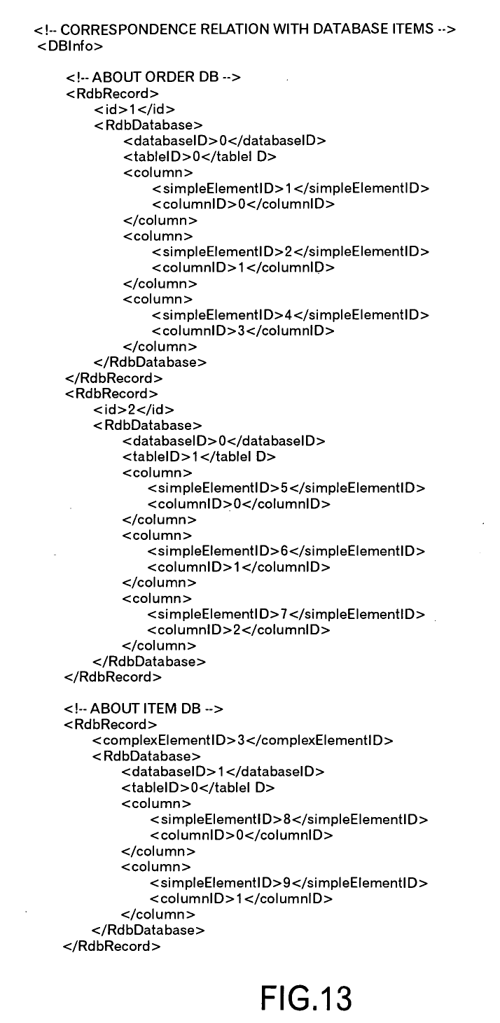

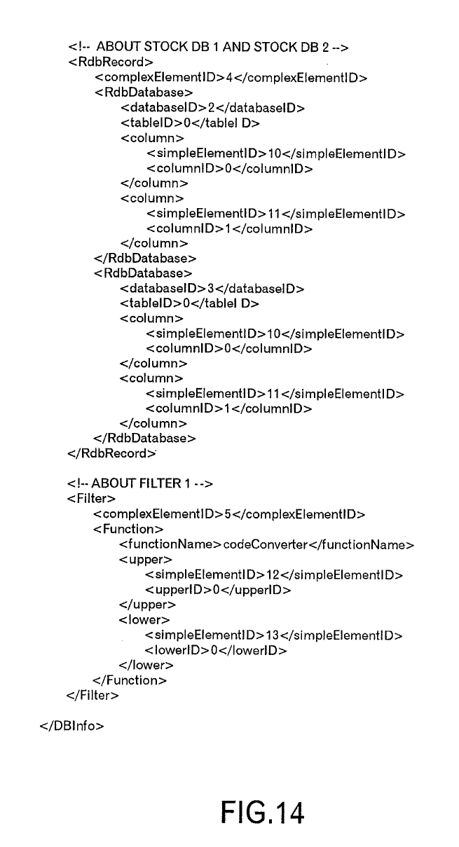

(2) Correspondence Relation with Database Item (FIGS. 13 and 14)

This is information concerning what item in what database corresponds to each node in XML.

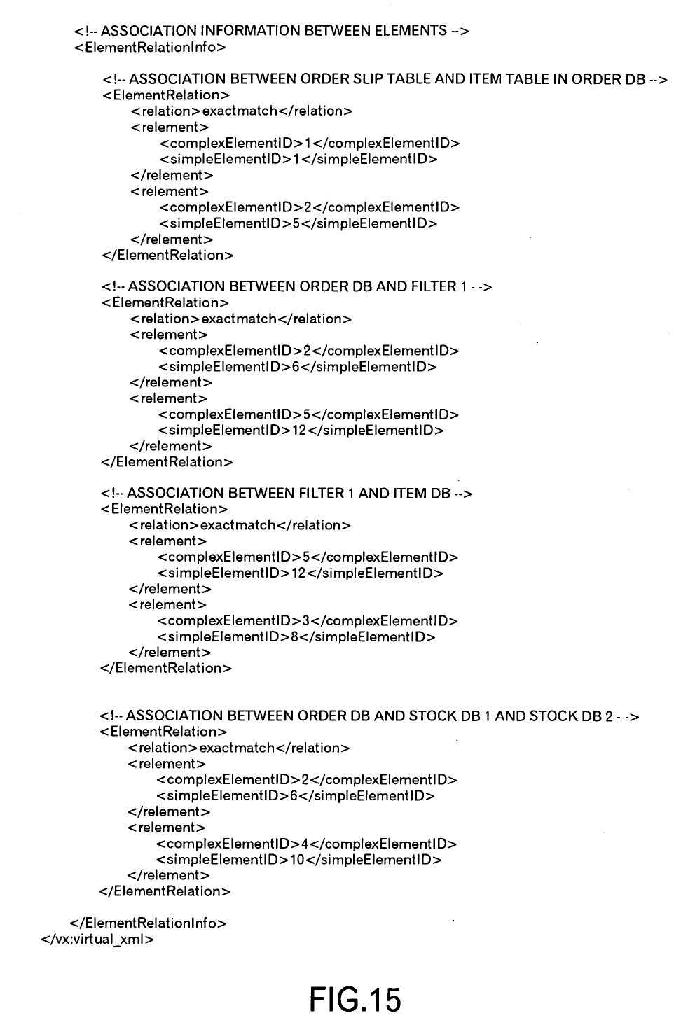

### (3) Association Information Between Elements (FIG. 15)

When XML data or tupples in different databases are associated and treated as one element, this is information concerning what items in respective databases are associated.

In the following, the details are respectively explained.

### (1) Virtual XML Schema Information (FIG. 12)

In the virtual XML schema information, the XML structure of the integrated data view is defined by using a format similar to the XML Schema. The nodes constructing the schema are categorized into three types.

### (1-1) ComplexElement

This is an intermediate node having other nodes under it. In the example of FIG. 11, a node whose name is “order” (No. 1 surrounded by a square), nodes whose name is “item” (Nos. 2 and 3 surrounded by a square), a node whose name is “item_stock” (No. 4 surrounded by a square) and a node whose name is “filter” (No. 5 surrounded by a square) are treated as “ComplexElement”. The number surrounded by a square shows an ID of the node.

When the corresponding database is the RDB, a combination of this node and SimpleElements under this node corresponds to one tupple in the database. When the corresponding database is the XML-DB, this node is an intermediate node having other nodes under this node, and means it does not have any value. Under this node, any type of the three types of nodes may appear. In addition, this node has attributes.

### Name (Name):

a tag name of this node on the virtual data view

### Visibility (Visible):

whether or not this node is displayed on the virtual data view

When the value is “true”, this node is displayed, and when the value is “false”, this node is not displayed. When this node is not displayed, this node cannot be included in the query.

### Maximum Number of Appearances:

the upper limit of the number of times this node repeatedly appears

### Minimum Number of Appearances:

the lower limit of the number of times this node repeatedly appears

### (1-2) SimpleElement

A terminal node having a value under this node; In the example of FIG. 11, a node whose name is “order_id”, a node whose name is “purchaser”, and a node whose name is “order_date”, which are included in the order slip table of the order DB, a node whose name is “order_id2”, a node whose name is “code”, and a node whose name is “quantity”, which are included in the item table of the order DB, a node whose label is “upper0”, a node whose label is “lower0”, which are included in the Filter1, a node whose name is “code” and a node whose name is “name”, which are included in the treated item table of the item DB, a node whose name is “item_code” and a node whose name is “stock_quantity”, which are included in the stock table 1 of the stock DB1, are “SimpleElements”. The number included in the circle respectively shows an ID of this node.

When the corresponding database is the RDB, this node corresponds to one column in the tupple, and holds only its value. When the corresponding database is the XML-DB, this node corresponds to a terminal node having a value. Because this node is the terminal node, other nodes cannot appear under this node. In addition, this node holds following attributes.

### Name (Name):

a tag name of this node on the virtual data view

### Visibility (Visible):

whether or not this node is displayed on the virtual data view

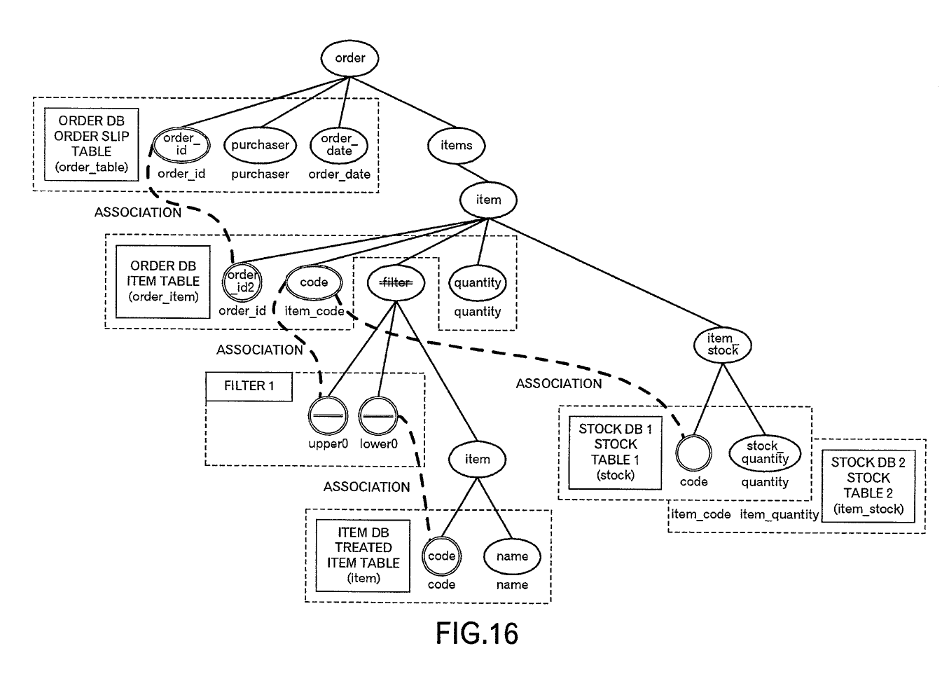

This attribute is the same as that of the Complex Element. For example, when “false” is set to the visible attribute of the ComplexElement whose name is “filter”, the SimpleElement whose label is “upper0” and the SimpleElement whose label is “lower0”, nodes deleted by the double line in FIG. 16 cannot be seen from the user. Similarly, such a node cannot be designated in the query.

### Schemaless Designation:

When the pertinent database is the XML-DB, this attribute designates whether or not the appearance of the free schema under this node is allowed by treating, as the simple character string, all of the tags appeared under this node.

### (1-3) TagElement

This node is a dummy node to insert a tag. In FIG. 11, this node corresponds to a node whose name is “items”. This node does not have any corresponding database element. Any type of the three types of nodes may appear under this node. In addition, this node has a following attribute.

Name (Name): A Tag Name of this Node on the Virtual Data View.

In addition, a unique ID is given to the ComplexElement and TagElement in order to make a correspondence relation with a database item corresponding to either of those nodes. Those IDs are called as ComplexElement-ID and SimpleElement-ID, respectively.

When the corresponding database is the RDB, a set of one ComplexElement and one or more SimpleElements corresponds to one tupple of the RDB, and a tree structure is assembled by mutually coupling the sets together. At a time of the coupling, items for which the association (i.e. matching of values) can be made between both nodes are required. Irrelevantly to those, it is possible to insert the TagElement at a position where a dummy tag should be added.

When the corresponding database is the XML-DB, it is necessary to construct the virtual XML schema so as to conform with the schema of the XML data stored in the XML-DB. When a tag, which does not exist in the schema of the original XML data, should be added, the TagElement has to be used. When a tag, which exists in the schema of the original XML data, should be deleted, it is possible to treat such a case by setting “False” to the attribute “Visible” of the tag.

(2) Correspondence Relation with Database Item (FIGS. 13 and 14)

As for the correspondence relation with the database item, information concerning what item in what database actually corresponds is described in each element (ComplexElement, SimpleElement) in the virtual XML schema. Content to be described is much different, depending on RDB or XML-DB, which is the corresponding database.

When the corresponding database is the RDB, it is described that each ComplexElement corresponds to which table in which RDB, and each SimpleElement under the ComplexElement corresponds to which column in the table. Examples of FIGS. 13 and 14 include data for the order slip table (ID=0) of the order DB (ID=0), data for the item table (ID=1) of the order DB, data for the treated item table (ID=0) of the item DB (ID=1), data for the stock table 1 (ID=0) of the stock DB 1 (ID=2) and data for the stock table 2 (ID=2) of the stock DB 2 (ID=3). This portion also describes that the stock table 1 of the stock DB 1 and the stock table 2 of the stock DB 2 use the same SimpleElement.

In addition, when the corresponding database is the XML-DB, it is described that a sub tree composed of which ComplexElement corresponds to what data in the XML-DB. Furthermore, when the tag name on the view is different from the tag name on the XML-DB, such correspondence is described (as for the ComplexElement and SimpleElement, which are not described, it is supposed that the tag name on the view is the same as the tag name on the XML-DB.).

In this embodiment, the bi-directional filter (i.e. bi-directional conversion function) and the database are equally handled, and the correspondence relation between the element in the virtual XML schema and the bi-directional filter is also described. Similarly to the case of the RDB, it is described that one ComplexElement corresponds to a bi-directional filter, and the following information is also described.
(a) a name of the bi-directional filter to be called (in the example of FIG. 14, “codeConverter”)
(b) a list of SimpleElements used for the input/output in the upper side (in the example of FIG. 14, SimpleElement (ID=12))
(c) a list of SimpleElements used for the input/output in the lower side (in the example of FIG. 14, SimpleElement (ID=13))

### (3) Association Information Between Elements (FIG. 15)

In the association information between the elements, coupling information between “sets of ComplexElement and SimpleElement”, which correspond to the RDB and coupling information between the set and the XML sub tree corresponding to the XML-DB are described. Specifically, it is described that a value matching between which SimpleElement and which SimpleElement should be carried out. Basically, “the complete identity of the values” between one item and one item is handled, but “the complete identity of the values” among the plural items may be handled.

In the example of FIG. 15, the association between the order slip table of the order DB and the item table, the association between the order DB and the filter 1, the association between the filter 1 and the item DB, and the association between the order DB and the stock DB 1 and stock DB 2 are defined. The filter 1 associates the order DB with the item DB like the bridging.

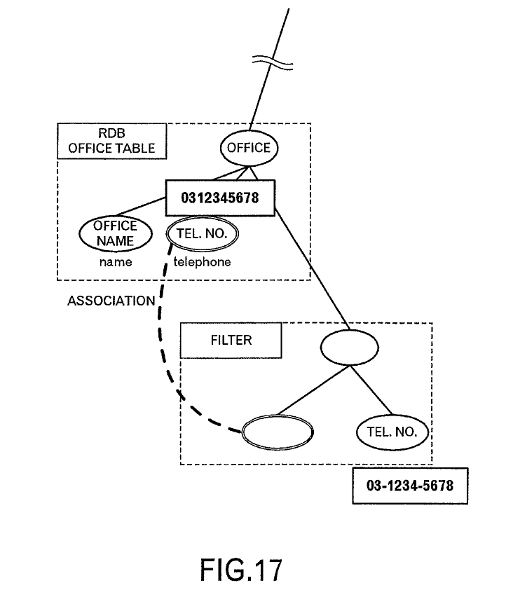

Like the examples of FIGS. 11 to 15, the bi-directional filter introduced in this embodiment is basically used for the association of the elements between the databases. In the example of FIG. 11, the values are not completely identical. Therefore, the bi-directional filter is introduced, because the node whose name is “code” in the item table of the order DB cannot be directly associated with the node whose name is “code” in the treated item table of the item DB. However, the filter can be used for virtualizing the value range or the format of the data in the database. That is, as shown in FIG. 17, the filter is introduced not for connecting an element of a certain database with an element of another database, but only under an element of a certain database. For example, a telephone number (e.g. “0312345678”) without any hyphen is stored in the office table of the RDB. However, by the bi-directional filter, it becomes possible to show, as a data view, a telephone number (e.g. “03-1234-5678”) with the hyphens. When “false” is set to the visible attribute of the telephone number, only the telephone number with the hyphens is seen from the user. In addition, when the telephone number with the hyphens is designated as a query condition, the bi-directional filter carries out a processing to delete the hyphens to search the office table of the RDB by the telephone number without the hyphens. In such a case, in the actual integration metadata, only the association between the database and the filter is defined without bridging the databases.

In addition, specific examples of the bi-directional filter are as follows: However, the bi-directional filter is not limited to those examples. The bi-directional filter can be any filter function having the symmetricalness of the conversion.

### (1) Bi-Directional Filter Carrying out Data Conversion

The conversion of the data value by one to one or plurality to plurality is carried out. Following examples can be adopted.
(a) bi-directional conversion between a capital letter and a small letter
(b) bi-directional conversion between a double-byte character and a single-byte character
(c) bi-directional conversion between the telephone number with the hyphens and the telephone number without the hyphens (e.g. FIG. 17)
(d) bi-directional conversion between kana of a Japanese name and roman representation of the Japanese name
(e) bi-directional conversion between a unique noun and another name of it

### (2) Bi-Directional Filter Carrying Out Data Coupling or Decomposing

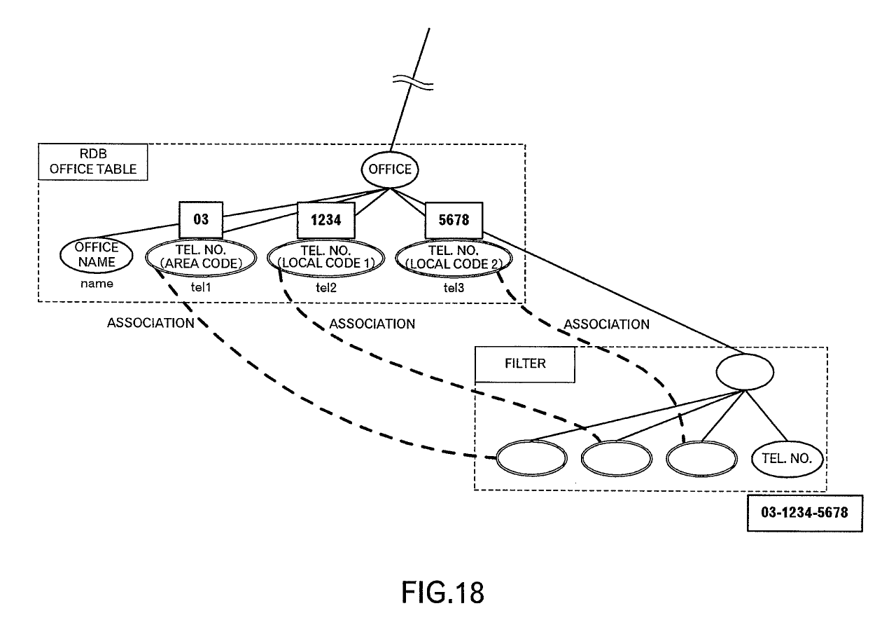

When the bi-directional filter having the input/output of m to n is used, it is possible to carry out the data coupling or decomposing. Specifically, following examples can be adopted.
(a) when the date data is stored in the database in a divided manner like “year”, “month” and “day”, the filter couples them to one to obtain the date data coupled by the hyphens.
(b) when the address data is stored in the database in a divided manner like “prefecture name”, “town name”, “street name”, and “building name”, the filter couples them to one to obtain one character string of the address data. However, although this conversion in the coupling direction is easily carried out, the conversion in the reverse and decomposing direction is carried out by using a knowledge base, for example. Specifically, the decomposing is carried out by using data such as a list of the prefecture names and a list of the town names.
(c) as shown in FIG. 18, when the telephone number in the office table of the RDB is stored in a divided manner like “area code”, “local code1” and “local code2”, the bi-directional filter converts the divided telephone number to the telephone number, which is coupled by the hyphens. In addition, the filter divides the telephone number, which is coupled by the hyphens, into “area code”, “local code1” and “local code2”.

### (3) Bi-Directional Filter to Limit or Select Data

When the bi-directional filter, which has the input/outputs of m to n and to which a constant is set to one or more input/outputs at the one side, is used, the data flowing through this filter is limited (or selected). When the filter of such a type is used, it becomes possible to take only specific data of the data stored in the database in to the virtual data view. As for the filter of this type, the details will be explained later.

Incidentally, the definition data for the conversion processing of the bi-directional filter is stored in the DB integration metadata storage 133.

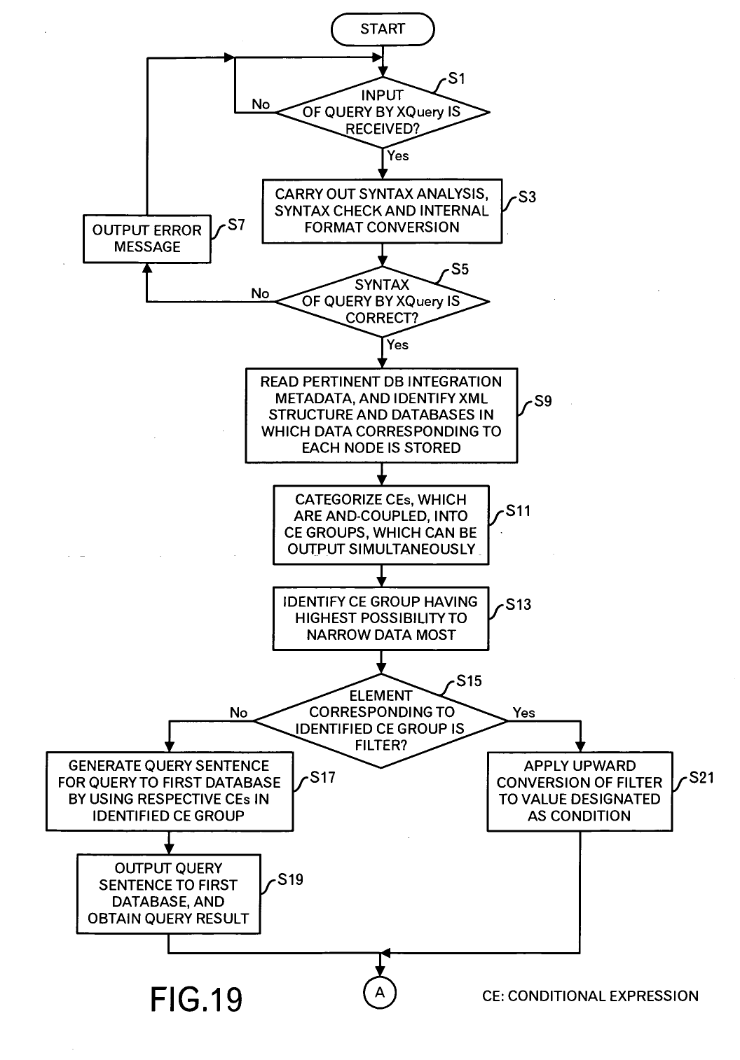

Next, a processing flow of the system shown in FIG. 9 will be explained by using FIGS. 19 to 32. First, the query parser 1311 of the XQuery output processor 131 waits for an input of a query by the XQuery from the user terminal 11 (step S1), and when the input of the query by the XQuery is received, the query parser 1311 carries out the syntax analysis, syntax check and internal format conversion for the received query by the XQuery (step S3). This processing is the same as conventional one, and the detail explanation is omitted.

Incidentally, when the syntax of the query by the XQuery is incorrect (step S5: No route), the XQuery output processor 131 outputs an error message to the user terminal 11 (step S7). Then, the processing returns to the step S1. On the other hand, when the syntax of the query by the XQuery is correct (step S5: Yes route), the query parser 1311 outputs data of the syntax tree to the query processing engine 1312. Then, the query processing engine 1312 reads pertinent portion of the DB integration metadata from the DB integration metadata storage 133, and identifies XML structure and databases in which data corresponding to each node are stored (step S9).

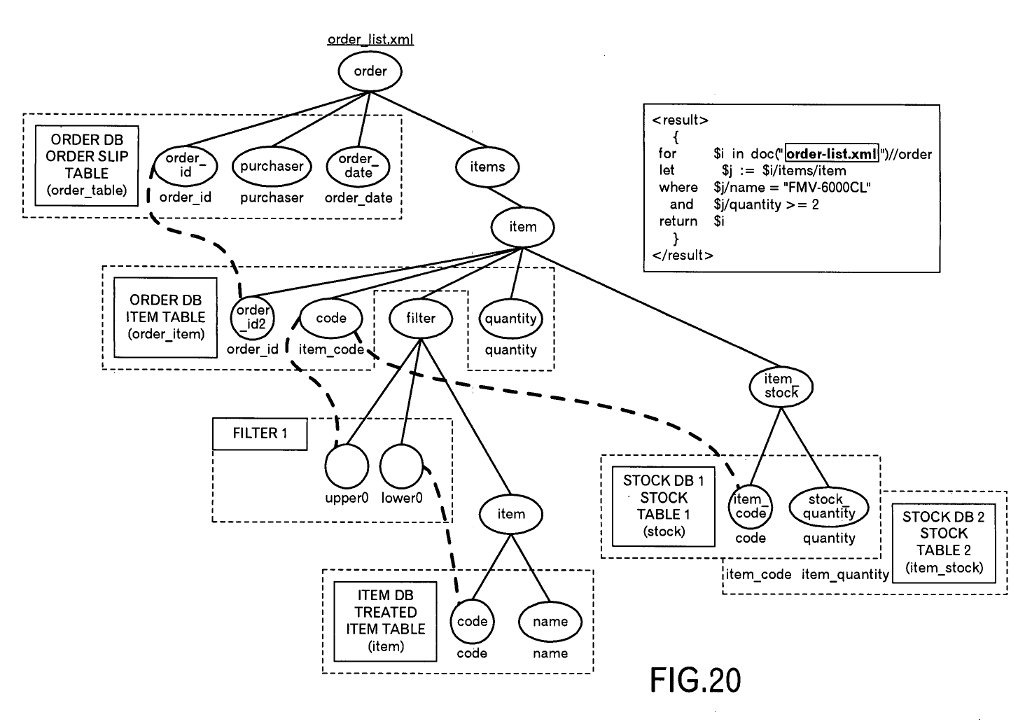

For example, the query by the XQuery to extract orders in which name=FMV-6000CL and the quantity is two or more is described as shown in the upper right of FIG. 20. Here, the pertinent DB integration metadata is designated as “order-list.xml”. Then, the data structure as shown in FIG. 20 is identified. This is the same as FIG. 11, basically.

Next, the query processing engine 1312 categorizes conditional expressions, which are AND-coupled, into some conditional groups, which can respectively be output simultaneously (step S11). For example, the conditional expressions for data items included in the same table and/or database are grouped. Two conditional expressions in the example on the upper right of FIG. 20 are treated separately, because those are conditional expressions for different databases.

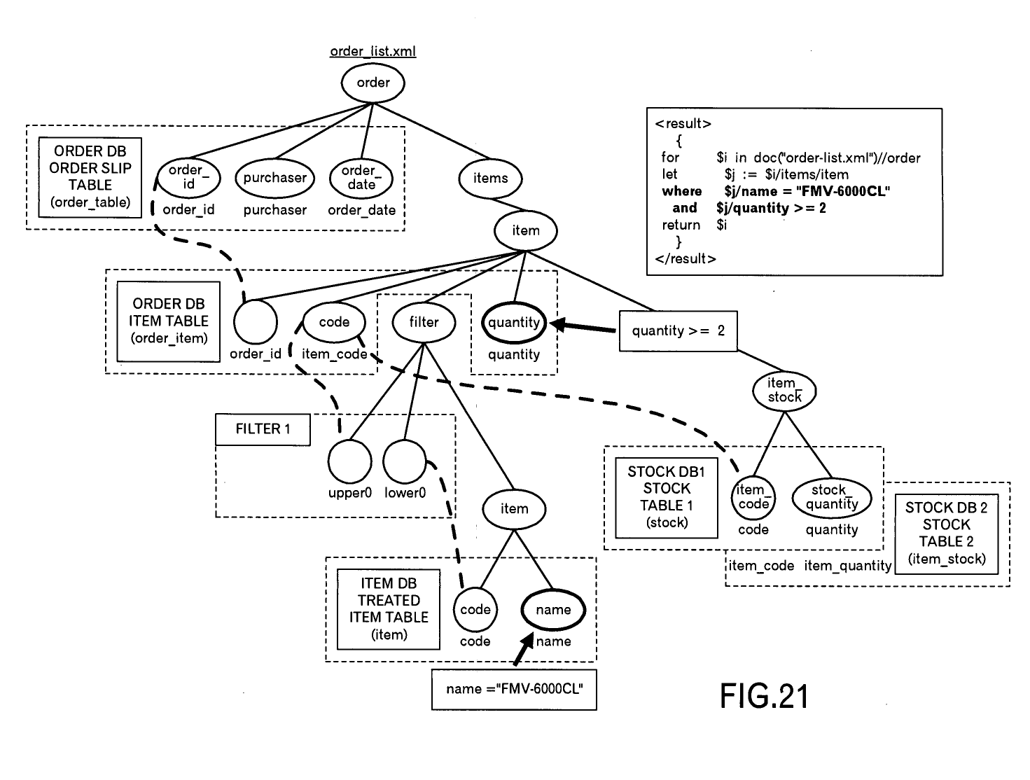

After that, the query processing engine 1312 identifies a conditional expression group that has the highest possibility to narrow the data most (step S13). The character string precedes the numeric value, and the long character string precedes the short character string. As shown in FIG. 21, “FMV-6000CL” for “name” rather than “2” for “quantity” is identified as a condition having the possibility to narrow the data more.

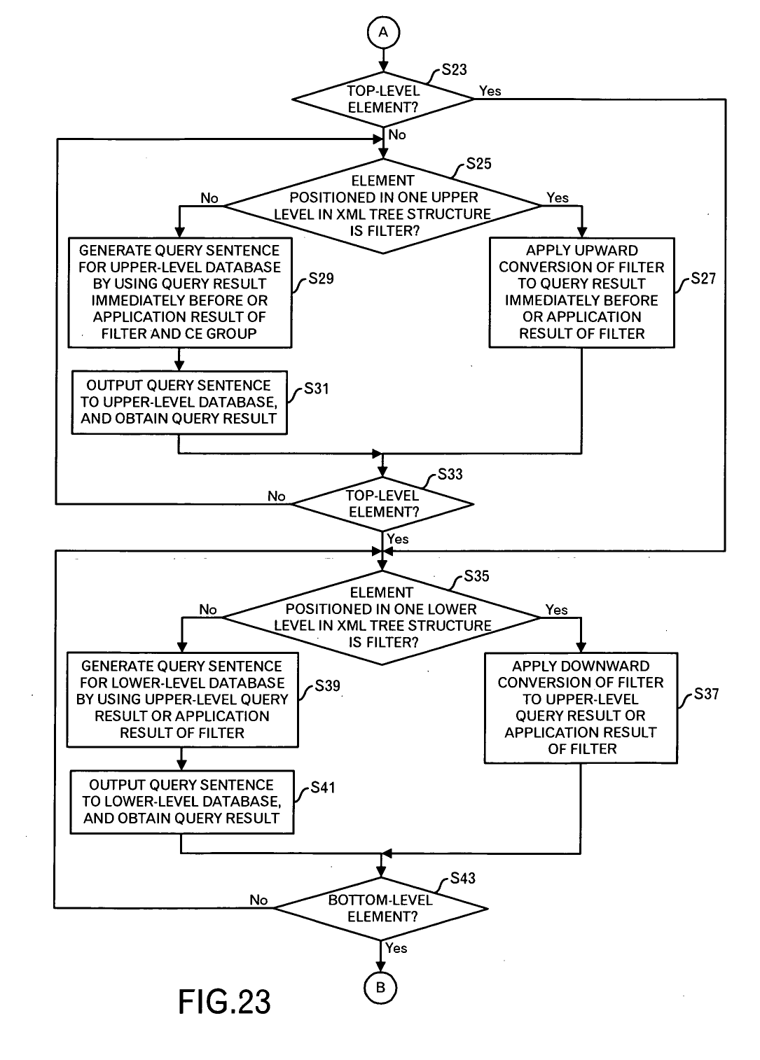

Then, the query processing engine 1312 judges whether or not an element, which corresponds to the conditional expression group identified at the step S13, in the data structure identified from the DB integration metadata is the bi-directional filter (step S15). For example, as shown in FIG. 17, because there is a case where the value range or format of the data in the database is virtualized, there is a case where the element corresponding to the conditional expression group is the bi-directional filter, firstly. When the element corresponding to the conditional expression group identified at the step S13 is the bi-directional filter, the query processing engine 1312 applies the upward conversion of the bi-directional filter to a value designated as a condition (step S21). In a case of the example in FIG. 17, because “03-1234-5678” is designated as a value of the condition, “0312345678” is obtained by the upward conversion of the bi-directional filter. Then, the processing shifts to a processing of FIG. 23 through a terminal A.

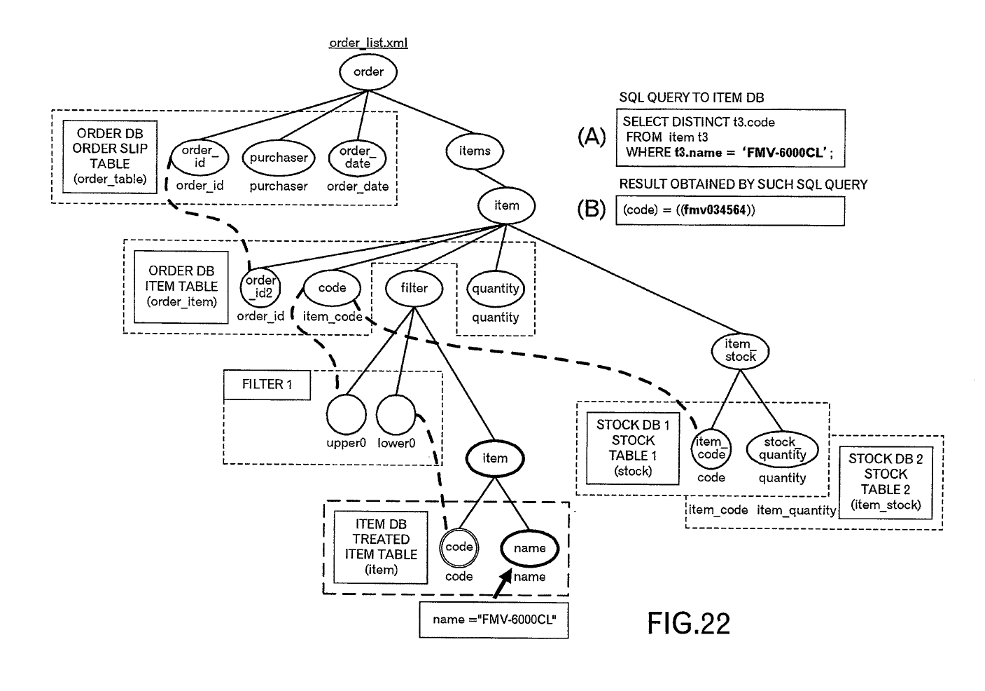

On the other hand, when the element corresponding to the conditional expression group identified at the step S13 is not the bi-directional filter, the query processing engine 1312 generates a query sentence to inquire of the first database by using respective conditions of the identified conditional expression group, and outputs the query sentence to the database access processor 1313 (step S17). For example, an SQL query for the item DB as shown in the upper right (A) of FIG. 22 is generated. Incidentally, basically, a record conforming with the conditional expression group is identified. However, as for the value, only a value of the column associated with the upper-level element is obtained. As shown in FIG. 22, when the “name” column in the treated item table of the item DB is searched by a condition “FMV-6000CL”, the value of the “code” column is identified, because only the “code” column in the treated item table of the item DB is associated with the upper-level element.

Then, the database access processor 1313 outputs the query sentence to a host managing the first database (e.g. the treated item table in the item DB) through the grid tool 132, and obtains a query result (step S19). As shown in the upper right (B) of FIG. 22, the value (fmv034564) of the “code” column is obtained. The database access processor 1313 outputs the query result to the query processing engine 1312. The processing shifts to a processing of FIG. 23 through the terminal A.

Shifting to the explanation of the processing of FIG. 23, the query processing engine 1312 judges whether or not the trace reaches the top-level element (step S23). When the trace reaches the top-level element, the processing shifts to step S35. On the other hand, when the trace does not reach the top-level element, the query processing engine 1312 judges whether or not an element positioned in one upper level in the XML tree structure is a filter (step S25). When the element positioned in one upper level in the XML tree structure is the filter, the query processing engine 1312 applies the upward conversion of the filter to the query result immediately before or the application result of the filter (step S27).

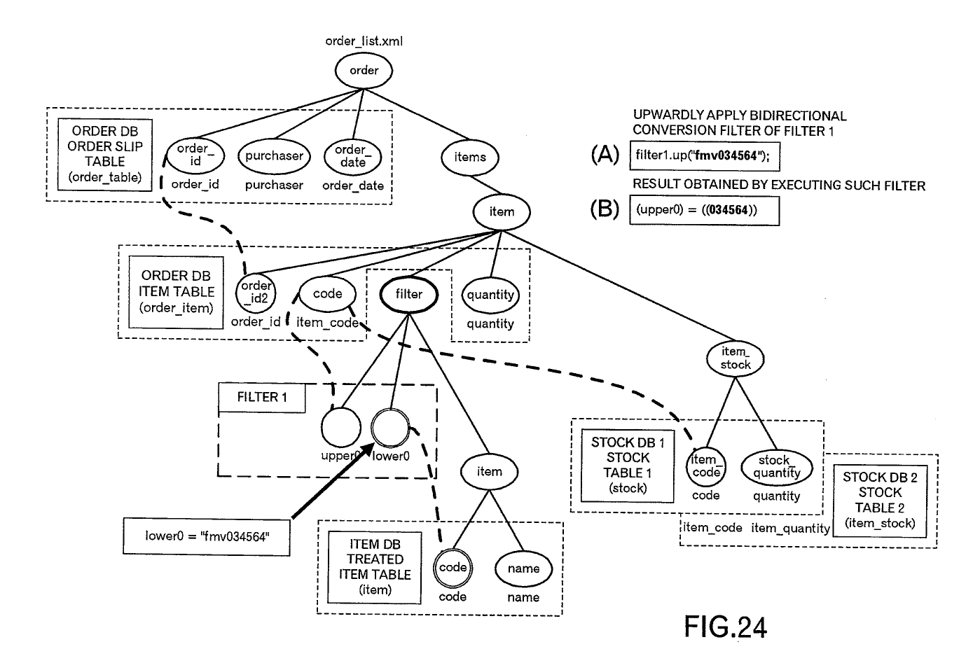

As shown in FIG. 24, because the value of the “code” column of the treated item table in the item DB is “fmv034564”, lower0=“fmv034564” is input to the bi-directional filter, and as shown in the upper right (A) of FIG. 24, the upward conversion filter1.up(“fmv034564”) of the bi-directional filter is carried out, and as shown in the upper right (B), (upper0)=((034564)) is obtained. That is, a value of the “item_code” column in the item table of the order DB, which is a further upper node, is obtained. After that, the query processing engine 1312 judges whether or not the trace reaches the top-level element (step S33). When the trace does not reach the top-level element, the processing returns to the step S25.

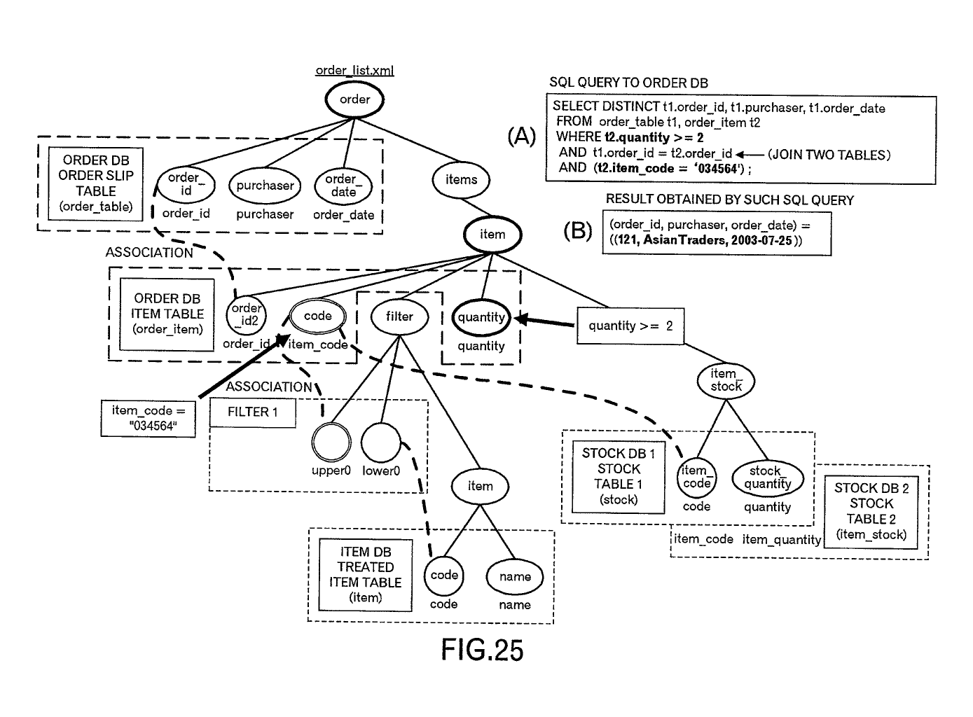

On the other hand, when the element positioned in one upper level in the XML tree structure is not the filter, the query processing engine 1312 generates a query sentence for the upper-level database by using the query result immediately before or the application result of the filter and an unused conditional expression group if it exists, and outputs the query sentence to the database access processor 1313 (step S29). As shown in FIG. 25, by using the value (034564) of the “item_code” column in the item table of the order DB, which is the application result of the filter immediately before, and the unused conditional expression group (e.g. the value of the “quantity” column is two or more), an SQL query for the order DB as shown in the upper right (A) of FIG. 25 is generated. Incidentally, the order DB includes the order slip table in addition to the item table, and the item table associated with the order slip table. Therefore, the search is carried out after carrying out a join of the table by “order_id” column. If possible, by instructing to carry out the join processing together, it becomes possible to reduce the number of query times to the database.

Then, the database access processor 1313 outputs the query sentence to a host managing the database (e.g. order DB) through the grid tool 132, and obtains a query result (step S31). As shown in the upper right (B) of FIG. 25, the value (121) of the “order_id” column, the value (Asian Traders) of the “purchaser” column and the value (2003-07-25) of the “order_date” column in the order slip table of the order DB are obtained. The database access processor 1313 outputs the query result to the query processing engine 1312. The processing shifts to step S33.

After that, the query processing engine 1312 judges whether or not the trace reaches the top-level element in the XML tree structure (step S33). When the trace does not reach the top-level element in the XML tree structure, the processing shifts to the step S25. By carrying out such a repeat processing, values of the top-level element on the XML tree structure are obtained. The values of the top-level element are stored in a storage device. In an example of FIG. 25, the values of the top-level element can be obtained. The upward trace is completed by this processing.

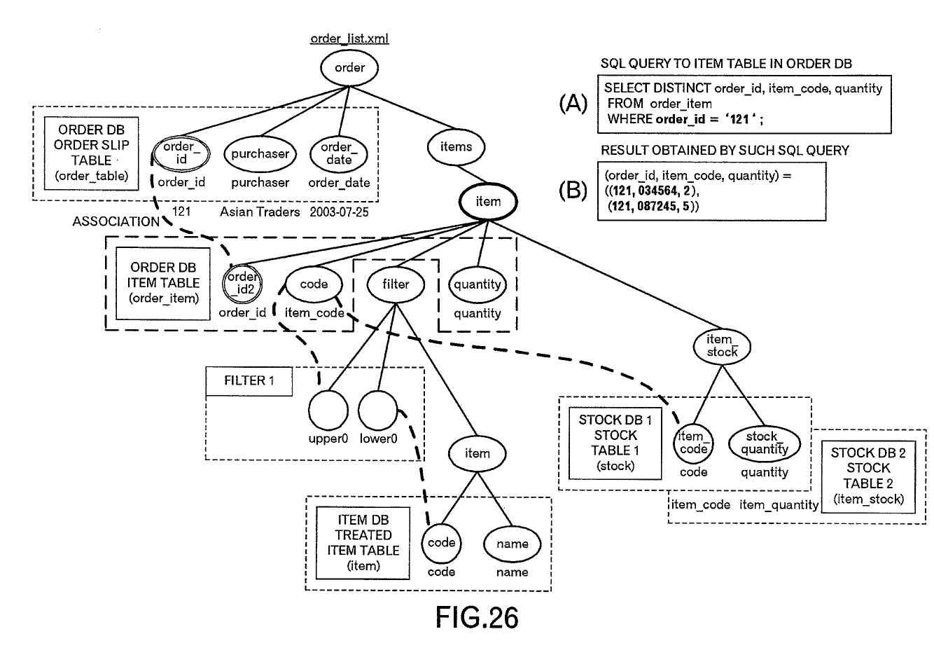

When it is judged at the step S33 that the trace reaches the top-level element, the query processing engine 1312 judges whether or not the element positioned in one lower level in the XML tree structure is a filter (step S35). When the element positioned in one lower level in the XML tree structure is not the filter, the query processing engine 1312 generates a query sentence for the lower-level database by using the upper-level query result or the application result of the filter, and outputs the query sentence to the database access processor 1313 (step S39). As shown in FIG. 26, by using the value (121) of the “order_id” column in the order slip table of the order DB, which is the query result immediately before, an SQL query for the item table of the order DB as shown in the upper right (A) of FIG. 26 is generated.

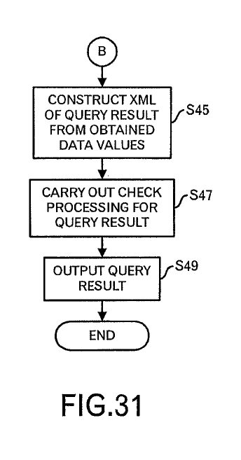

Then, the database access processor 1313 outputs the query sentence to a host managing the database (e.g. the item table of the order DB) through the grid tool 132, and obtains the query result (step S41). As shown in the upper right (B) of FIG. 26, the values (121, 121) of the “order_id” column in the item table of the order DB, the values (034564, 087245) of the “item_code” column and the values (2, 5) of the “quantity” column are obtained. The database access processor 1313 outputs the obtained query result to the query processing engine 1312. Then, the query processing engine 1312 judges whether or not the trace reaches the bottom-level element (step S43). When the trace does not reach the bottom-level element, the processing returns to the step S35. On the other hand, when the trace reaches the bottom-level element, the processing shifts to the processing of FIG. 31 through a terminal B.

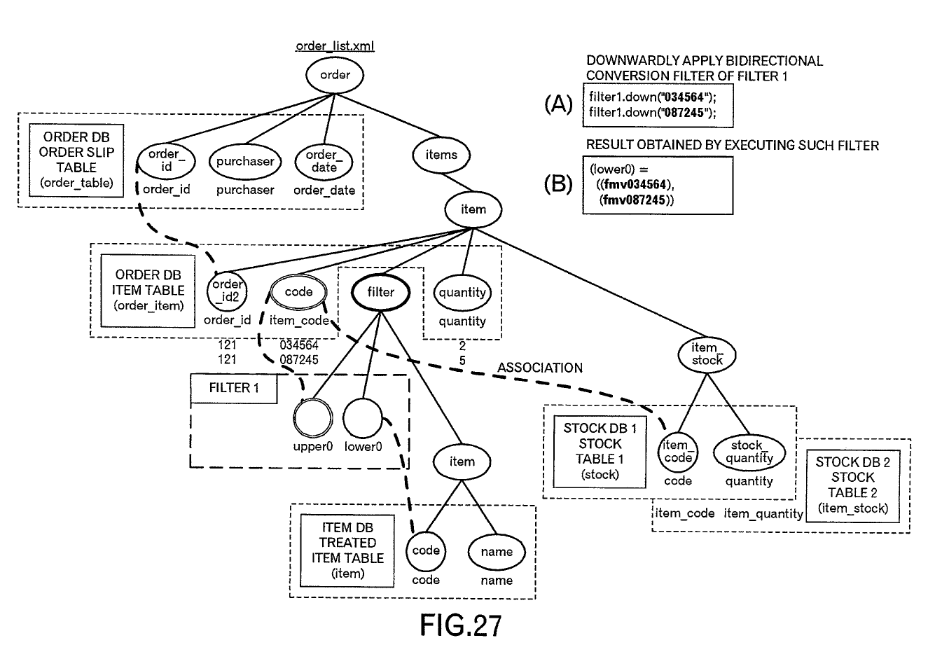

When the element positioned in one lower level in the XML tree structure is the filter, the query processing engine 1312 carries out the downward conversion of the bi-directional filter for the upper-level query result or the application result of the filter (step S37). As shown in FIG. 27, because the filter1 is associated with the “item_code” column in the item table of the order DB, and the downward conversion is carried out by using the values (034564, 087245), which are the upper-level query results as the inputs. That is, as shown in the upper right (A) of FIG. 27, the downward conversion filter1.down(“034564”) and filter1.down(“087245”) of the bi-directional filter are carried out to obtain (lower0)=((fmv034565) (fmv087245)) as shown in the upper right (B). Namely, the values of the “code” column in the treated item table of the item DB, which is in the further lower level, are obtained. After that, the processing shifts to step S43.

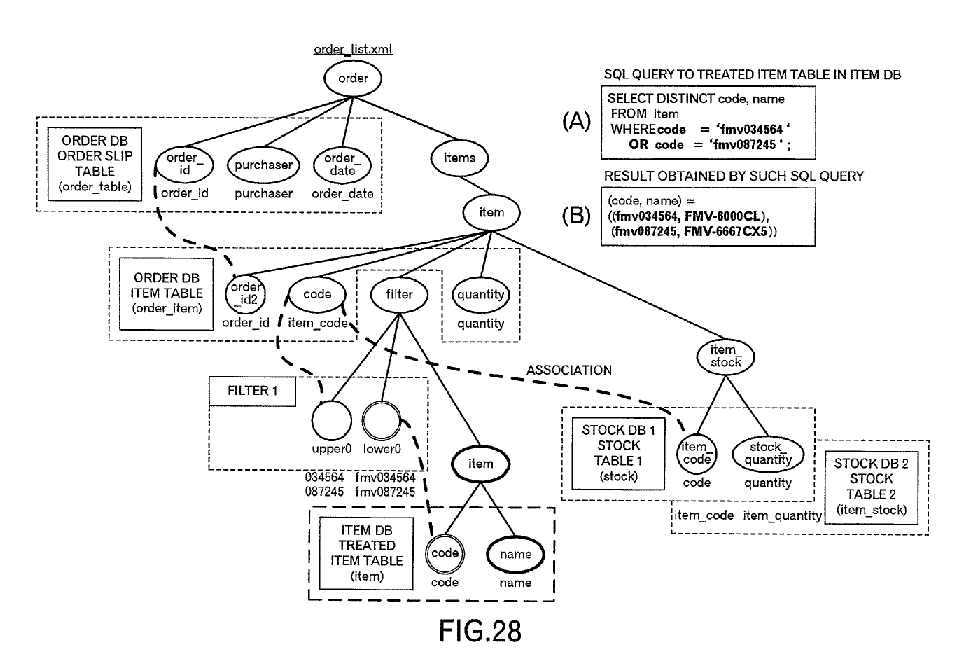

In the example of FIG. 27, because the trace has not yet reached the bottom-level element, the processing returns to the step S35, and the query processing engine 1312 judges whether or not the element positioned in one lower level in the XML tree structure is the filter. Then, because the element positioned in one lower level is not the filter, the processing shifts to the step S39. Then, the query processing engine 1313 generates the query sentence for the lower-level database by using the upper-level query result or the application result of the filter, and outputs the query sentence to the database access processor 1313. As shown in FIG. 28, the query processing engine 1312 generates an SQL query for the treated item table of the item DB, as shown in the upper right (A) of FIG. 28 by using the values (fmv034564, fmv087245) of the “code” column in the treated item table of the item DB, which is the application result of the filter. Because there are two values, the conditions are coupled by “OR”.

Then, the database access processor 1313 outputs the query sentence to a host managing the database (e.g. the treated item table of the item DB) through the grid tool 132, and obtains the query result. As shown in the upper right (B) of FIG. 28, the values (FMV-6000CL, FMV-6667CX5) of the “name” column in the treated item table of the item DB are obtained. The database access processor 1313 outputs the obtained query result to the query processing engine 1312.

Then, the query processing engine 1312 judges whether or not the trace reaches the bottom-level element, again. Because the “item_code” column in the item table of the order DB is also associated with the columns in the stock DB1 and the stock DB2, it is judged that the trace does not reach the bottom-level element. Then, the processing returns to the step S35, and shifts to the step S39.

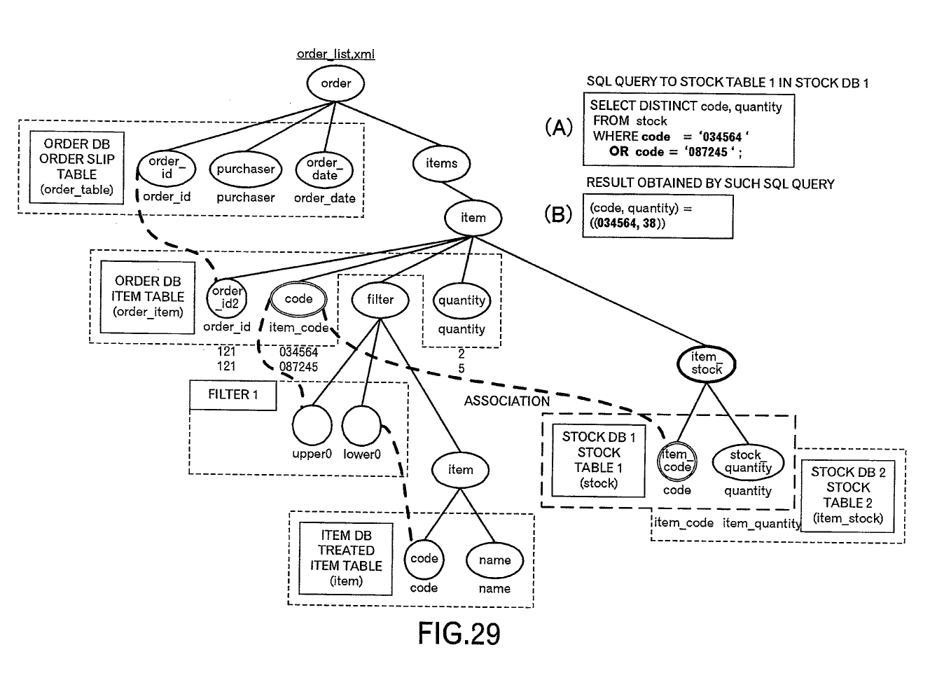

Then, the query processing engine 1312 generates the query sentence for the lower-level database by using the upper-level query result, and outputs the query sentence to the database access processor 1313. As shown in FIG. 29, by using the values (034564, 087245) of the “item_code” column of the item table in the order DB, the SQL query for the stock table 1 of the stock DB 1 as shown in the upper right (A) of FIG. 29 is generated. Because there are two values, the conditions are coupled by “OR”.

After that, the database access processor 1313 outputs the query sentence to a host managing the database (e.g. the stock table 1 of the stock DB 1) through the grid tool 132, and obtains the query result. As shown in the upper right (B) of FIG. 29, the value (034564) of the “code” column in the stock table 1 of the stock DB 1 and the value (38) of the “quantity” column are obtained. The database access processor 1313 outputs the obtained query result to the query processing engine 1312.

Then, the query processing engine 1312 judges again whether or not the trace reaches the bottom-level element. Because the stock table 2 of the stock DB 2 is unprocessed, it is judged that the trace does not reach the bottom-level element. Then, the processing returns to the step S35, and shifts to the step S39.

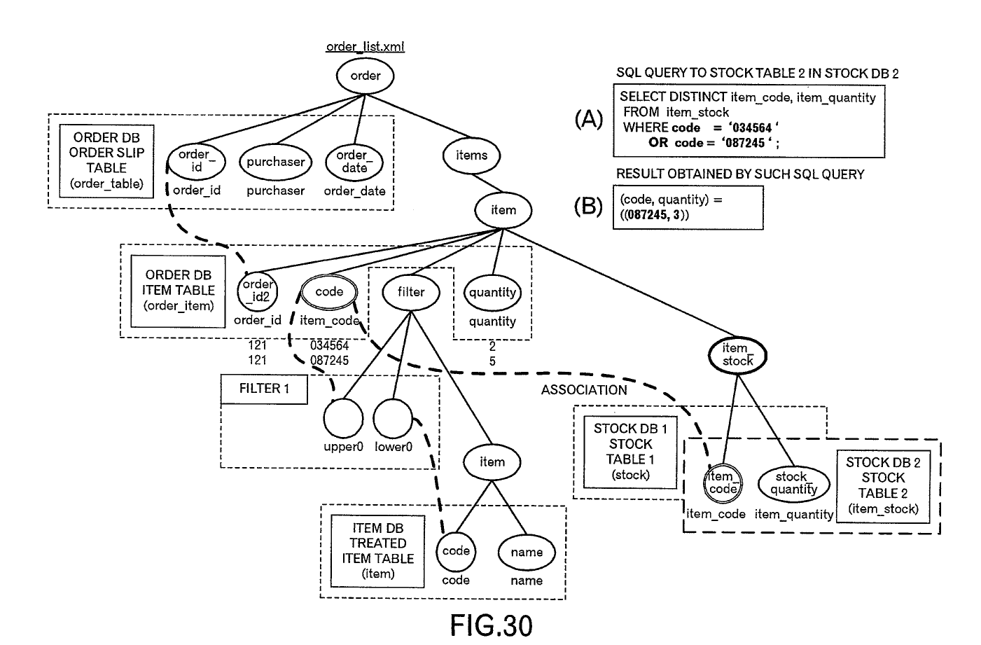

Then, the query processing engine 1312 generates a query sentence for the lower-level database by using the upper-level query result, and outputs the query sentence to the database access processor 1313. As shown in FIG. 30, by using the values (034564, 087245) of the “item_code” column of the item table in the order DB, the SQL query for the stock table 2 in the stock DB 2 as shown in the upper right (A) of FIG. 30 is generated. Because there are two values, the conditions are coupled by the “OR”.

After that, the database access processor 1313 outputs the query sentence to a host managing the database (e.g. the stock table 2 of the stock DB 2) through the grid tool 132, and obtains the query result. As shown in the upper right (B) of FIG. 30, the value (087245) of the “item_code” column in the stock table 2 of the stock DB 2 and the value (3) of the “item_quantity” column are obtained. The database access processor 1313 outputs the obtained query result to the query processing engine 1312.

Then, the query processing engine 1312 judges again whether or not the trace reaches the bottom-level element. Here, it is judged that the trace reaches the bottom-level element, and the processing shifts to the processing in FIG. 31 through the terminal B.

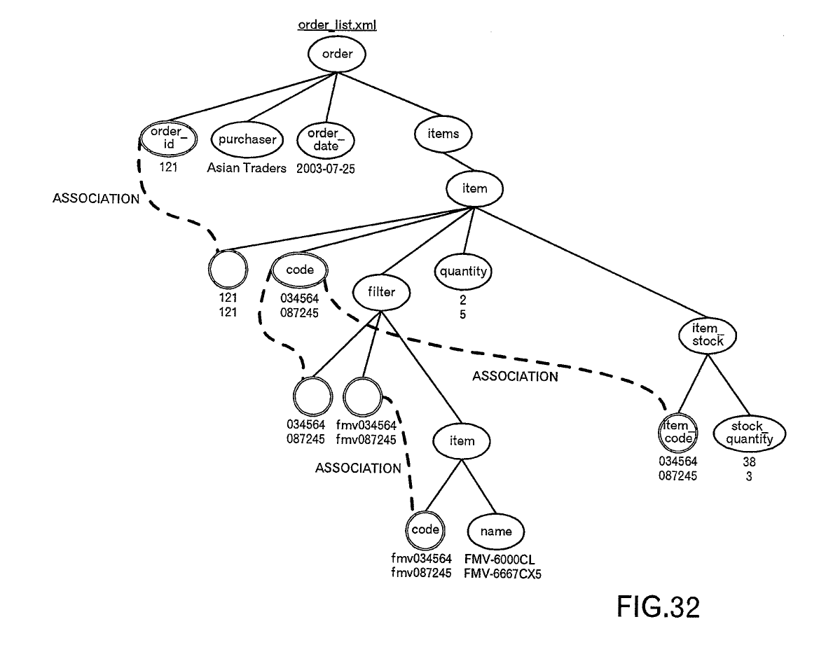

The query processing engine 1312 constructs XML data of the query result from the obtained values according to the DB integration metadata (step S45). For example, the XML data as schematically shown in FIG. 32 is constructed. The obtained data values are embedded in association with the nodes of the SimpleElements, in which “visible=true” is made.

After that, the query processing engine 1312 carries out a check processing of the query results (step S47). Because the possibility that a portion of the query conditions designated in the query by the XQuery has not been reflected yet remains, any solution that does not satisfy the query conditions is excluded from the XML data of the final results by the check processing. Finally, the query processing engine 1312 outputs the query result to the user terminal 11 (step S49).

By carrying out such a processing, it becomes possible to refer to the associated data extending in the plural databases all together.

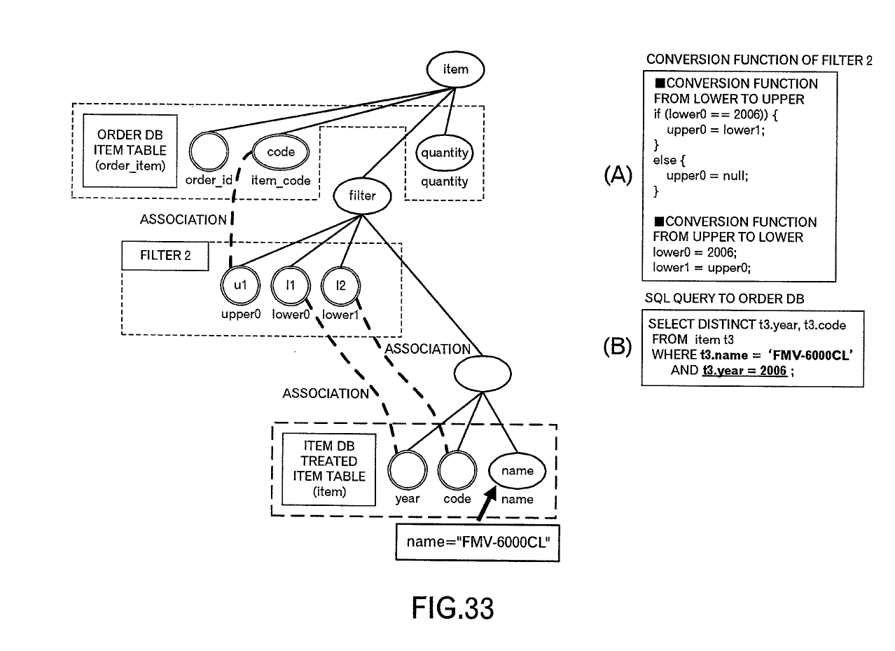

Next, the bi-directional filter for the data limitation or selection will be explained. FIG. 33 shows an example of such a bi-directional filter. In the example of FIG. 33, the “item_code” column of the item table in the order DB is associated with a node whose label is “upper0” in the filter2. In addition, the “year” column of the treated item table in the item DB is associated with a node whose label is “lower0” in the filter2. Furthermore, the “code” column of the treated item table in the item DB is associated with a node whose label is “lower1” in the filter2. Then, as shown in the upper right (A) of FIG. 33, the conversion function of the filter2 has an upward function to set the value of “lower1” as the value of “upper0” when the value of the “lower0” is “2006”, and to set “null” as the value of “upper0” when the value of “lower0” is other than “2006”. On the other hand, the conversion function of the filter2 has a downward function to set “2006” to “lower0”, and the value of “upper0” to “lower1”. In such a case, data obtained in the treated item table of the item DB is limited to data whose value of the “year” column is “2006” when passing through this filter2. Similarly, because the value of “upper0” becomes “null” by the downward function when the value of the “year” column of the treated item table of the item DB is other than 2006, the upward trace cannot be made.

Then, when outputting a query to the treated item table of the item DB, it is checked in advance whether or not the destination of the association is the bi-directional filter, and when the bi-directional filter carries out the data limitation or selection, the condition of the limitation or selection is added to the query to the treated item table of the item DB. As shown in the upper right (B) of FIG. 33, in addition to the condition in which the value of the “name” column is “FMV-6000CL”, and the condition “2006” of the limitation or selection for the value of the “year” column is combined by “AND”. Thus, it becomes possible to reduce the data volume replied from the database, the data transfer load, and the load to process the replied data.

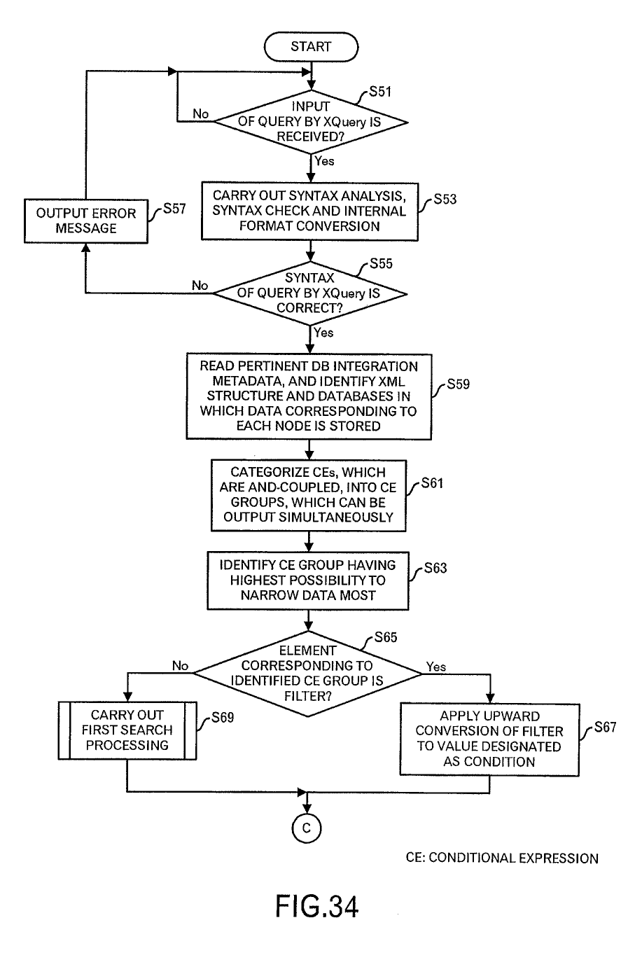

In a case where the bi-directional filter to carry out such data limitation or selection is used, a processing shown in FIGS. 34 to 37 is carried out. Firstly, the query parser 1311 of the XQuery query processor 131 waits for an input of a query by the XQuery from the user terminal 11 (step S51), and when the input by the XQuery is received, the query parser 1311 carries out the syntax analysis, syntax check and internal format conversion for the received query by the XQuery (step S53).

Incidentally, when the syntax of the query by the XQuery is not correct (step S55: No route), the query parser 1311 outputs an error message to the user terminal 11 (step S57). Then, the processing returns to the step S51. On the other hand, when the syntax of the query by the XQuery is correct (step S55: Yes route), the query parser 1311 outputs the data of the syntax tree to the query processing engine 1312. Then, the query processing engine 1312 reads the pertinent DB integration metadata from the DB integration metadata storage 133, and identifies XML structure and databases in which data corresponding to each node is stored (step S59).

Next, the query processing engine 1312 categorizes conditional expressions, which are AND-coupled, into conditional expression groups, which can respectively be output simultaneously (step S61). For example, the conditional expressions for data items included in the same table and/or database are grouped.

After that, the query processing engine 1312 identifies a conditional expression group that has the highest possibility to narrow the data most (step S63).

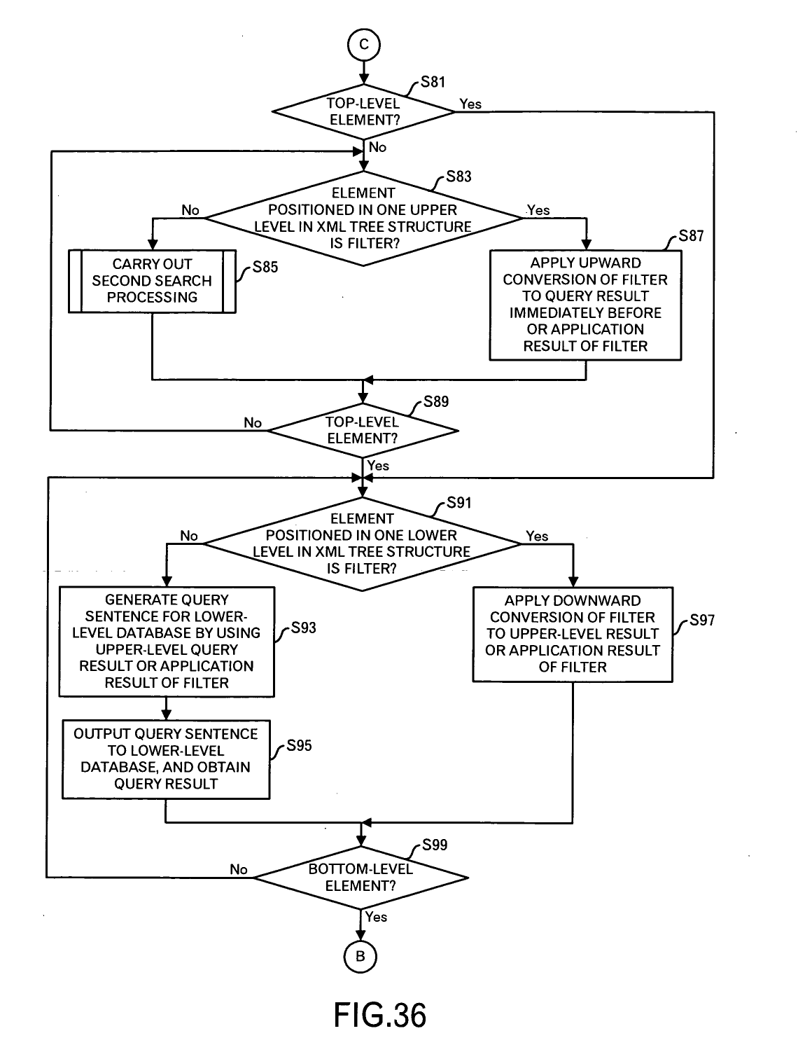

Then, the query processing engine 1312 judges whether or not an element corresponding to the conditional expression group identified at the step S63 is a bi-directional filter (step S65). For example, as shown in FIG. 17, because there is a case where the value range or format of the data in the database is virtualized, there is a case where the element corresponding to the conditional expression group is the bi-directional filter, firstly. When the element corresponding to the conditional expression group identified at the step S63 is the bi-directional filter, the query processing engine 1312 applies the upward conversion of the bi-directional filter to a value designated as a condition (step S67). Then, the processing shifts to a processing of FIG. 36 through a terminal C.

On the other hand, when the element corresponding to the conditional expression group identified at the step S63 is not the bi-directional filter, the query processing engine 1312 carries out a first search processing (step S69). Then, the processing shift to the processing in FIG. 36 through the terminal C.

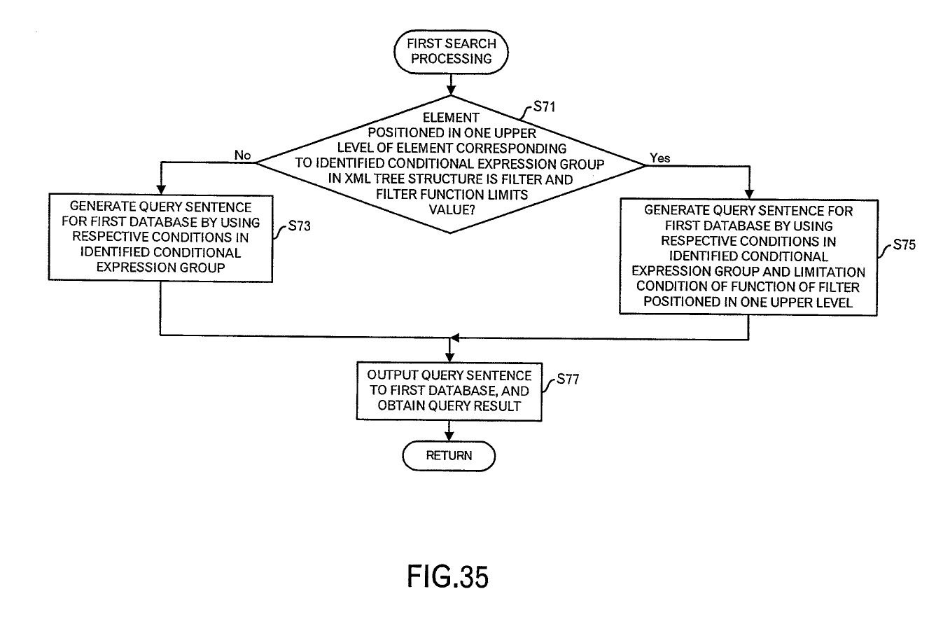

The first search processing will be explained by using FIG. 35. Firstly, the query processing engine 1312 judges whether or not a node, which is positioned in one upper level of the element corresponding to the conditional expression group identified at the step S63 on the XML tree structure, is a filter, and the function of the filter limits or selects a value (step S71). When such conditions are not satisfied, the query processing engine 1312 generates a query sentence for the query to the first database as usual by using respective conditions in the identified condition expression group, and outputs the query sentence to the database access processor 1313 (step S73).

Then, the database access processor 1313 outputs the query sentence to a host managing the first database through the grid tool 132, and obtains a query result (step S77). The database access processor 1313 outputs the query result to the query processing engine 1312. Then, the processing returns to the original processing.

On the other hand, when the conditions at the step S71 are satisfied, the query processing engine 1312 generates a query sentence for the query to the first database by using respective conditions in the conditional expression group identified at the step S63 and a limitation condition (in the example of FIG. 33, year=2006) of the filter function positioned in one upper level, and outputs the query sentence to the database access processor 1313 (step S75). An SQL query as shown in the upper right (B) of FIG. 33 is generated. Then, the processing shifts to step S77.

Shifting to the explanation of the processing of FIG. 36, the query processing engine 1312 judges whether or not the trace reaches the top-level element (step S81). When the trace reaches the top-level element, the processing shifts to step S91. On the other hand, when the trace does not reach the top-level element, the query processing engine 1312 judges whether or not an element positioned in one upper level in the XML tree structure is a filter (step S83). When the element positioned in one upper level in the XML tree structure is the filter, the query processing engine 1312 applies the upward conversion of the filter to the query result immediately before or the application result of the filter (step S87). After that, the query processing engine 1312 judges whether or not the trace reaches the top-level element (step S89). When the trace does not reach the top-level element, the processing returns to the step S83.

On the other hand, when the element positioned in one upper level in the XML tree structure is not the filter, the query processing engine 1312 carries out a second search processing (step S85). After that, the processing shifts to step S89.

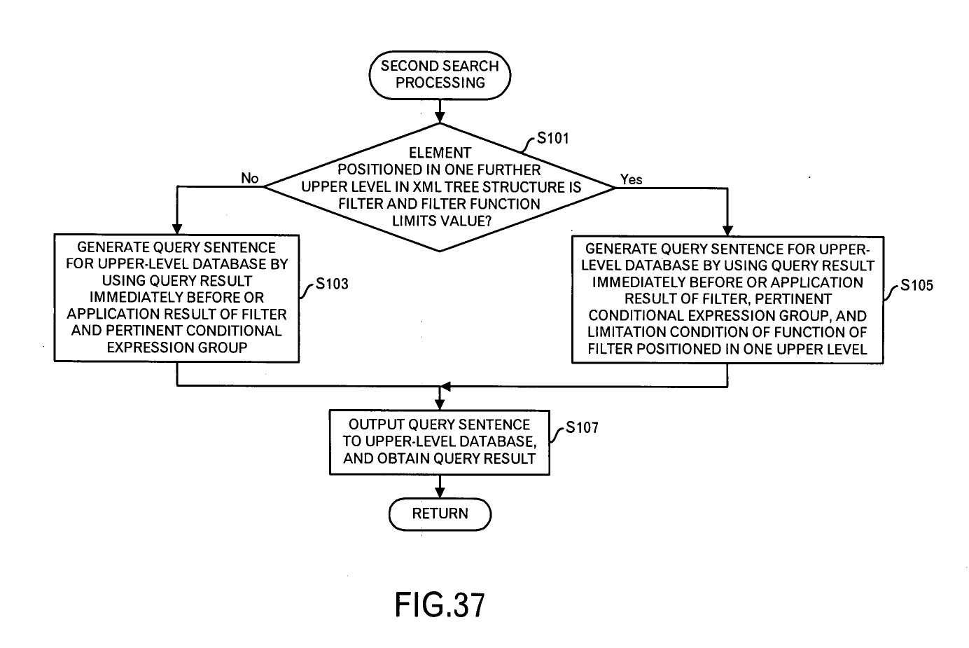

The second search processing will be explained by using FIG. 37. First, the query processing engine 1312 judges whether or not a node positioned in further one upper level in the XML tree structure is a filter, and the filter function limits or selects a value (step S101). When such conditions are not satisfied, the query processing engine 1312 generates a query sentence for the query to the upper-level database as usual by using the query result immediately before or the application result of the filter and the pertinent conditional expression group, and outputs the query sentence to the database access processor 1313 (step S103).

Then, the database access processor 1313 outputs the query sentence to a host managing the upper-level database through the grid tool 132, and obtains the query result (step S107). The database access processor 1313 outputs the query result to the query processing engine 1312. Then, the processing returns to the original processing.

On the other hand, when the conditions at the step S101 are satisfied, the query processing engine 1312 generates a query sentence for the query to the upper-level database by using the query result immediately before or the application result of the filter, the pertinent conditional expression group and the limitation condition of the function of the filter positioned in one upper level, and outputs the query sentence to the database access processor 1313 (step S105). Then, the processing shifts to step S107.

Thus, by carrying out such a repeat processing, the value of the top-level element in the XML tree structure is obtained. Incidentally, the value of the top-level element is stored in the storage device.

Returning to the explanation of the processing of FIG. 36, when it is judged at the step S89 that the trace reaches the top-level element, the query processing engine 1312 judges whether or not an element positioned in one lower level in the XML tree structure is a filter (step S91). When the element positioned in one lower level in the XML tree structure is not the filter, the query processing engine 1312 generates a query sentence for the lower-level database by using the upper-level query result or the application result of the filter, and outputs the query sentence to the database access processor 1313 (step S93).

Then, the database access processor 1313 outputs the query sentence to a host managing the database through the grid tool 132, and obtains the query result (step S95). The database access processor 1313 outputs the obtained query result to the query processing engine 1312. Then, the query processing engine 1312 judges whether or not the trace reaches the bottom-level element (step S99). When the trace does not reach the bottom-level element, the processing returns to the step S91. On the other hand, when the trace reaches the bottom-level element, the processing shifts to the processing of FIG. 31 through the terminal B. The processing of FIG. 31 is the same, and the explanation is omitted.

When the element positioned in one lower level in the XML tree structure is the filter, the query processing engine 1312 carries out the downward conversion of the bi-directional filter for the upper-level query result or the application result of the filter (step S97). Then, the processing shifts to step S99.

Thus, in a case of the upward trace, the query sentence is generated taking into consideration the bi-directional filter, which limits or selects the data value. On the other hand, in a case of the downward trace, there is no need to take into consideration such a type of the bi-directional filter on tracing the XML tree structure.

By carrying out the aforementioned processing, it becomes possible to appropriately deal with even a case where the bi-directional filter limits or selects the data value.

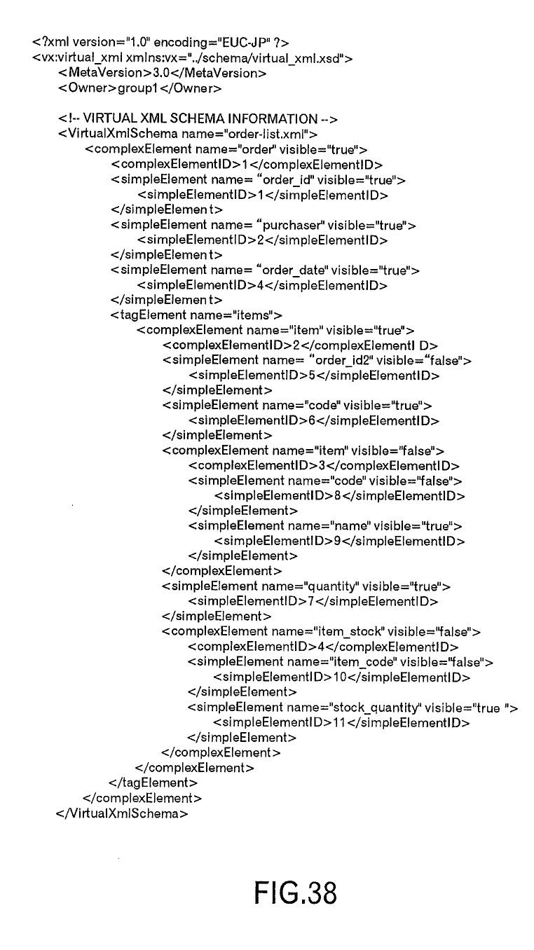

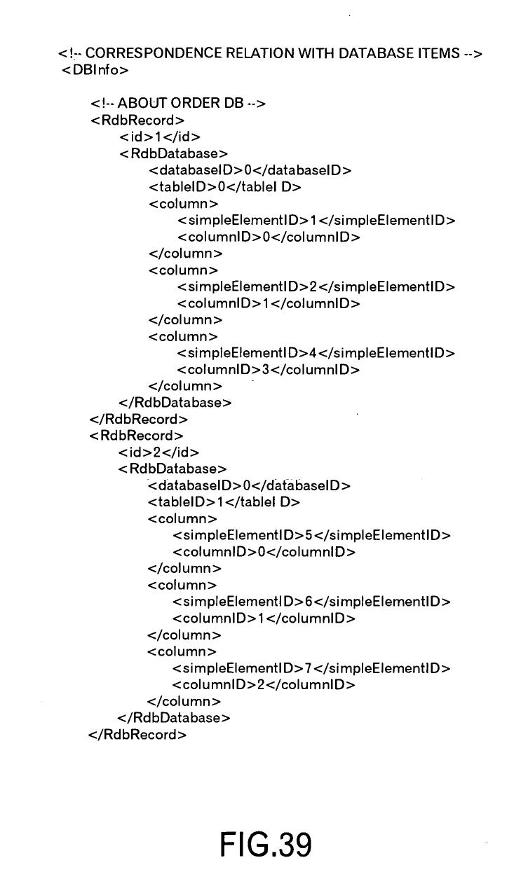

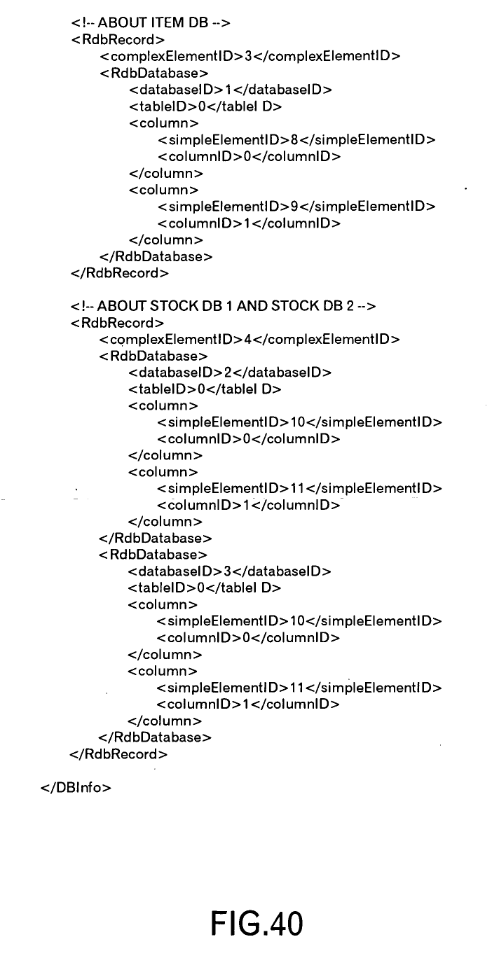

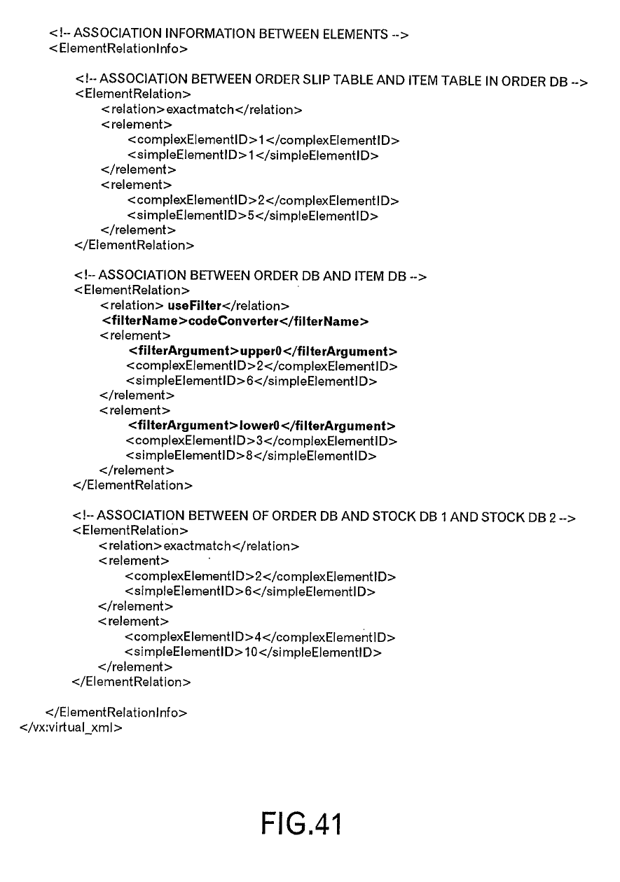

Although the first embodiment of this invention was explained, this invention is not limited to this embodiment. For example, in the examples shown in FIGS. 12 to 15, the filter is described equally to the elements in the database. However, there is no need to always describe the filter equally to the elements of the databases. For example, it is possible to use the DB integration metadata as shown in FIGS. 38 to 41. When FIG. 38 is compared with FIG. 12, a node for the filter is deleted in FIG. 38. In addition, when FIGS. 39 and 40 are compared with FIGS. 13 and 14, the description for the filter is deleted in FIGS. 39 and 40. Then, because the node is deleted when FIG. 41 is compared with FIG. 14, a filter is introduced at an association portion to which the bi-directional filter should be added. When such a description method is used, it is possible to associate elements in databases whose value range or format is different each other. However, it becomes impossible to use the filter in order to virtualize the value range or format of the data. In addition, the association of “plural” to “plural” becomes difficult.

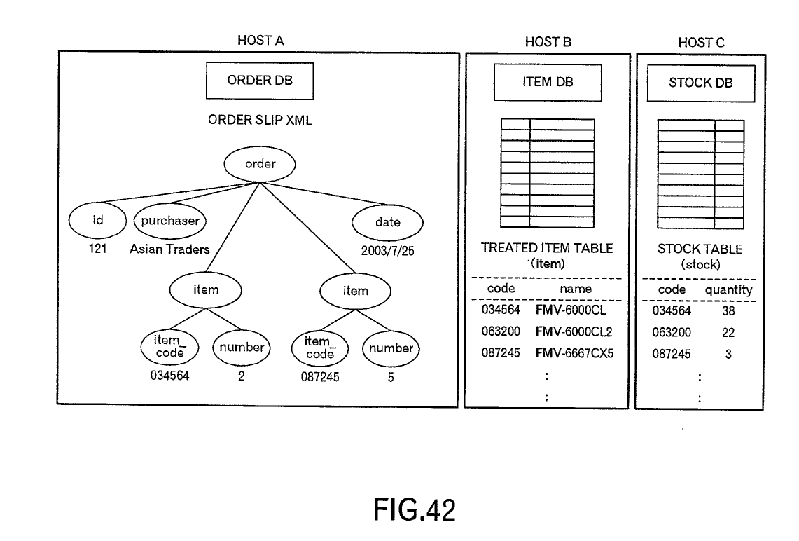

Furthermore, as described above, this invention can be applied to an environment in which XML-DB (e.g. order slip XML of the order DB) as shown in FIG. 42 coexists. When the DB integration metadata is created, the preferable virtual data view is presented for the user, and then, the query according to the virtual data view is processed to appropriately extract data extending in the plural databases.

In addition, the functional block diagram shown in FIG. 9 is a mere example, and does not always show an actual program module configuration.

### Embodiment 2

A one-directional filter, not the bi-directional filter introduced in the first embodiment of this invention, can be introduced. FIGS. 12 to 15 show an example of the DB integration metadata when introducing the bi-directional filter. However, the same description is also required when introducing the one-directional filter. That is, the one-directional filter (i.e. one-directional conversion function) is also handled in the same lank as the database, and an association between an element (e.g. ComplexElement, SimpleElement) in the virtual XML schema and the one-directional filter is also described. It is described that one ComplexElement corresponds to the one-directional filter, and following information is also described:
a name of the one-directional filter to be called (e.g. codeConverter)
a list of the SimpleElements used for inputs and outputs in the upper side
a list of the SimpleElements used for inputs and outputs in the lower side

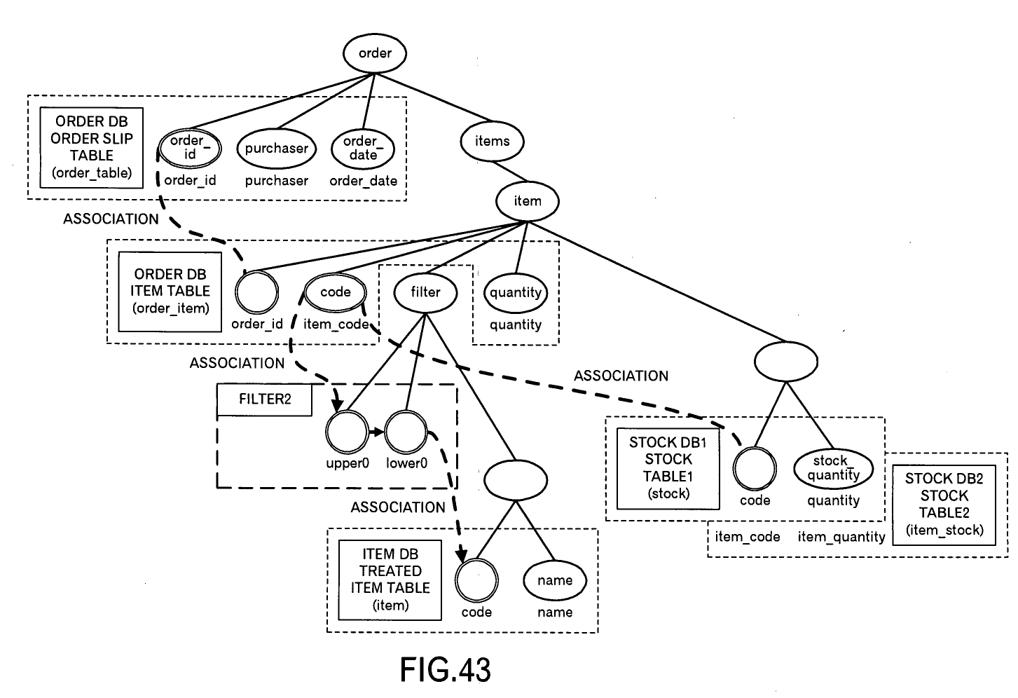

Even when the one-directional filter is introduced, the DB integration metadata is described similarly to the DB integration metadata in case of introducing the bi-directional filter. Therefore, the schematic drawing of the DB integration metadata is represented similarly to FIG. 11. However, in case of the bi-directional filter, any arrow is attached to the thick dotted line representing the association. However, as shown in FIG. 43, in case of the one-directional filter (i.e. a filter 2 in FIG. 43), an arrow is used for the thick dotted line representing the association in order to represent the direction of the filter. In an example of FIG. 43, a node, whose name is “upper0,” of the filter 2, which is the one-directional filter, is associated with a node whose name is “item_code” in the item table of the order DB and which is an upper node, and a node, whose name is “lower0,” of the filter 2 is associated with a node whose name is “code” in the treated item table of the item DB and which is a lower node.

Incidentally, whether the filter is the one-directional filter or the bi-directional filter is identified based on the substance of the filter, not the DB integration metadata. That is, for example, at the activation, the system reads the definition of the filter, and distinguishes the type by identifying which class of the bi-directional filter and the one-directional filter the filter inherits.

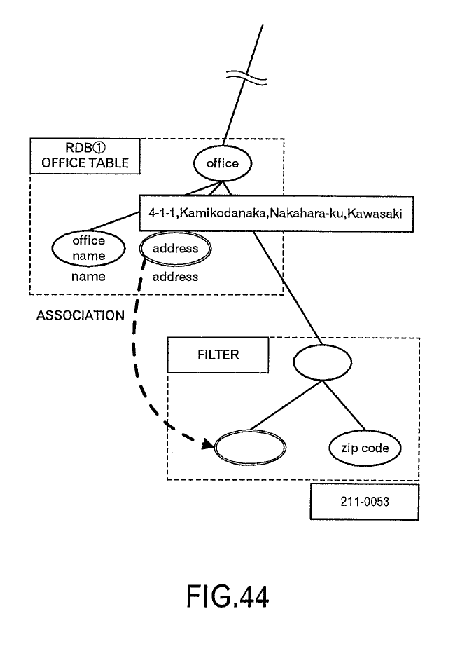

For example, the one-directional filter is a conversion function as shown in the following:
(a) convert a character string including the capital letters and small letters into a character string including only the capital letters
(b) convert a character string including the capital letters and small letters into a character string including only the small letters
(c) convert a character string including the single-byte characters and the double-byte characters into a character string including only the single-byte characters
(d) convert a telephone number, which is segmented by using hyphens or parentheses into a telephone number without the hyphens or parentheses
(e) convert the birth day into the age
(f) convert old address representation into newest address representation
(g) covert an address into a ZIP code (e.g. FIG. 44)
The above-listed functions are mere examples, and any types of the one-directional conversion function can be used.

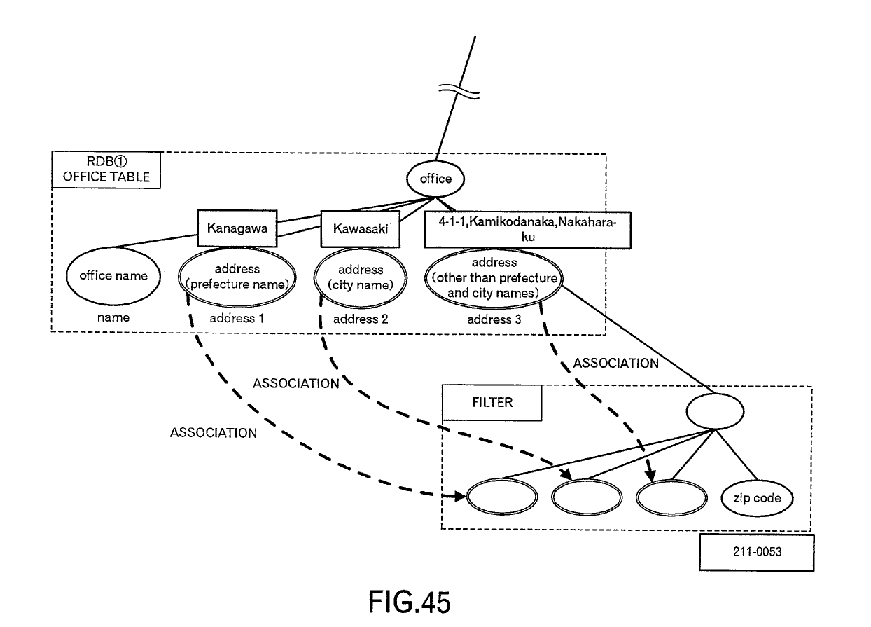

The conversion indicated in (a) to (g) is a one-to-one conversion. However, it is possible to define an m-to-n conversion such as obtaining n outputs from m elements in the database. FIG. 45 shows an example. In the example of FIG. 45, an address is registered into an office table in a RDB in such a form that a prefecture name, a city name and a portion other than the prefecture name and the city name are separated.

As shown in FIG. 45, it is possible to introduce the one-directional filter under an element of a certain database, not to associate the element of the certain database with an element of another database. Namely, this is similar to the value range or format virtualization described for the bi-directional filter. It is also possible to designate “false” for the visible attribute, and show only the ZIP code in the data view.

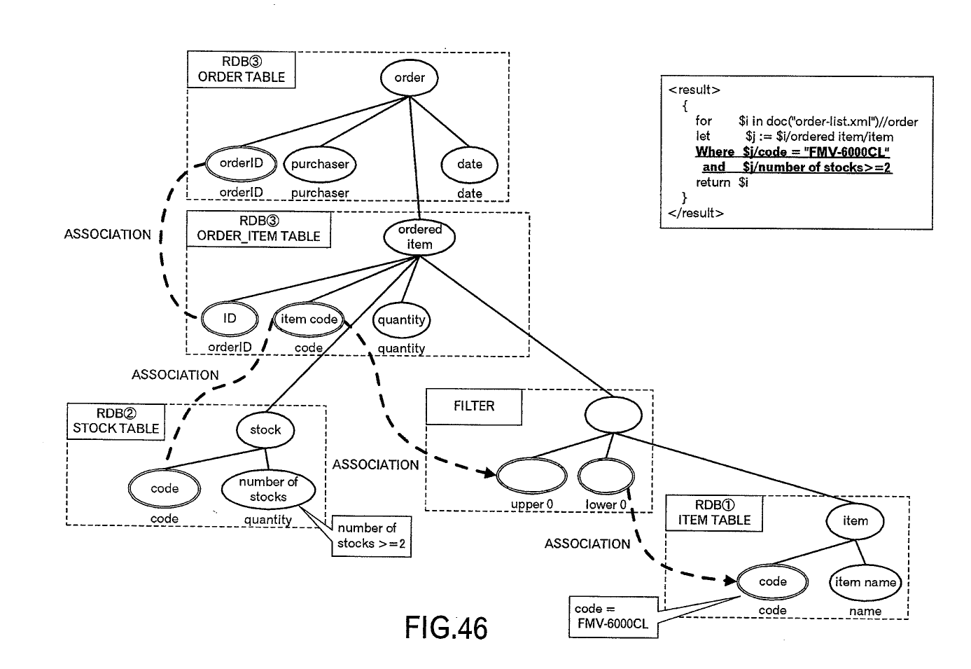

Next, by using FIGS. 46 to 64, a processing flow in case of introducing the one-directional filter will be explained. In the following, it is assumed that the DB integration metadata as shown in FIG. 46 has been defined. In FIG. 46, a node, whose name is “code”, of the order_item table in RDB 3 is associated with a node, whose name is “upper0”, of the one-directional filter, and a node, whose name is “lower0”, of the one-directional filter is associated with a node, whose name is “code”, of the item table of RDB 1. Incidentally, the processing flow itself assumes a case where the bi-directional filter and the one-directional filter are mixed.

In addition, the system configuration in the first embodiment shown in FIG. 9 is similar to that of this embodiment. However, a processing content of the query processing engine 1312 is changed as described below.

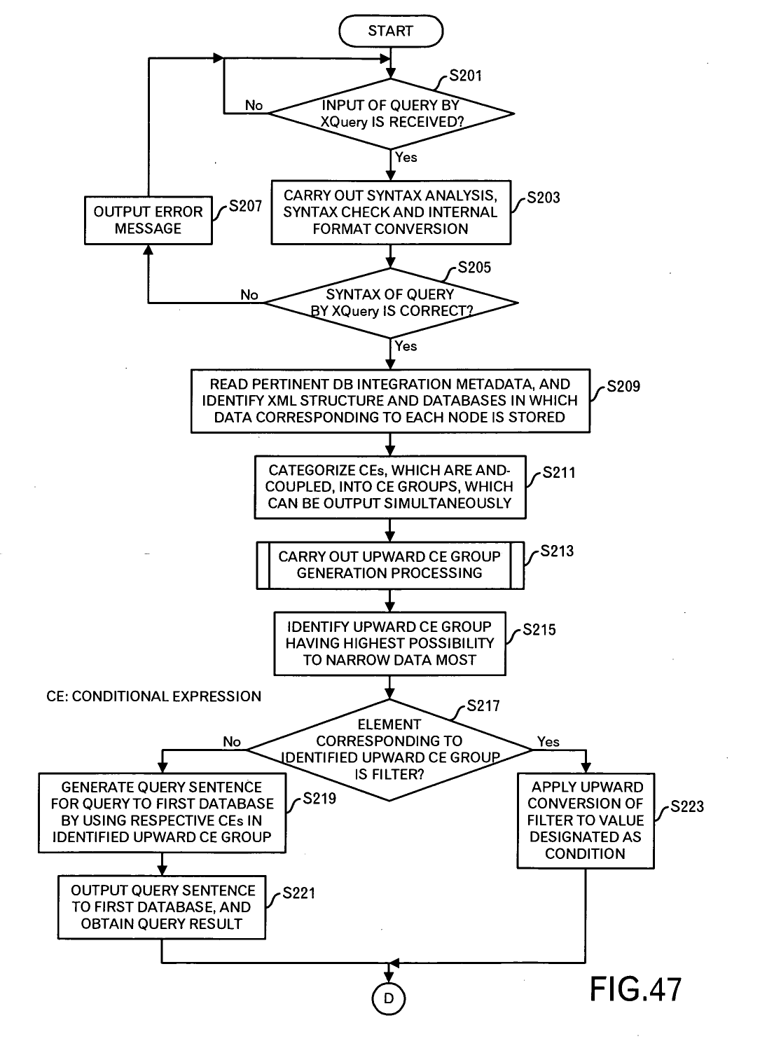

First, the query parser 1311 of the XQuery output processor 131 waits for an input of a query by the XQuery from the user terminal 11 (FIG. 47: step S201), and when the input of the query by the XQuery is received, the query parser 1311 carries out the syntax analysis, syntax check and internal format conversion for the received query by the XQuery (step S203). This processing is the same as conventional one, and the detail explanation is omitted.

Incidentally, when the syntax of the query by the XQuery is incorrect (step S205: No route), the XQuery output processor 131 outputs an error message to the user terminal 11 (step S207). Then, the processing returns to the step S201. On the other hand, when the syntax of the query by the XQuery is correct (step S205: Yes route), the query parser 1311 outputs data of the syntax tree to the query processing engine 1312. Then, the query processing engine 1312 reads pertinent portion of the DB integration metadata from the DB integration metadata storage 133, and identifies XML structure and databases in which data corresponding to each node are stored (step S209). As described above, at the activation or the like, the filter definition is read to identify which class of the bi-directional filter and the one-directional filter the pertinent filter inherits.

For example, the query by the XQuery to extract orders in which name=FMV-6000CL and the quantity is two or more is described as shown in the upper right of FIG. 46. Here, the pertinent DB integration metadata is designated as “order-list.xml”. Then, the data structure as shown in FIG. 46 is identified.

Next, the query processing engine 1312 categorizes conditional expressions, which are AND-coupled, into some conditional groups, which can respectively be output simultaneously (step S211). For example, the conditional expressions for data items included in the same table and/or database are grouped. Two conditional expressions in the example on the upper right of FIG. 46 are treated separately, because those are conditional expressions for different databases.

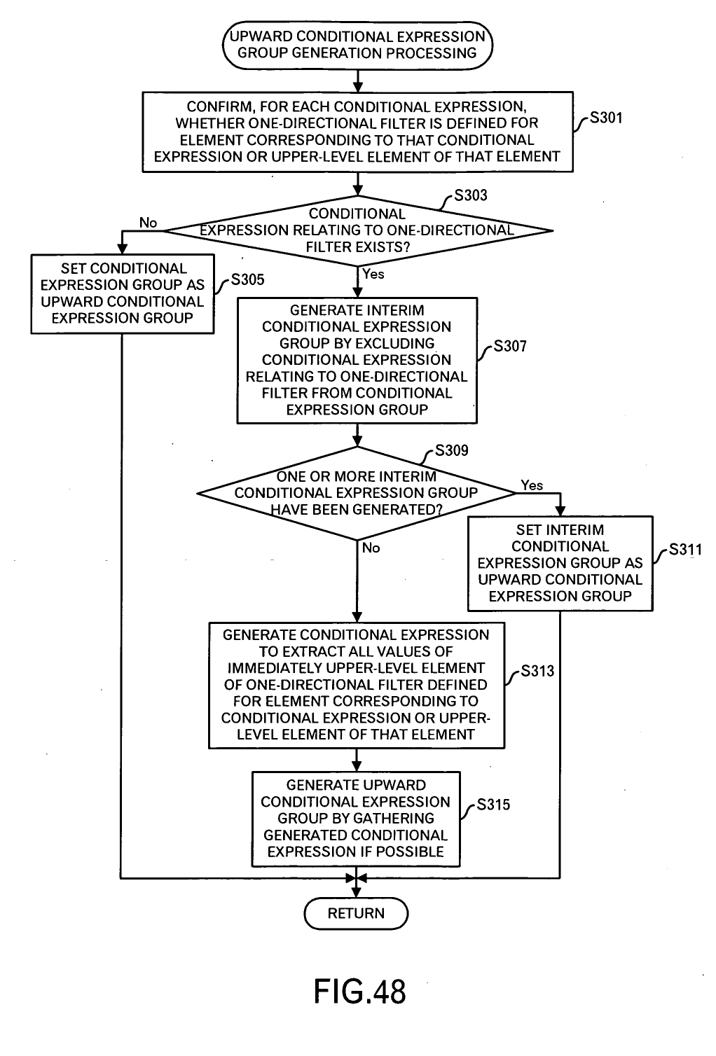

After that, the query processing engine 1312 carries out an upward conditional expression group generation processing (step S213) This upward conditional expression group generation processing is provided to handle a case where the one-directional filter is defined in the XML tree structure and a conditional expression of the query is defined for a portion under this one-directional filter. This is because an upward trace of the tree structure cannot be simply carried out, when the one-directional filter exists. The upward conditional expression group generation processing will be explained by using FIG. 48.

First, the query processing engine 1312 confirms, for each conditional expression, whether or not the one-directional filter is defined for a specific element on the tree structure of the DB integration metadata, which corresponds to that conditional expression, or an upper-level element of the specific element (step S301). The query processing engine 1312 confirms, for each conditional expression, whether or not the aforementioned condition is satisfied, and adds a flag representing whether or not the condition is satisfied to data of the syntax tree of the query, for example.

Then, the query processing engine 1312 judges whether or not at least one conditional expression relating to the one-directional filter (i.e. which satisfies the aforementioned condition) exists (step S303). When there is no conditional expression relating to the one-directional filter (i.e. a case where there is no filter, a case where only the bi-directional filter is defined in the DB integration metadata, and a case where no conditional expression is not inputted for the one-directional filter and the lower element of the one-directional filter), the query processing engine 1312 sets the conditional expression group identified at the step S211 as an upward conditional expression group (step S305).

On the other hand, when the conditional expression relating to the one-directional filter exists, the query processing engine 1312 excludes the conditional expression relating to the one-directional filter from the conditional expression group identified at the step S211 to generate an interim conditional expression group (step S307). The conditional expression “code=FMV-6000CL” among two conditional expressions in the upper-right example of FIG. 46 is a conditional expression relating to a lower element of the one-directional filter as shown in FIG. 46. Therefore, the conditional expression “code=FMV-6000CL” is excluded at the step S307 from the conditional expression group, and the interim conditional expression group includes only a conditional expression “quantity≧2”.

Then, the query processing engine 1312 judges whether or not one or more interim conditional expression groups can be generated (step S309). Although it is described later in detail, in a case where the query includes only the conditional expression “code=FMV-6000CL”, when the conditional expression “code=FMV-6000CL” is excluded at the step S307, the interim conditional expression group becomes empty. At this step, the query processing engine 1312 confirms whether or not such a state occurred.

When one or more interim conditional expression groups are generated, the query processing engine 1312 sets the interim conditional expression groups as the upward conditional expression groups (step S311). On the other hand, when no interim conditional expression group is generated, the query processing engine 1312 generates a conditional expression to extract all values of an immediately upper-level element of the one-directional filter defined for an element corresponding to the conditional expression or for an upper-level element of such an element (step S313). When the query including only the conditional expression “code=FMV-6000CL” in the XML tree structure as shown in FIG. 46 is executed, the immediately upper-level element of the one-directional filter is an element of an order item in the order_item table in the RDB3, and the query processing engine 1312 generates a conditional expression to extract all values (specifically, values of orderID, code and quantity columns) of this element. Incidentally, when the immediately upper-level element of the one-directional filter is not the top-level element, a conditional expression to extract all values of only an element (in this example, orderID column) associated with the further upper-level element may be generated.

Then, the query processing engine 1312 generates the upward conditional expression group by gathering the generated conditional expressions, if possible (step S315). For example, when the plural one-directional filters relating to the condition expressions exist in the DB integration metadata and the immediately upper-level element of each one-directional filter is the same, it is possible to gather the conditional expressions because the values to be extracted are the same and the same conditional expression is generated.

Thus, a preparation for the upward trace of the XML tree structure is carried out. Incidentally, the conditional expression excluded at the step S307 (called “downward trace conditional expression” or “downward conditional expression”) is used in the downward trace of the tree structure of the DB integration metadata.

Returning to the explanation of the processing in FIG. 46, the query processing engine 1312 identifies an upward conditional expression group having the highest possibility to narrow the data most (step S215). The character string precedes the numeric value, and the long character string precedes the short character string. This step is the same as the step S13.

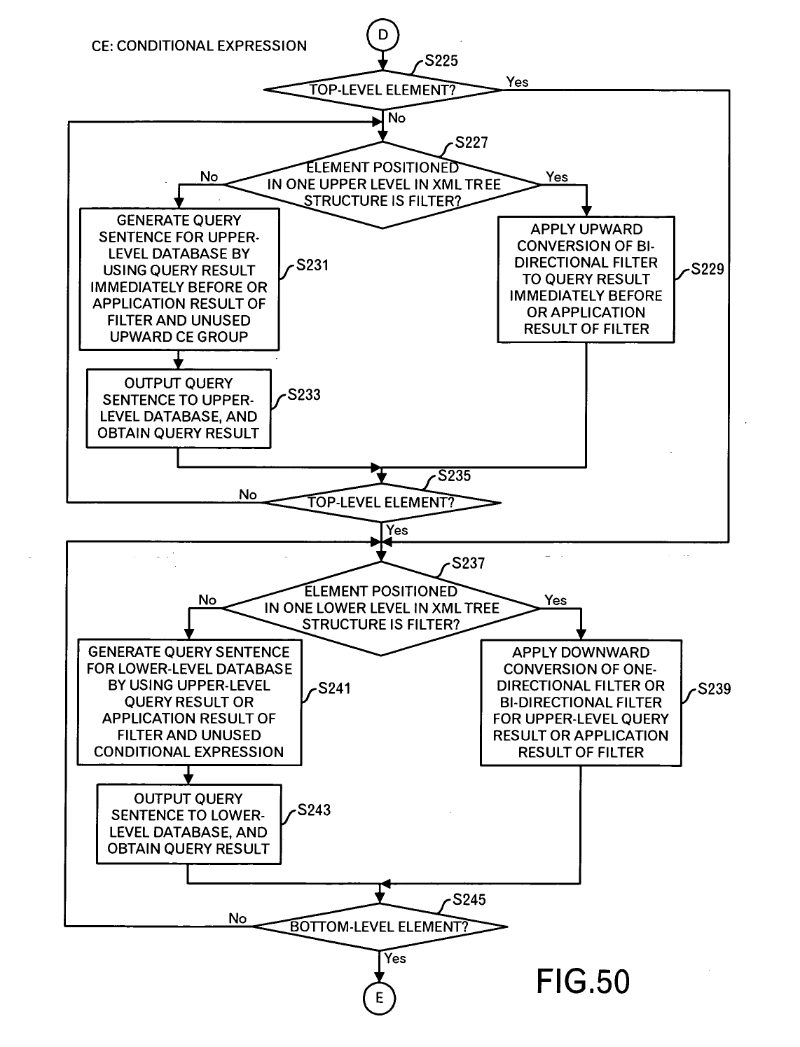

Then, the query processing engine 1312 judges whether or not an element, which corresponds to the upward conditional expression group identified at the step S215, in the XML tree structure is the bi-directional filter (in this case, always bi-directional filter because the processing as shown in FIG. 48 is carried out) (step S217). Although it was described above, because there is a case where the value range or format of the data in the database is virtualized, there is a case where the element corresponding to the upward conditional expression group is the bi-directional filter, firstly. When the element corresponding to the upward conditional expression group identified at the step S215 is the bi-directional filter, the query processing engine 1312 applies the upward conversion of the bi-directional filter to a value designated as a condition (step S223) Then, the processing shifts to a processing of FIG. 50 through a terminal D.

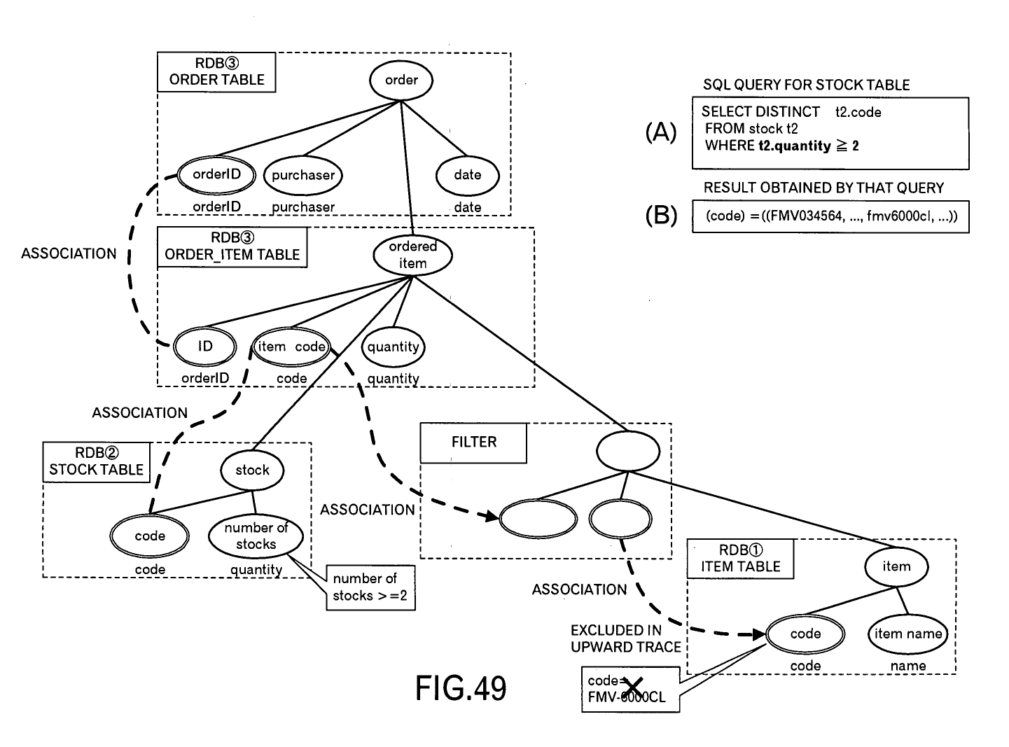

On the other hand, when the element corresponding to the upward conditional expression group identified at the step S215 is not the bi-directional filter, the query processing engine 1312 generates a query sentence to inquire of the first database by using respective conditions of the identified upward conditional expression group, and outputs the query sentence to the database access processor 1313 (step S219). For example, an SQL query for the stock table of the RDB2 as shown in the upper right (A) of FIG. 49 is generated. Incidentally, basically, a record conforming with the conditional expression group is identified. However, as for the value, only a value of the column associated with the upper-level element is obtained. As shown in FIG. 49, when the “quantity” column in the stock table of the RDB2 is searched by a condition of “quantity≧2”, it is sufficient that only the values of the “code” column is identified, because only the “code” column in the stock table of the RDB2 is associated with the upper-level element.

Then, the database access processor 1313 outputs the query sentence to a host managing the first database (e.g. the stock table of RDB2) through the grid tool 132, and obtains a query result (step S221). As shown in the upper right (B) of FIG. 49, the values (fmv034564 . . . , fmv60000Cl, . . . ) of the “code” column are obtained. The database access processor 1313 outputs the query result to the query processing engine 1312. The processing shifts to a processing of FIG. 50 through the terminal D.

Shifting to the explanation of the processing of FIG. 50, the query processing engine 1312 judges whether or not the trace reaches the top-level element (step S225). When the trace reaches the top-level element, the processing shifts to step S237. On the other hand, when the trace does not reach the top-level element, the query processing engine 1312 judges whether or not an element positioned in one upper level in the XML tree structure is a filter (here, the bi-directional filter) (step S227). When the element positioned in one upper level in the XML tree structure is the filter, the query processing engine 1312 applies the upward conversion of the filter to the query result immediately before or the application result of the filter (step S229). Then, the processing shifts to step S235.

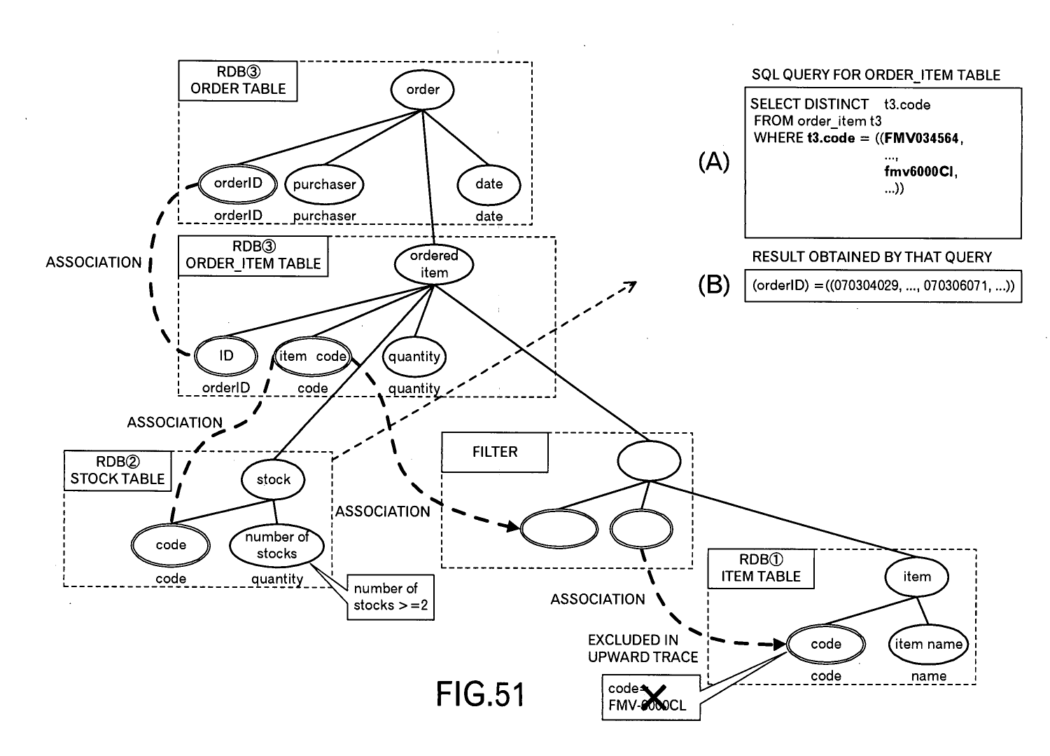

On the other hand, when the element positioned in one upper level in the XML tree structure is not a filter, the query processing engine 1312 generates a query sentence for the upper-level database by using the query result immediately before or the application result of the filter and an unused upward conditional expression group if it exists, and outputs the query sentence to the database access processor 1313 (step S231). As shown in FIG. 51, by using the query result immediately before (code=(FMV034564 , . . . , fmv6000Cl, . . . ), an SQL query for the order-item table in the RDB3 as shown in the upper right (A) of FIG. 51 is generated. Even in such a case, only values of an element (column) associated with an upper-level element may be obtained.

Then, the database access processor 1313 outputs the query sentence to a host managing the database (here, the RDB3) through the grid tool 132, and obtains a query result (step S233). As shown in the upper right (B) of FIG. 51, the values (070304029, . . . , 070306071, . . . ) of the orderID column in the order_item table of the RDB3 are obtained. The database access processor 1313 outputs the query result to the query processing engine 1312. The processing shifts to step S235.

After that, the query processing engine 1312 judges whether or not the trace reaches the top-level element (step S235). When the trace does not reach the top-level element on the XML tree structure, the processing shifts to the step S227. By carrying out such a repeat processing, the value of the top-level element in the XML tree structure is obtained. The value of the top-level element is stored in a storage device.

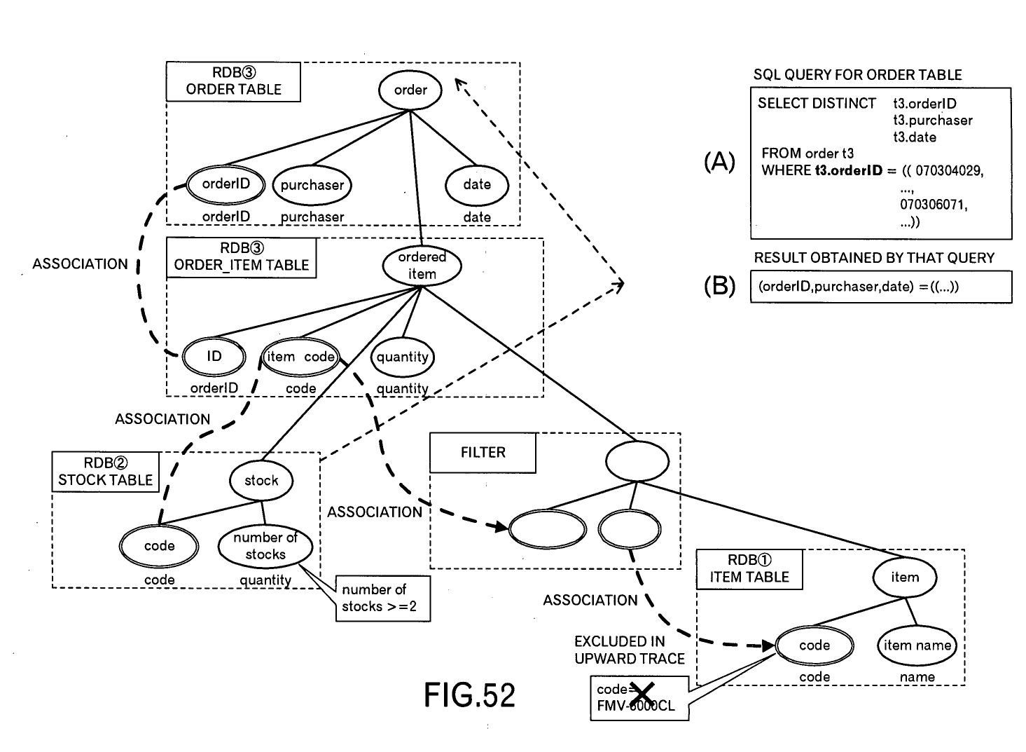

Because the trace does not still reach the top-level element in the XML tree structure at the stage of FIG. 51, the processing returns to the step S227, and the query processing engine 1312 judges whether or not an element positioned in one upper level in the XML tree structure is a filter. In the case of FIG. 51, because the element positioned in one upper level is not a filter, a query sentence for the upper-level database is generated by using the query result immediately before. As shown in the upper right (A) of FIG. 52, by using the query result immediately before (orderID=(070304029, . . . , 080306071, . . . ), an SQL query for the order table of the RDB3 is generated. Then, the query processing engine 1312 outputs a query sentence to a host managing the database (here, the RDB3) through the grid tool 132, and obtains a query result. As shown in the upper right (B) of FIG. 52, values (values of the orderID column, the purchaser column, and date column. Incidentally, because a lot of values are obtained, the details are omitted in the upper right (B) of FIG. 52) of each column in the order table of the RDB3 are obtained. The database access processor 1313 outputs the query result to the query processing engine 1312. In the example of FIG. 52, the values of the top-level element are finally obtained. The upward trace is completed by this processing.

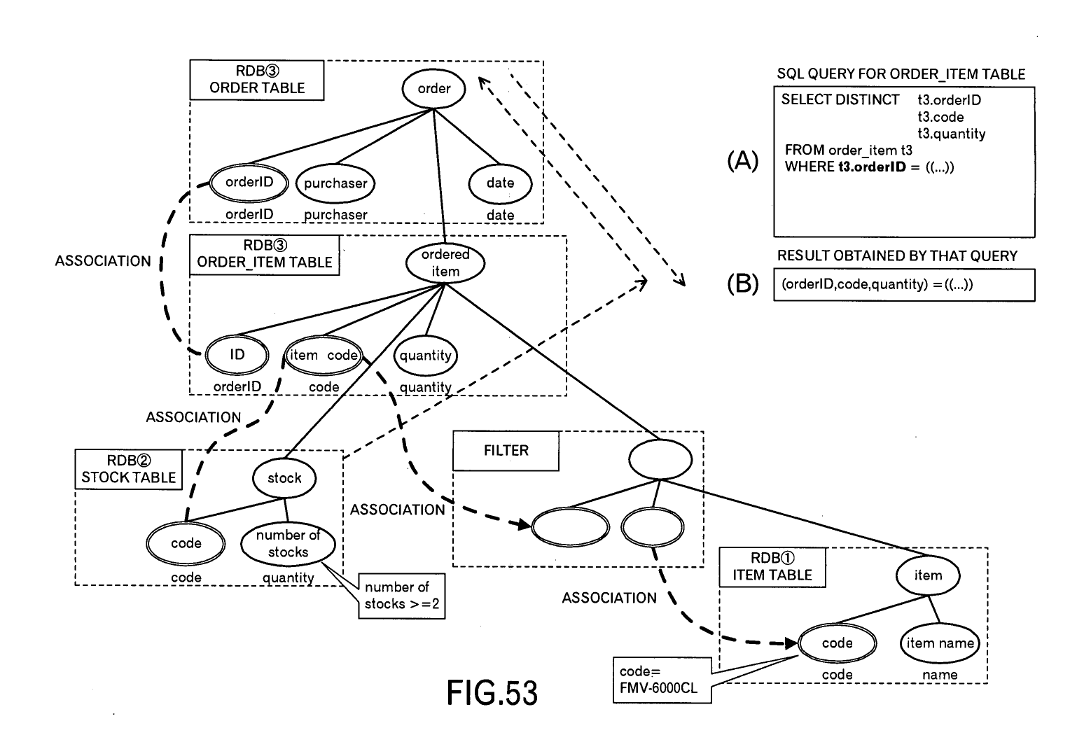

When it is judged at the step S235 that the trace reaches the top-level element, the query processing engine 1312 judges whether or not the element positioned in one lower level in the XML tree structure is a filter (step S237). When the element positioned in one lower level in the XML tree structure is not a filter, the query processing engine 1312 generates a query sentence for the lower-level database by using the upper-level query result or the application result of the filter and unused conditional expression (i.e. downward trace conditional expression), and outputs the query sentence to the database access processor 1313 (step S241). As shown in FIG. 53, by using the value of the orderID column, which is associated with another node, among the query results immediately before, an SQL query for the order_item table of the RDB3 as shown in the upper right (A) of FIG. 53 is generated.

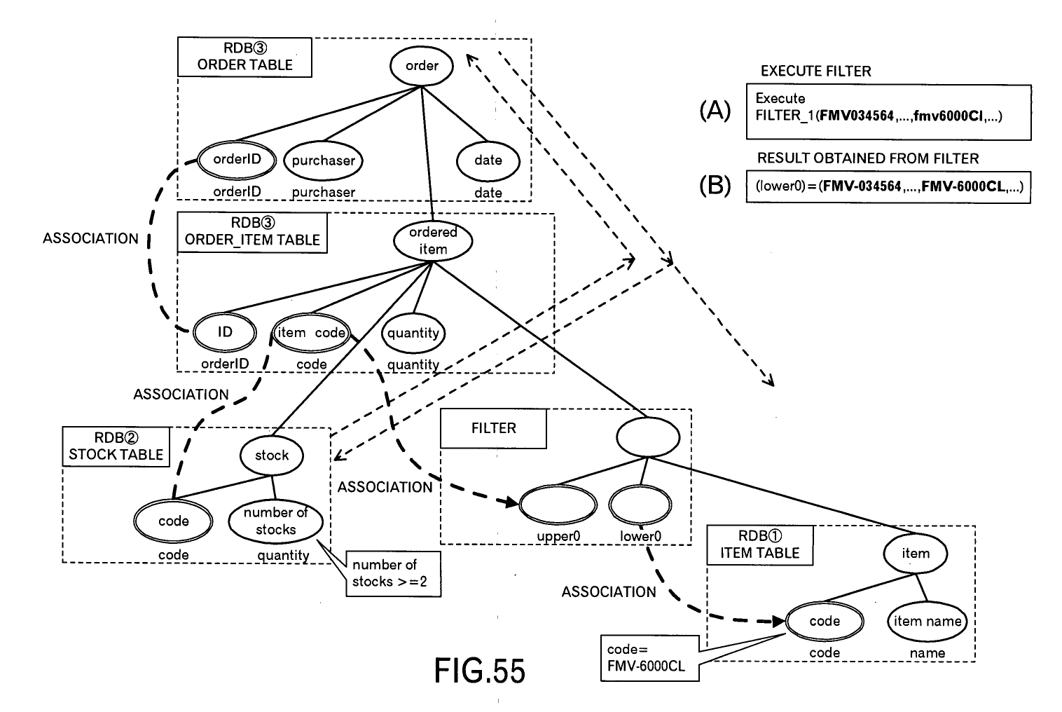

Then, the database access processor 1313 outputs the query sentence to a host managing the database (e.g. the order_item table of the RDB3) through the grid tool 132, and obtains the query result (step S243). As shown in the upper right (B) of FIG. 53, the values of the order_item table of the RDB3, the values of the code column and the values of the quantity column are obtained. The database access processor 1313 outputs the obtained query result to the query processing engine 1312. Then, the query processing engine 1312 judges whether or not the trace reaches the bottom-level element in the XML tree structure (step S245). When the trace does not reach the bottom-level element in the XML tree structure, the processing returns to the step S237. On the other hand, when the trace reaches the bottom-level element, the processing shifts to the processing of FIG. 55 through a terminal E.

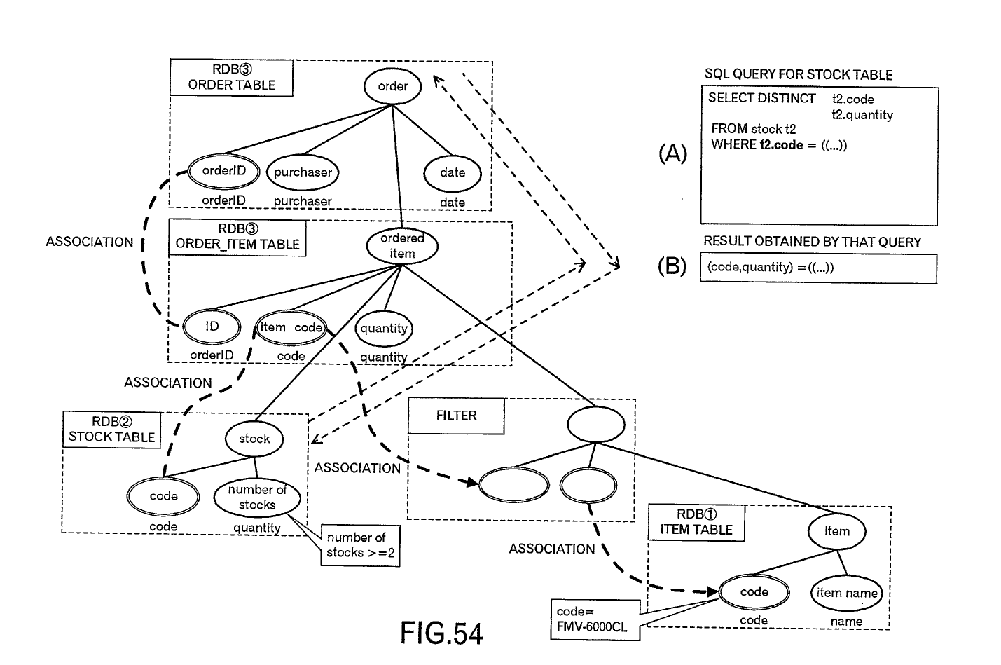

In the example of FIG. 53, because the trace does not reach the bottom-level element in the XML tree structure, the processing returns to the step S237. In this case, because the XML tree structure branches to two directions, the processing returns to the step S237 to repeat the aforementioned processing until the trace reaches all of the edge elements. Then, shifting to the stock table of the RDB2, the query processing engine 1312 judges whether or not the element positioned in one lower level in the XML tree structure is a filter, and when the element positioned in one lower level in the XML tree structure is not a filter, the query processing engine 1312 generates a query sentence for the lower-level database by using the upper-level query result, and outputs the query sentence to the database access processor 1313. As shown in FIG. 54, by using the values of the code column associated with the lower-level node among the query results immediately before, an SQL query for the stock table of the RDB2 as shown in the upper right (A) of FIG. 54 is generated. Then, the database access processor 1313 outputs the query sentence to a host managing the database (here, the stock table of the RDB2) through the grid tool 132, and obtains the query result. As shown in the upper right (B) of FIG. 54, the values of the code column in the stock table of the RDB2 and the values of the quantity column are obtained. The database access processor 1313 outputs the obtained query result to the query processing engine 1312.

Then, the query processing engine 1312 judges whether or not the trace reaches the bottom-level element in the XML tree structure. Because the trace does not reach the bottom-level element in the XML tree structure, the processing returns to the step S237.

When the element positioned in one lower level in the XML tree structure is the filter, the query processing engine 1312 carries out a downward conversion of the bi-directional filter or the one-directional filter for the upper-level query result or the application result of the filter (step S239). As shown in FIG. 55, because a filter is associated with the code column in the order_item table of the RDB3, the downward conversion by using, as inputs, the values (e.g. FMV034565, . . . , fmv6000Cl, . . . ) of the code column, which are the upper-level query results, is carried out. That is, as shown in the upper right (A) of FIG. 55, the downward conversion Filter_1 (FMV034565, . . . , fmv6000Cl, . . . ) of the one-directional filter is carried out, and as shown in the upper right (B), (lower0)=(FMV-034565, . . . , FMV-6000CL, . . . ) is obtained. Namely, the values of the code column in the item table of the RDB1, which is in the further lower-level database, are obtained. After that, the processing shifts to the step S245.

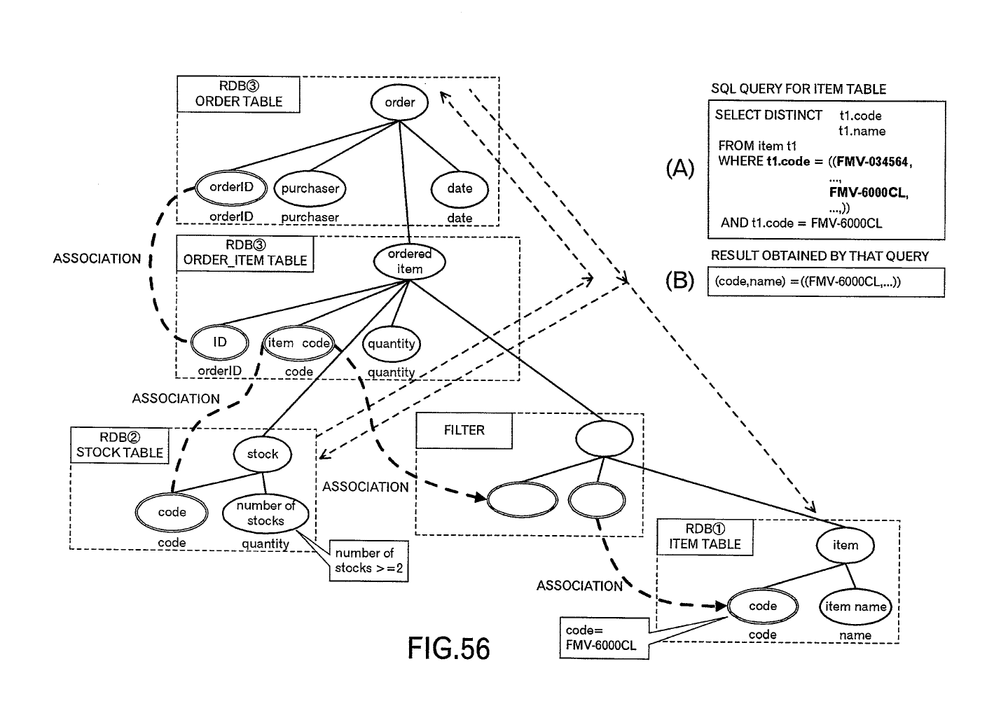

Because the trace does not still reach the bottom-level element in the example of FIG. 55, the processing returns to the step S237, and the query processing engine 1312 judges whether or not the element positioned in one lower level in the XML tree structure is a filter, and because that element is not a filter, the processing returns to the step S241. Then, by using the application result of the filter and the unused conditional expression (code=FMV-6000CL), the query processing engine 1312 generates a query sentence for the lower-level database, and outputs the query sentence to the database access processor 1313. As shown in FIG. 56, by using the values (FMV-034564, . . . , FMV-6000CL, . . . ) of the code column in the item table of the RDB1, which are the application results of the filter, and the unused conditional expression (code=FMV-6000CL), an SQL query for the item table of the RDB1 is generated as shown in the upper right (A) of FIG. 56. The conditions are AND-coupled.

Then, the database access processor 1313 outputs the query sentence to a host managing the database (here, the item table of the RDB1) through the grid tool 132, and obtains the query result. As shown in the upper right (B) of FIG. 56, the values of the code column in the item table of the RDB1 and the values of the name column are obtained. The database access processor 1313 output the obtained query results to the query processing engine 1312.

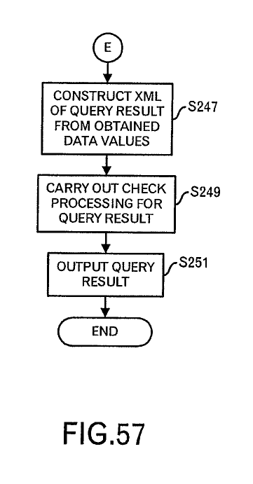

Then, the query processing engine 1312 judges whether or not the trace reaches the bottom-level element, again. In the example of FIG. 56, because the trace reached two edges in the XML tree structure, it is judged that the trace reaches the bottom-level element. The processing shifts to the processing of FIG. 57 through the terminal E.

The query processing engine 1312 constructs XML data of the query results from the obtained data values according to the DB integration metadata (step S247). The obtained data values are embedded so as to correspond to the nodes of the SimpleElement, in which visible=true is set.

After that, the query processing engine 1312 carries out check of the query result (step S249). Because the possibility that a portion of the query conditions designated in the query by the XQuery has not been reflected yet remains, any solution that does not satisfy the query conditions is excluded from the XML data of the final results by the check processing.

When the one-directional filter is used in the XML tree structure, because some conditional expressions (i.e. downward trace condition expression) included in the query are not used in the upward trace, a lot of values were extracted though they does not satisfy the query condition in the downward trace for the upper portion of the filter. In the aforementioned example, when the conversion result of the filter and the conditional expression (code=FMV-6000CL) are finally applied, a case where any value is not extracted frequently occurs. Therefore, in this step, as a case where the query condition is not satisfied, data for a case where any values are not extracted for the code column and the name column in the item table of the RDB1 is deleted. When the value of the code column is “FMV-034564”, because the condition is not satisfied, the values of the code column and the name column in the item table of the RDB1 become empty. Accordingly, a case where the value of the code column in the order_item table of the RDB3 is “FMV-034564” is deleted.

Finally, the query processing engine 1312 outputs the query result to the user terminal 11 (step S251).

By carrying out such a processing, it becomes possible to refer to the associated data extending in the plural databases all together.

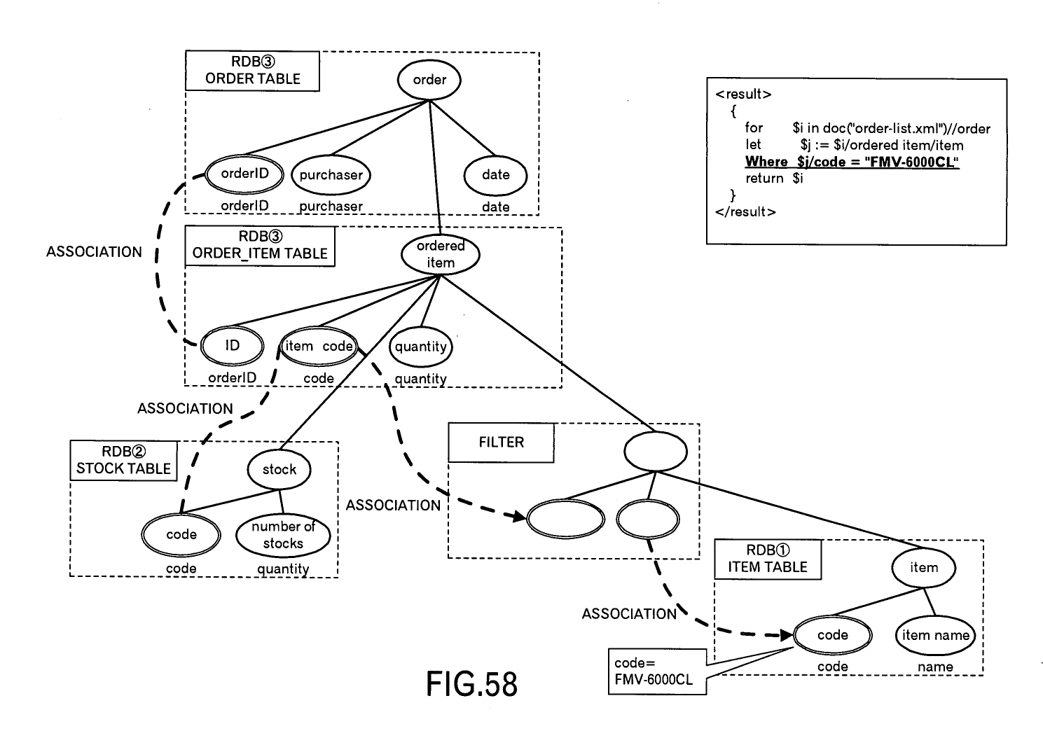

Next, by using FIGS. 58 to 64, another search processing example in a case where the one-directional filter exists in the XML tree structure will be explained. As shown in FIG. 58, a case where the same structure as the aforementioned XML tree structure is adopted is assumed. In addition, a query as shown in the upper right of FIG. 58 is carried out. Namely, a query to extract data whose code is “FMV-6000CL” is carried out. Incidentally, in the XML tree structure in FIG. 58, the query includes only a conditional expression corresponding to a node lower than the one-directional filter.

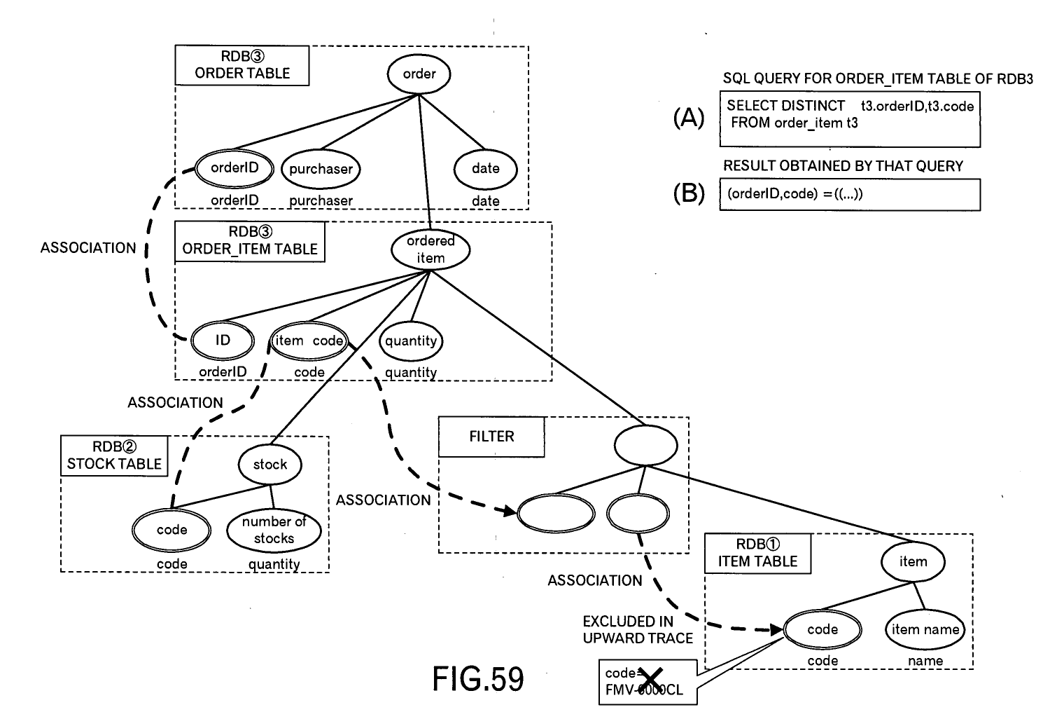

In such a case, at the step S313 of the upward conditional expression group generation processing, a conditional expression to extract all values of the immediately upper-level element of the one-directional filter is generated. Namely, as shown in the upper right (A) of FIG. 59, a search expression to extract values of the orderID column and values of the code column from the order_item table of the RDB3 (t3) is generated. However, only values of the orderID column, which is associated with the upper-level node in the XML tree structure, may be extracted. Then, although it is omitted in the upper right (B) of FIG. 59, all of the values of the orderID column and the values of the code column are extracted.

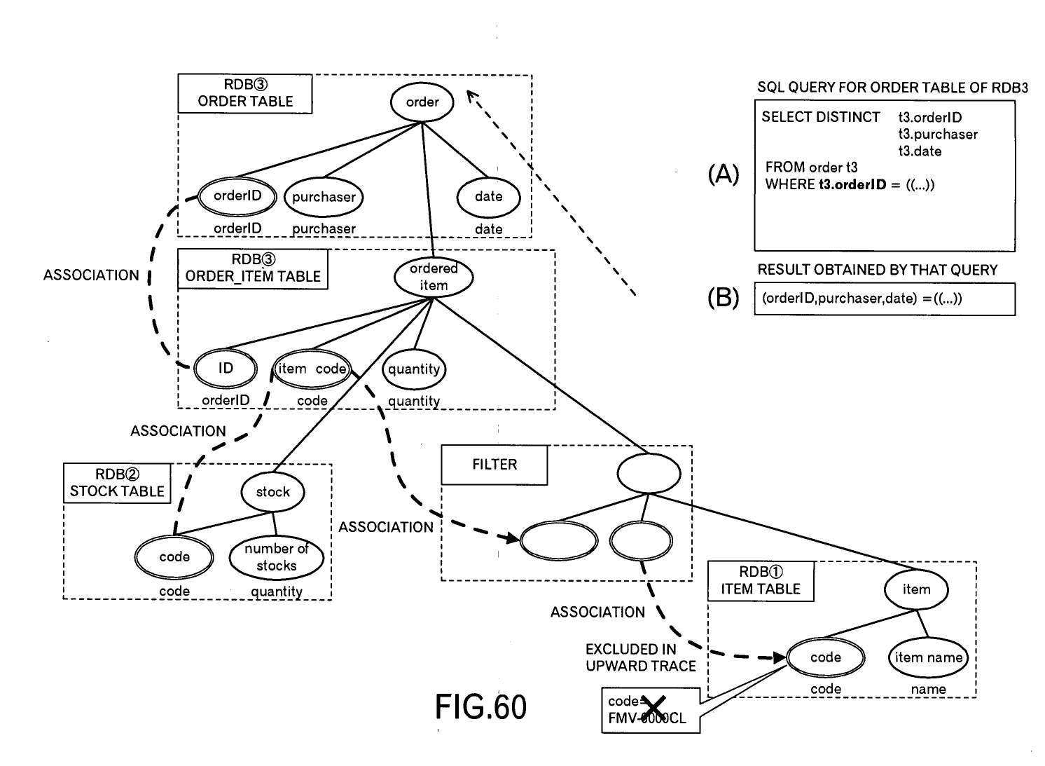

Then, shifting to an element positioned in one upper level, as shown in the upper right (A) of FIG. 60, a search expression to extract records corresponding to the values of the orderID column, which are extracted from the order_item table of the RDB3, from the order table of the RDB3 is generated and outputted. As a result, although it is omitted in the right upper (B) of FIG. 60, sets of the value of the orderID column, a value of the purchaser column and a value of the date column are extracted. The number of sets is equal to the number of values of the orderID column, which are included in the conditional expression (search expression).

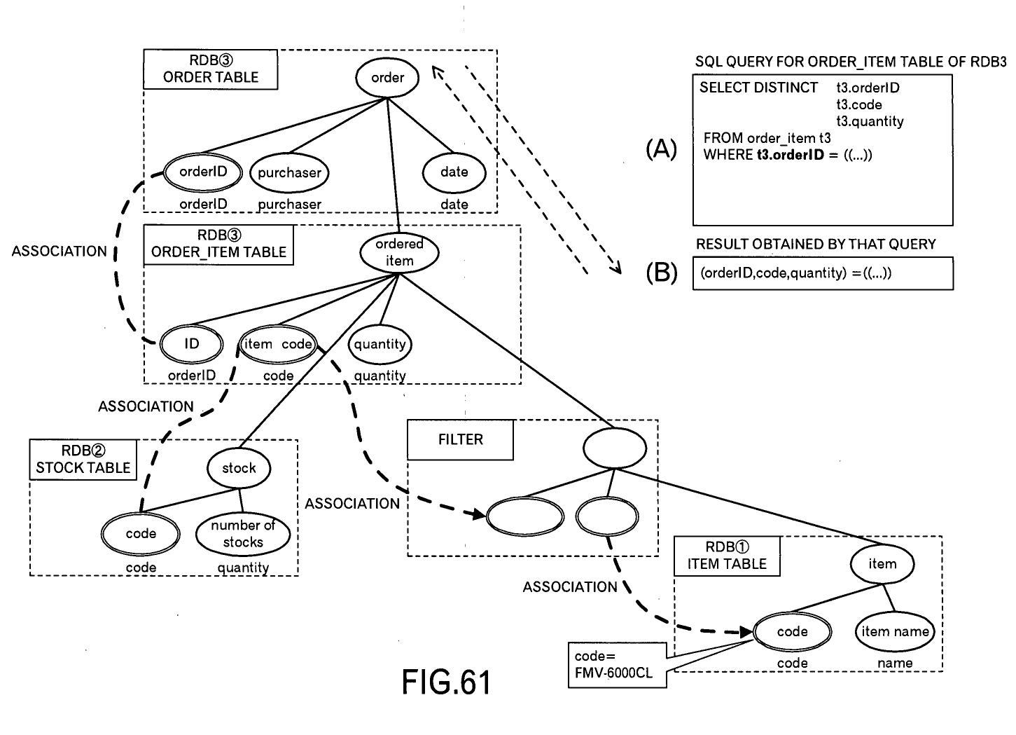

Because the trace reaches the top-level element, the processing shifts to the downward trace. First, as shown in the right upper (A) of FIG. 61, a search expression to extract pertinent records from the order_item table of the RDB3 by using, as conditions, the extracted values of the orderID columns from the order table of the RDB3 is generated and outputted. As a result, although it is omitted in the upper right (B) of FIG. 61, sets of the value of the orderID column, the value of the code column and the value of the quantity column are extracted. The number of sets is equal to the number of values of the orderID column, which are included in the conditional expression.

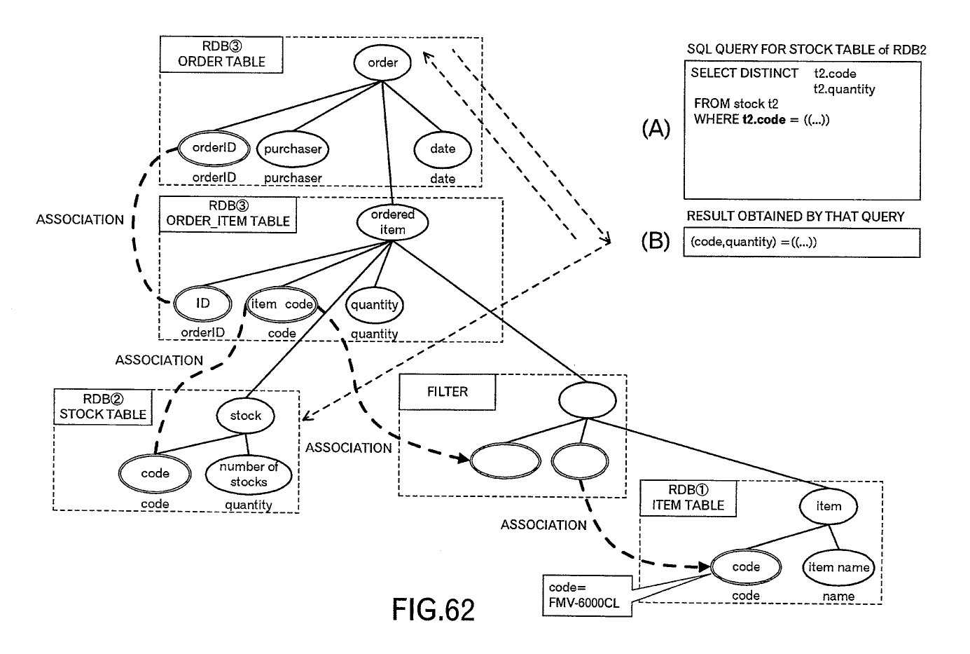

Furthermore, the processing shifts to an element corresponding to the stock table of the RDB2, as the lower-level element. Then, as shown in the upper right (A) of FIG. 62, a search expression to extract pertinent records from the stock table of the RDB2, by using, as conditions, the values of the code column in the order_item table of the RDB3 is generated and outputted. As a result, although it is omitted in the upper right (B) of FIG. 62, sets of the value of the code column and the value of the quantity column are extracted. The number of sets is equal to the number of values of the code column, which are included in the conditional expression (search expression).

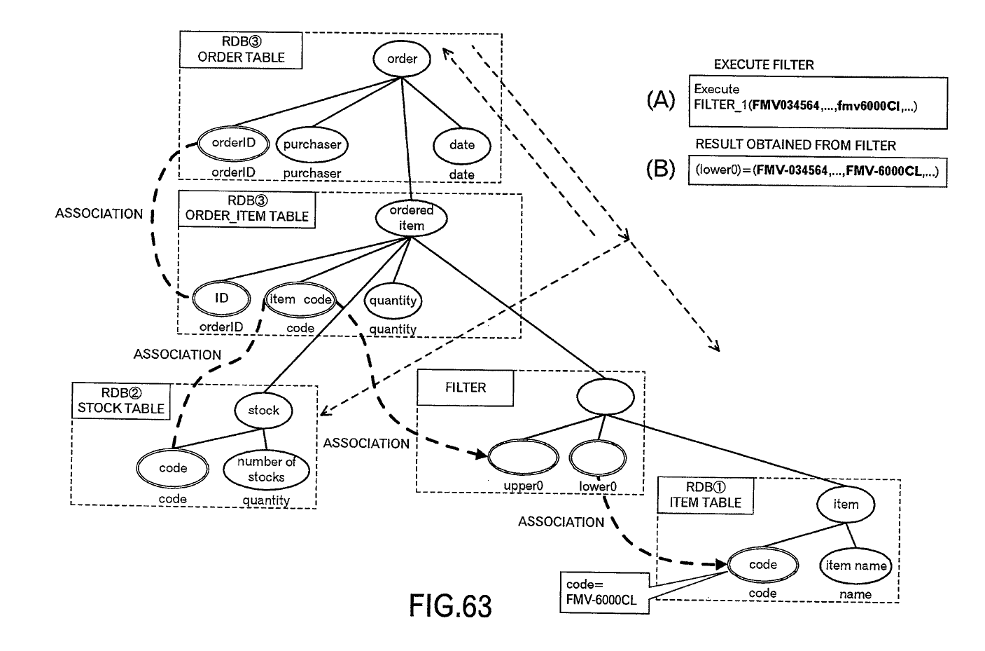

Next, the processing shifts to the one-directional filter. Then, as shown in the upper right (A) of FIG. 63, capitalizing and attaching the hyphen are carried out for the values (FMV034564, . . . , fmv6000Cl, . . . ) of the code column, which are extracted from the order_item table of the RDB3. As a result, as shown in the upper right (B) of FIG. 63, the values (FMV-034564, . . . , FMV-6000CL, . . . ) of the code column are obtained after the capitalizing and attaching the hyphen.

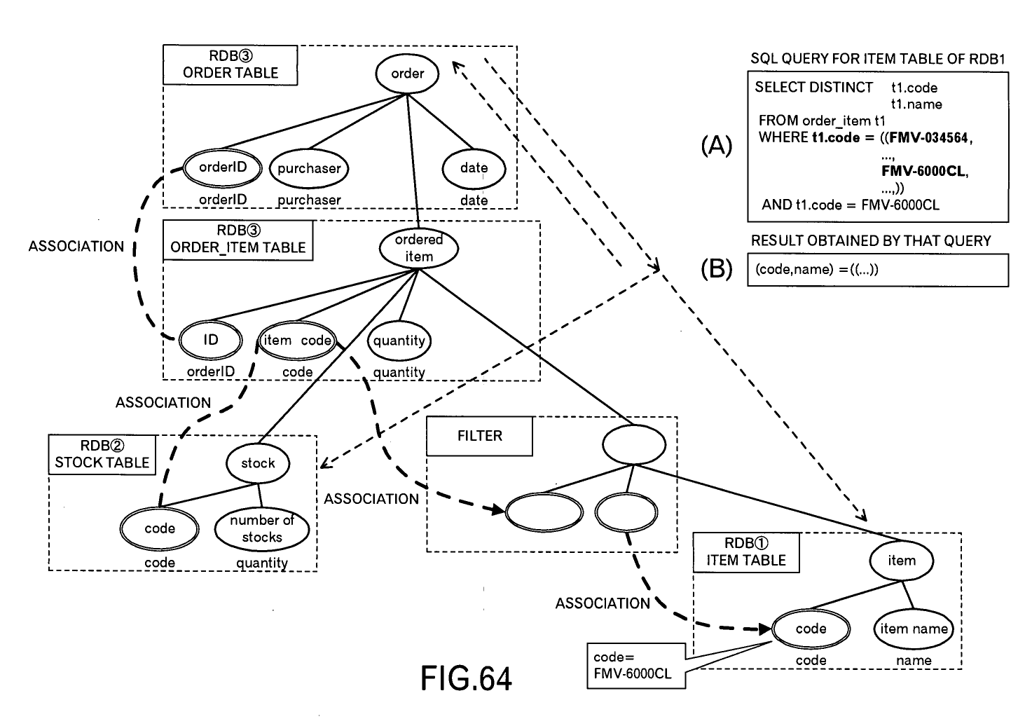

The trace shifts to an element corresponding to the item table of the RDB1 as a further lower-level element. Then, as shown in the upper right (A) of FIG. 64, a search expression to extract pertinent records from the item table of the RDB1 by using, as conditions, the values of the code column, which are outputs from the one-directional filter, and the unused downward trace conditional expression (code=FMV-6000CL) is generated and outputted. As a result, although it is omitted in the upper right (B) of FIG. 64, values of the name column, which satisfy the condition of code=FMV-6000CL.

Although this has been described above, narrowing by the condition of the query is lastly carried out in this case. Therefore, the records extracted from the RDB2 and the RDB3 includes data, which does not satisfy the condition of the query. Finally, already extracted data sets, which do not satisfy the condition of code=FMV-6000CL and in which any value of the name column is not extracted from the item table of the RDB1, are deleted.

Thus, even in case of the one-directional filter and even in case of the bi-directional filter, by the aforementioned upward trace and downward trace, it becomes possible to extract necessary data from the plural databases and to provide the extracted data for the user by the data view defined in the DB integration metadata in advance.

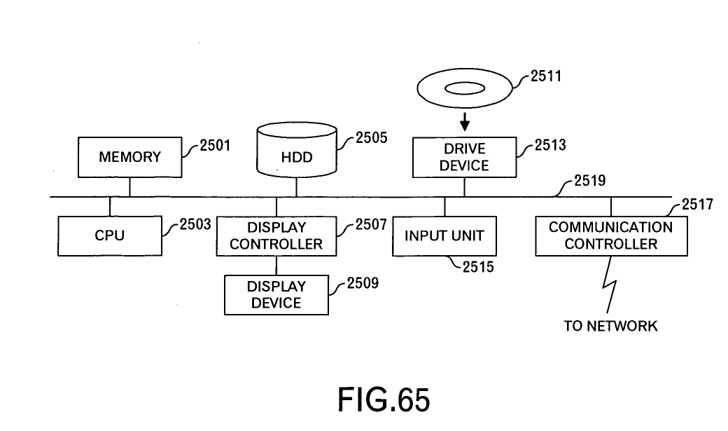

Incidentally, the database integration query system 13 and the user terminal 11 are computer devices as shown in FIG. 65. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 65. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A search program embodied on a computer readable medium, for causing a computer to execute a search processing, said search program comprising:
accepting a query of integrated data reference for a plurality of databases;
extracting a value of an element in said database, which corresponds to a top-level element in a structure identified from integration metadata, by upwardly tracing said structure based on said query, said integration metadata defining structure data defining an output structure of a query result, a correspondence relation between elements in said structure data and elements in said databases, an association of said elements between said databases, and a bi-directional conversion function applied to said association of said elements between said databases or a specific element of said databases;
extracting a value of each said element in each said database by downwardly tracing said structure based on said value of said element in said database, which corresponds to said top-level element in said structure; and
outputting the extracted value of each said element in each said database according to said integration metadata, and
wherein said extracting by upwardly tracing comprises:
outputting individual queries based on at least one of a condition of said query and a processing result immediately before to pertinent databases on an upward trace route, and obtaining search processing results of said individual queries; and
upwardly applying a pertinent bi-directional conversion function on said upward trace route to at least one of said condition of said query and said processing result immediately before, and obtaining a conversion processing result, and
said extracting by downwardly tracing comprises:
outputting individual queries based on upper-level processing results to pertinent databases on a downward trace route, and obtaining a search processing result; and
downwardly applying a pertinent bi-directional conversion function on said downward trace route to upper-level processing results, and obtaining a conversion processing result.

2. The search program as set forth in claim 1, wherein, in said integration metadata, said bi-directional conversion function is defined as an element in a same rank as a rank of said elements of said databases, and said association of said elements between said databases includes an association between an element of a first database and a downward element of said bi-directional conversion function, and an association between an element of a second database and an upward element of said bi-directional conversion function.

3. The search program as set forth in claim 1, wherein, in said integration metadata, said bi-directional conversion function is defined as an element in a same rank as a rank of said elements of said databases, and in a case of said bi-directional conversion function, which converts a value of a specific element in said database, said association of said elements between said databases includes an association between said specific element of said database and said element of said bi-directional conversion function.

4. The search program as set forth in claim 2, wherein, in said integration metadata, an element in said structure data, which corresponds to said bi-directional conversion function, includes an attribute concerning whether or not utilization in said query of said data reference is granted.

5. The search program as set forth in claim 1, wherein, in said integration metadata, said bi-directional conversion function is defined as an element in a same rank as a rank of said elements of said databases, and said association of said elements between said databases includes an association between m elements of a first database and m downward elements of said bi-directional conversion function and an association between n elements of a second database and n upward elements of said bi-directional conversion function.

6. The search program as set forth in claim 1, wherein, in said integration metadata, said bi-directional conversion function is defined as an element in a same rank as a rank of said elements of said databases, and, in a case of said bi-directional conversion function, which is applied to a specific element of said database, said association of said elements between said databases includes an association between m specific elements of said database and m elements of said bi-directional conversion function.

7. The search program as set forth in claim 6, wherein, in a case where a function limiting a value of said element of the associated database is defined as said bi-directional conversion function, said individual queries to said associated database includes a condition concerning said value limited by said bi-directional conversion function.

8. A search method, comprising:
accepting a query of integrated data reference for a plurality of databases;
extracting a value of an element in said database, which corresponds to a top-level element in a structure identified from integration metadata, by upwardly tracing said structure based on said query, said integration metadata defining structure data defining an output structure of a query result, a correspondence relation between elements in said structure data and elements in said databases, an association of said elements between said databases, and a bi-directional conversion function applied to said association of said elements between said databases or a specific element of said databases;
extracting a value of each said element in each said database by downwardly tracing said structure based on said value of said element in said database, which corresponds to said top-level element in said structure; and
outputting the extracted value of each said element in each said database according to said integration metadata, and
wherein said extracting by upwardly tracing comprises:
outputting individual queries based on at least one of a condition of said query and a processing result immediately before to pertinent databases on an upward trace route, and obtaining search processing results of said individual queries; and
upwardly applying a pertinent bi-directional conversion function on said upward trace route to at least one of said condition of said query and said processing result immediately before, and obtaining a conversion processing result, and said extracting by downwardly tracing comprises:
outputting individual queries based on upper-level processing results to pertinent databases on a downward trace route, and obtaining a search processing result; and
downwardly applying a pertinent bi-directional conversion function on said downward trace route to upper-level processing results, and obtaining a conversion processing result.

9. A search apparatus, comprising:
a unit that accepts a query of integrated data reference for a plurality of databases;
a integration metadata storage that stores integration metadata defining structure data defining an output structure of a query result, a correspondence relation between elements in said structure data and elements in said databases, an association of said elements between said databases, and a bi-directional conversion function applied to said association of said elements between said databases or a specific element of said databases;
an upward trace unit that extracts a value of an element in said database, which corresponds to a top-level element in a structure identified from said integration metadata, by upwardly tracing said structure based on said query;
a downward trace unit that extracts a value of each said element in each said database by downwardly tracing said structure based on said value of said element in said database, which corresponds to said top-level element in said structure; and
a unit that outputs the extracted value of each said element in each said database according to said integration metadata, and
wherein said upward trace unit comprises:
a unit that outputs individual queries based on at least one of a condition of said query and a processing result immediately before to pertinent databases on an upward trace route, and obtains search processing results of said individual queries; and
a unit that upwardly applies a pertinent bi-directional conversion function on said upward trace route to at least one of said condition of said query and said processing result immediately before, and obtaining a conversion processing result, and
said downward trace unit comprises:
a unit that outputs individual queries based on upper-level processing results to pertinent databases on a downward trace route, and obtains a search processing result; and
a unit that downwardly applies a pertinent bi-directional conversion function on said downward trace route to upper-level processing results, and obtains a conversion processing result.

10. A search program embodied on a computer-readable storage medium, for causing a computer to execute a search processing, said search program comprising:
accepting a query of integrated data reference for a plurality of databases;
identifying an upward trace condition that is a condition obtained by excluding a downward trace condition that is a condition relating to a first element corresponding to a one-directional conversion function in a structure identified from integration metadata stored in an integration metadata storage device storing said integration metadata and second elements lower than said first element from conditions of said query or that is a condition to extract all values for an immediately upper element of said first element corresponding to said one-directional conversion function in said structure in a case where said conditions of said query are only said downward trace conditions, wherein said integration metadata defines structure data defining an output structure of a query result, a correspondence relation between elements in said structure data and elements in said databases, an association of said elements between said databases, and a bi-directional conversion function or said one-directional conversion function applied to said association of said elements between said databases or a specific element of said databases;
extracting a value of an element in said database, which corresponds to a top-level element in said structure identified from said integration metadata, by upwardly tracing said structure identified from said integration metadata based on said upward trace condition;
extracting a value of each said element in each said database by downwardly tracing said structure based on said value of said element in said database, which corresponds to said top-level element in said structure, and said downward trace condition; and
outputting the extracted value of each said element in each said database according to said integration metadata stored in said integration metadata storage device, and
wherein said extracting by upwardly tracing comprises:
outputting an individual query based on at least one of said upward trace condition and a processing result immediately before to a pertinent database on an upward trace route to obtain a search processing result; and
upwardly applying a pertinent bi-directional conversion function on said upward trace route to said upward trace condition or said processing result immediately before to obtain a conversion processing result, and
said extracting by downwardly tracing comprises:
outputting an individual query based on at least one of an upper processing result and said downward trace condition to a pertinent database on an downward trace route to obtain a search processing result; and
downwardly applying a pertinent bi-directional conversion function or a pertinent one-directional conversion function on said downward trace route to obtain a conversion processing result.

11. The search program as set forth in claim 10, wherein, in said integration metadata, said bi-directional conversion function or said one-directional conversion function is defined as an element in a same rank as a rank of said elements of said databases, and said association of said elements between said databases includes an association between an element of a first database and a downward element of said bi-directional conversion function or said one-directional conversion function, and an association between an element of a second database and an upward element of said bi-directional conversion function or said one-directional conversion function.

12. The search program as set forth in claim 10, wherein, in said integration metadata, said bi-directional conversion function or said one-directional conversion function is defined as an element in a same rank as a rank of said elements of said databases, and in a case of said bi-directional conversion function or said one-directional conversion function, which converts a value of a specific element in said database, said association of said elements between said databases includes an association between said specific element of said database and said element of said bi-directional conversion function or said one-directional conversion function.

13. The search program as set forth in claim 10, wherein, in said integration metadata, an element in said structure data, which corresponds to said bi-directional conversion function or said one-directional conversion function, includes an attribute concerning whether or not utilization in said query of said data reference is granted.

14. The search program as set forth in claim 10, wherein, in said integration metadata, said bi-directional conversion function or said one-directional conversion function is defined as an element in a same rank as a rank of said elements of said databases, and said association of said elements between said databases includes an association between m elements of a first database and m downward elements of said bi-directional conversion function or said one-directional conversion function and an association between n elements of a second database and n upward elements of said bi-directional conversion function or said one-directional conversion function.

15. The search program as set forth in claim 10, wherein, in said integration metadata, said bi-directional conversion function or said one-directional conversion function is defined as an element in a same rank as a rank of said elements of said databases, and, in a case of said bi-directional conversion function or said one-directional conversion function, which is applied to a specific element of said database, said association of said elements between said databases includes an association between m specific elements of said database and m elements of said bi-directional conversion function or said one-directional conversion function.

16. A search method, comprising:
accepting a query of integrated data reference for a plurality of databases;
identifying an upward trace condition that is a condition obtained by excluding a downward trace condition that is a condition relating to a first element corresponding to a one-directional conversion function in a structure identified from integration metadata stored in an integration metadata storage device storing said integration metadata and second elements lower than said first element from conditions of said query or that is a condition to extract all values for an immediately upper element of said first element corresponding to said one-directional conversion function in said structure in a case where said conditions of said query are only said downward trace conditions, wherein said integration metadata defines structure data defining an output structure of a query result, a correspondence relation between elements in said structure data and elements in said databases, an association of said elements between said databases, and a bi-directional conversion function or said one-directional conversion function applied to said association of said elements between said databases or a specific element of said databases;
extracting a value of an element in said database, which corresponds to a top-level element in said structure identified from said integration metadata, by upwardly tracing said structure identified from said integration metadata based on said upward trace condition;
extracting a value of each said element in each said database by downwardly tracing said structure based on said value of said element in said database, which corresponds to said top-level element in said structure, and said downward trace condition; and
outputting the extracted value of each said element in each said database according to said integration metadata stored in said integration metadata storage device, and
wherein said extracting by upwardly tracing comprises:
outputting an individual query based on at least one of said upward trace condition and a processing result immediately before to a pertinent database on an upward trace route to obtain a search processing result; and
upwardly applying a pertinent bi-directional conversion function on said upward trace route to said upward trace condition or said processing result immediately before to obtain a conversion processing result, and
said extracting by downwardly tracing comprises:
outputting an individual query based on at least one of an upper processing result and said downward trace condition to a pertinent database on an downward trace route to obtain a search processing result; and
downwardly applying a pertinent bi-directional conversion function or a pertinent one-directional conversion function on said downward trace route to obtain a conversion processing result.

17. A search apparatus, comprising:
a unit that accepts a query of integrated data reference for a plurality of databases;
an integration metadata storage device that stores an integration metadata, wherein said integration metadata defines structure data defining an output structure of a query result, a correspondence relation between elements in said structure data and elements in said databases, an association of said elements between said databases, and a bi-directional conversion function or said one-directional conversion function applied to said association of said elements between said databases or a specific element of said databases;
a unit that identifies an upward trace condition that is a condition obtained by excluding a downward trace condition that is a condition relating to a first element corresponding to a one-directional conversion function in a structure identified from said integration metadata stored in said integration metadata storage device and second elements lower than said first element from conditions of said query or that is a condition to extract all values for an immediately upper element of said first element corresponding to said one-directional conversion function in said structure in a case where said conditions of said query are only said downward trace conditions;
an upward trace unit that extracts a value of an element in said database, which corresponds to a top-level element in said structure identified from said integration metadata, by upwardly tracing said structure identified from said integration metadata based on said upward trace condition;
a downward trace unit that extracts a value of each said element in each said database by downwardly tracing said structure based on said value of said element in said database, which corresponds to said top-level element in said structure, and said downward trace condition; and
a unit that outputs the extracted value of each said element in each said database according to said integration metadata stored in said integration metadata storage device, and
wherein said upwardly trace unit comprises:
a unit that outputs an individual query based on at least one of said upward trace condition and a processing result immediately before to a pertinent database on an upward trace route to obtain a search processing result; and
a unit that upwardly applies a pertinent bi-directional conversion function on said upward trace route to said upward trace condition or said processing result immediately before to obtain a conversion processing result, and
said downwardly trace unit comprises:
a unit that outputs an individual query based on at least one of an upper processing result and said downward trace condition to a pertinent database on an downward trace route to obtain a search processing result; and
a unit that downwardly applies a pertinent bi-directional conversion function or a pertinent one-directional conversion function on said downward trace route to obtain a conversion processing result.
